(19) United States
(12) Patent Application Publication
(10) Pub. No.: US 2024/0298641 A1
(43) Pub. Date: Sep. 12, 2024

(54) COMPOSITION FOR ENHANCING NITROGEN ASSIMILATION IN PLANTS

(71) Applicant: CH BIOTECH R&D CO., LTD., Nantou City (TW)

(72) Inventors: Nai-Hua YE, Nantou City (TW); Cho-Chun Huang, Nantou City (TW); Gui-Jun Li, Nantou City (TW); Kai Xia, Nantou City (TW); Chen-Pang Wu, Nantou City (TW)

(21) Appl. No.: 18/119,941

(22) Filed: Mar. 10, 2023

(51) Int. Cl. A01N 43/38; A01N 25/24; A01N 25/30; A01N 37/40; A01P 21/00

(52) U.S. Cl. CPC A01N 43/38; A01N 25/24; A01N 25/30; A01N 37/40; A01P 21/00

(57) ABSTRACT

The invention relates to a composition for enhancing nitrogen assimilation in plants. The composition includes auxin, salicylic acid, and melatonin. The invention also relates to a method for enhancing nitrogen assimilation in plants.

### BACKGROUND OF THE INVENTION

### 1. Field of the Invention

The present invention relates to a composition for enhancing nitrogen assimilation in plants. More particularly, the present invention relates to a composition including auxin, salicylic acid, and melatonin as the active ingredients.

### 2. Description of the Prior Art

Element nitrogen (N) is crucial to the development of plant structure, nucleotides, and enzymes, among many other central roles. Most nitrogen fertilizers are in the form of ammonia (NH₃) and nitrate (NO₃⁻). However, only 30-50% of the nitrogen fertilizer added to fields are taken up by plants, and the remainder is metabolized by soil microbes in two processes with detrimental environmental impacts. The first process, nitrification, refers to the biological oxidation of ammonia (NH₃) to nitrite (NO₂⁻) and nitrate (NO₃⁻), which have low retention in soil and pollute the waterways, leading to downstream eutrophication. In the second process, denitrification, nitrite and nitrate undergo stepwise reduction to volatile nitrogen dioxide (N₂O) and nitrogen gas (N₂). Significant amounts of the nitrogen dioxide produced in this process escape into the atmosphere, contributing to climate change and ozone destruction.

In addition to the environmental factors, plant intrinsic factors are also critical to nitrogen utilization efficiency in plants. Nitrogen uptake rate is determined by root architecture, root morphology, and activities of transporters of available forms of nitrogen (i.e., ammonium and nitrate) in the rhizosphere. Root architecture and the activities of ammonium and nitrate transporters, which is regulated by nitrogen form and concentration, diurnal fluctuations, and temperature fluctuations, both affect nitrogen acquisition by roots.

In light of the environmental impact caused by nitrogen fertilizer that is not absorbed by plants, it is important to enhance nitrogen absorption and utilization (i.e., nitrogen assimilation) efficiency in the plants to reduce application of nitrogen fertilizer.

### SUMMARY OF THE INVENTION

In one aspect, the present invention relates to a concentrate composition for enhancing nitrogen assimilation in plants. The concentrate composition comprises between about 0.05 g/L to about 20 g/L auxin, between about 0.1 g/L to about 40 g/L salicylic acid, and between about 0.05 g/L to about 20 g/L melatonin.

In another aspect, the present invention relates to a ready to use composition for enhancing nitrogen assimilation in plants. The ready to use composition comprises between about 0.5 mg/L to about 200 mg/L auxin, between about 1 mg/L to about 400 mg/L salicylic acid, and between about 0.5 mg/L to about 200 mg/L melatonin.

In another aspect, the present invention relates to a method for enhancing nitrogen assimilation in plants.

The present invention is illustrated but not limited by the following embodiments and drawings.

### BRIEF DESCRIPTION OF THE DRAWINGS

FIG. 1 shows influences of the composition of the present invention on relative gene expression of wheat (n=3) 1 day after application of the composition of the present invention under optimal condition or 1 day after recovery from stress events.

FIG. 2 shows influences of the composition of the present invention on relative gene expression of cotton (n=3) 1 day after application of the composition of the present invention under optimal condition or 1 day after recovery from stress events.

FIG. 3 shows influences of the composition of the present invention on relative gene expression of corn (n=3) 1 day after application of the composition of the present invention under optimal condition or 1 day after recovery from stress events.

FIG. 4 shows influences of the composition of the present invention on relative gene expression of rice (n=3) 1 day after application of the composition of the present invention under optimal condition or 1 day after recovery from stress events.

FIG. 5 shows influences of the composition of the present invention on relative gene expression of soybean (n=3) 1 day after application of the composition of the present invention under optimal condition or 1 day after recovery from stress events.

FIGS. 6A to 6E show influences of the composition of the present invention on abscisic acid (ABA) contents of five crops, wheat (FIG. 6A, n=3), cotton (FIG. 6B, n=3), corn (FIG. 6C, n=3), rice (FIG. 6D, n=3), and soybean (FIG. 6E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 7A to 7E show influences of the composition of the present invention on indole-3-acetic acid (IAA) contents of five crops, wheat (FIG. 7A, n=3), cotton (FIG. 7B, n=3), corn (FIG. 7C, n=3), rice (FIG. 7D, n=3), and soybean (FIG. 7E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, *p<0.01, ***p<0.001).

FIGS. 8A to 8E show influences of the composition of the present invention on root biomass of five crops, wheat (FIG. 8A, n=3), cotton (FIG. 8B, n=4), corn (FIG. 8C, n=3), rice (FIG. 8D, n=3), and soybean (FIG. 8E, n=4), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 9A to 9C show influences of the composition of the present invention on root length of wheat (FIG. 9A, n=3), corn (FIG. 9B, n=3), and soybean (FIG. 9C, n=4) seedlings under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIG. 10 shows influences of the composition of the present invention on root coverage area of rice 27 days after application of the composition of the present invention under optimal condition or recovering from stress events.

FIGS. 11A to 11E show influences of the composition of the present invention on zeatin (ZT) contents of the five crops, wheat (FIG. 11A, n=3), cotton (FIG. 11B, n=3), corn (FIG. 11C, n=3), rice (FIG. 11D, n=3), and soybean (FIG. 11E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 12A to 12E show influences of the composition of the present invention on gibberellic acids (GA) contents of five crops, wheat (FIG. 12A, n=3), cotton (FIG. 12B, n=3), corn (FIG. 12C, n=3), rice (FIG. 12D, n=3), and soybean (FIG. 12E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 13A to 13E show influences of the composition of the present invention on chlorophyll content of five crops, wheat (FIG. 13A, n=3), cotton (FIG. 13B, n=6), corn (FIG. 13C, n=5), rice (FIG. 13D, n=3), and soybean (FIG. 13E, n=4), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 14A to 14E show influences of the composition of the present invention on electron transport rate (ETR) of five crops, wheat (FIG. 14A, n=3), cotton (FIG. 14B, n=3), corn (FIG. 14C, n=5), rice (FIG. 14D, n=3), and soybean (FIG. 14E, n=4), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 15A to 15E show influences of the composition of the present invention on soluble sugar concentration of five crops, wheat (FIG. 15A, n=3), cotton (FIG. 15B, n=3), corn (FIG. 15C, n=3), rice (FIG. 15D, n=3), and soybean (FIG. 15E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 16A to 16E show influences of the composition of the present invention on shoot biomass of five crops, wheat (FIG. 16A, n=3), cotton (FIG. 16B, n=3), corn (FIG. 16C, n=3), rice (FIG. 16D, n=3), and soybean (FIG. 16E, n=4), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 17A to 17D show influences of the composition of the present invention on leaf area of four crops, wheat (FIG. 17A, n=3), cotton (FIG. 17B, n=6), rice (FIG. 17C, n=4), and soybean (FIG. 17D, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 18A to 18D show influences of the composition of the present invention on growth vigor of wheat 7 days after application of the composition of the present invention under optimal condition (FIG. 18A), or 7 days after recovery from cold-treated condition (FIG. 18B), 21 days after recovery from drought-treated condition (FIG. 18C), and 21 days after recovery from cloudy-treated condition (FIG. 18D).

FIG. 19 shows influences of the composition of the present invention on wheat tiller numbers (n=3) under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, ***p<0.001).

FIGS. 20A to 20D show influences of the composition of the present invention on leaf morphology of cotton under optimal condition (FIG. 20A), cold-treated condition (FIG. 20B), drought-treated condition (FIG. 20C), and cloudy-treated condition (FIG. 20D). The numbers shown on the left side of the photos indicate the order of the leaves. Sample collection times shown on the photos indicate the numbers of days after application of the composition of the present invention under optimal condition, or recovery from stress conditions.

FIG. 21 shows influences of the composition of the present invention on main stem width of cotton (n=8) under the test conditions. The main stem width of cotton is the cross-section of the cotyledonary node. Sample collection times shown above bars indicate the numbers of days after application of the composition of the present invention under optimal condition, or recovery from stress conditions. Asterisks indicate statistical significance compared with the control (T1 group), as determined by Student's t-test (*p<0.05, ***p<0.001).

FIGS. 22A to 22D show influences of the composition of the present invention on leaf morphology of corn under optimal condition (FIG. 22A), cold-treated condition (FIG. 22B), drought-treated condition (FIG. 22C), and cloudy-treated condition (FIG. 22D). Sample collection times shown on photos indicate the numbers of days after application of the composition of the present invention under optimal condition, or recovery from stress conditions. The numbers indicate the order of leaf emergence. The triangles indicate additional leaves shown in T2 and T3.

FIGS. 23A to 23D show influences of the composition of the present invention on growth vigor of rice 14 days after application of the composition of the present invention under optimal condition (FIG. 23A), or 21 days after recovery from cold-treated condition (FIG. 23B), 14 days after recovery from drought-treated condition (FIG. 23C), and 14 days after recovery from cloudy-treated condition (FIG. 23D).

FIG. 24 shows influences of the composition of the present invention on rice tiller numbers (n=3) under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, ***p<0.001).

FIGS. 25A to 25D shows influences of the composition of the present invention on growth vigor of soybean 14 days after application of the composition of the present invention under optimal condition (FIG. 25A), 9 days after recovering from cold-treated condition (FIG. 25B), 10 days after recovering from drought-treated condition (FIG. 25C), and 9 days after recovering from the cloudy-treated condition (FIG. 25D).

FIGS. 26A to 26C show influences of the composition of the present invention on activities of nitrogen assimilation enzymes, nitrate reductase (NR, FIG. 26A, n=3), glutamine synthetase (GS, FIG. 26B, n=3), glutamate synthase (GOGAT, FIG. 26C, n=3), in wheat under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, ***p<0.001).

FIGS. 27A to 27C show influences of the composition of the present invention on activities of nitrogen assimilation enzymes, NR (FIG. 27A, n=4), GS (FIG. 27B, n=4), GOGAT (FIG. 27C, n=4), in cotton under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 28A to 28C show influences of the composition of the present invention on activities of nitrogen assimilation enzymes, NR (FIG. 28A, n=4), GS (FIG. 28B, n=4), GOGAT (FIG. 28C, n=4), in corn under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (**p<0.01, ***p<0.001).

FIGS. 29A to 29C show influences of the composition of the present invention on activities of nitrogen assimilation enzymes, NR (FIG. 29A, n=3), GS (FIG. 29B, n=3), GOGAT (FIG. 29C, n=3), in rice under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 30A to 30C show influences of the composition of the present invention on activities of nitrogen assimilation enzymes, NR (FIG. 30A, n=3), GS (FIG. 30B, n=3), GOGAT (FIG. 30C, n=3), in soybean under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 31A to 31E show influences of the composition of the present invention on total nitrogen content of five crops, wheat (FIG. 31A, n=3), cotton (FIG. 31B, n=3), corn (FIG. 31C, n=3), rice (FIG. 31D, n=3), and soybean (FIG. 31E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, ***p<0.001).

FIGS. 32A to 32E show influences of the composition of the present invention on soluble protein content of five crops, wheat (FIG. 32A, n=3), cotton (FIG. 32B, n=4), corn (FIG. 32C, n=3), rice (FIG. 32D, n=5), and soybean (FIG. 32E, n=3), under the test conditions. Sample collection times shown above bars indicate the numbers of days after application of the composition of the present invention under optimal condition, or recovering from stress conditions. Asterisks indicate statistical significance compared with the control (T1 group), as determined by Student's t-test (*p<0.05, **p<0.01, ***p<0.001).

FIGS. 33A to 33D show influences of the composition of the present invention on mineral content (n=3) in wheat 21 days after application of the composition of the present invention under optimal condition (FIG. 33A), or 21 days after recovering from cold-treated condition (FIG. 33B), drought-treated condition (FIG. 33C), and cloudy-treated condition (FIG. 33D).

FIGS. 34A to 34D show influences of the composition of the present invention on mineral content (n=3) in cotton 7 days after application of the composition of the present invention under optimal condition (FIG. 34A), or 7 days after recovering from cold-treated condition (FIG. 34B), drought-treated condition (FIG. 34C), and cloudy-treated condition (FIG. 34D).

FIGS. 35A to 35D show influences of the composition of the present invention on mineral content (n=3) in corn 14 days after application of the composition of the present invention under optimal condition (FIG. 35A), or 14 days after recovering from cold-treated condition (FIG. 35B), drought-treated condition (FIG. 35C), and cloudy-treated condition (FIG. 35D).

FIGS. 36A to 36D show influences of the composition of the present invention on mineral content (n=3) in rice 21 days after application of the composition of the present invention under optimal condition (FIG. 36A), or 21 days after recovering from cold-treated condition (FIG. 36B), drought-treated condition (FIG. 36C), and cloudy-treated condition (FIG. 36D).

FIGS. 37A to 37D show influences of the composition of the present invention on mineral content (n=3) in soybean 14 days after application of the composition of the present invention under optimal condition (FIG. 37A), or 14 days after recovering form cold-treated condition (FIG. 37B), drought-treated condition (FIG. 37C), and cloudy-treated condition (FIG. 37D).

FIGS. 38A to 38D show influences of the composition of the present invention on wheat yield, including spike number per plant (FIG. 38A, n=21), spikelet number per spike (FIG. 38B, n=137˜261), weight per spike (FIG. 38C, n=137˜261), and 1000-kernel weight (FIG. 38D, n=3), under the test conditions. Asterisks indicate statistical significance compared with the control (T1 group), as determined by Student's t-test (*p<0.05, **p<0.01, ***p<0.001).

FIGS. 39A to 39D show influences of the composition of the present invention on wheat spike morphology under optimal condition (FIG. 39A), cold-treated condition (FIG. 39B), drought-treated condition (FIG. 39C), and cloudy-treated condition (FIG. 39D).

FIGS. 40A and 40B show influences of the composition of the present invention on protein content (FIG. 40A, n=6) and starch content (FIG. 40B, n=6) of wheat kernels under the test conditions. Asterisks indicate statistical significance compared with the control (T1 group), as determined by Student's t-test (*p<0.05, **p<0.01, ***p<0.001).

FIGS. 41A to 41C show influences of the composition of the present invention on cotton yield, including lint weight per plant (FIG. 41A, n=4), boll weight (FIG. 41B, n=4), and seed number per boll (FIG. 41C, n=4). Asterisks indicate statistical significance compared with the control (T1 group), as determined by Student's t-test (*p<0.05, **p<0.01, ***p<0.001).

FIGS. 42A and 42B show influences of the composition of the present invention on the percentage of numbers of early bolls (FIG. 42A, n=4) and first position bolls (FIG. 42B, n=3) under the test conditions. Asterisks indicate statistical significance compared with the control (T1 group), as determined by Student's t-test (*p<0.05, **p<0.01).

FIGS. 43A to 43C show influences of the composition of the present invention on corn yield, including grain number per ear (FIG. 43A, n=5), ear weight per plant (FIG. 43B, n=5), and 100-kernel weight (FIG. 43C, n=5), under the test conditions. Asterisks indicate statistical significance compared with the control (T1 group), as determined by Student's t-test (*p<0.05, **p<0.01).

FIG. 44 shows influences of the composition of the present invention on protein content of corn kernels (n=4) under the tested conditions.

FIGS. 45A to 45D show influences of the composition of the present invention on ear morphology of corn under optimal condition (FIG. 45A), cold-treated condition (FIG. 45B), drought-treated condition (FIG. 45C), and cloudy-treated condition (FIG. 45D).

FIGS. 46A to 46C show influences of the composition of the present invention on rice yield, including panicle weight per plant (FIG. 46A, n=4), grain weight per panicle (FIG. 46B, n=4) and 1000-grain weight (FIG. 46C, n=4), under the test conditions. Asterisks indicate statistical significance compared with the control (T1 group), as determined by Student's t-test (**p<0.01, ***p<0.001).

FIGS. 47A to 47C show influences of the composition of the present invention on rice panicle structure under cold-treated condition (FIG. 47A), drought-treated condition (FIG. 47B), and cloudy-treated condition (FIG. 47C).

FIGS. 48A to 48C show influences of the composition of the present invention on length, width, and thickness of 15 rice grains under cold-treated condition (FIG. 48A), drought-treated condition (FIG. 48B), and cloudy-treated condition (FIG. 48C).

FIGS. 49A and 49B show influences of the composition of the present invention on soybean yield, including grain number per plant (FIG. 49A, n=8) and grain dry weight per plant (FIG. 49B, n=8), under the test conditions. Asterisks indicate statistical significance compared with the control (T1 group), as determined by Student's t-test (*p<0.05, **p<0.01, ***p<0.001).

FIGS. 50A to 50D show influences of the composition of the present invention on the mature (saleable) and immature seeds per soybean plant under the tested conditions.

FIGS. 51A and 51B show influences of the composition of the present invention on soybean seed oil content (FIG. 51A, n=3) and protein content (FIG. 51B, n=3) under the tested conditions. Asterisks indicate statistical significance compared with the control (T1 group), as determined by Student's t-test (*p<0.05, **p<0.01, ***p<0.001).

FIGS. 52A and 52B show influences of the compositions of the present invention with different concentrations of active ingredients on shoot fresh weight of corn (FIG. 52A, n=24) and soybean (FIG. 52B, n=16) under the drought conditions. The numbers above the bars of T2 to T5 groups indicate the percentage increase compared to T1 group. Asterisks indicate statistical significance compared with T1 group, as determined by Student's t-test (*p<0.05).

FIGS. 53A and 53B show influences of the compositions of the present invention with different concentrations of active ingredients on leaf area of corn (FIG. 53A, n=24) and soybean (FIG. 53B, n=16) under the drought conditions. The numbers above the bars of T2 to T5 groups indicate the percentage increase compared to T1 group. Asterisks indicate statistical significance compared with T1 group, as determined by Student's t-test (*p<0.05).

FIGS. 54A and 54B show influences of the compositions of the present invention with different concentrations of active ingredients on nitrogen content of corn leaves (FIG. 54A, n=18) and soybean leaves (FIG. 54B, n=8) under the drought conditions. The numbers above the bars of T2 to T5 groups indicate the percentage increase compared to T1 group. Asterisks indicate statistical significance compared with T1 group, as determined by Student's t-test (**p<0.01; ***p<0.001).

FIGS. 55A and 55B show influences of at least one active ingredient of the composition of the present invention on shoot biomass of corn (FIG. 55A, n=12) and soybean (FIG. 55B, n=16) under the drought conditions. The numbers above the bars indicate the percentage increase compared to T1 group. Asterisks indicate statistical significance compared with T1 group, as determined by Student's t-test (*p<0.05, ***p<0.001).

FIGS. 56A and 56B show influences of at least one active ingredient of the composition of the present invention on leaf area of corn (FIG. 56A, n=10) and soybean (FIG. 56B, n=16) under the drought conditions. The number above the bar of T8 group indicates the percentage increase compared to T1 group. Asterisks indicate statistical significance compared with T1 group, as determined by Student's t-test (*p<0.05).

FIG. 57 show influences of at least one active ingredient of the composition of the present invention on nitrogen content of soybean leaves (n=8) under the drought conditions. The numbers above the bars indicate the percentage increase compared to T1 group.

### DETAILED DESCRIPTION

In some embodiments, the present invention provides a composition for enhancing nitrogen assimilation in plants. The composition comprises, as the active ingredients, auxin, salicylic acid, and melatonin.

In some embodiments, the auxin is selected from indole-3-butyric acid (IBA), indole-3-acetic acid (IAA), 2-phenylacetic acid (PAA), indole-3-propionic acid (IPA), and 1-naphthaleneacetic acid (NAA). In some embodiments, the auxin is IBA.

In some embodiments, the composition of the present invention is a concentrate composition, comprising between about 0.05 g/L to about 20 g/L auxin, between about 0.1 g/L to about 40 g/L salicylic acid, and between about 0.05 g/L to about 20 g/L melatonin. A concentrate solution refers to a solution which is intended to be diluted with water to form a use solution prior to application to the plant.

In some embodiments, the concentration of auxin in the concentrate composition is between about 0.05 g/L to about 20 g/L, between about 0.1 g/L to about 10 g/L, between about 0.2 g/L to about 8 g/L, and preferably is, but is not limited to, about 0.05 g/L, about 0.1 g/L, about 0.5 g/L, about 1 g/L, about 2 g/L, about 3 g/L, about 4 g/L, about 5 g/L, about 6 g/L, about 7 g/L, about 8 g/L, about 9 g/L, about 10 g/L, about 11 g/L, about 12 g/L, about 13 g/L, about 14 g/L, about 15 g/L, about 16 g/L, about 17 g/L, about 18 g/L, about 19 g/L, about 20 g/L, or any concentration between about 0.05 g/L to about 20 g/L, such as about 0.289 g/L, about 5.748 g/L, or about 12.739 g/L. In some embodiments, the concentration of auxin in the concentrate composition is about 0.05 g/L, about 0.1 g/L, about 10 g/L, or about 20 g/L.

In some embodiments, the concentration of salicylic acid in the concentrate composition is between about 0.1 g/L to about 40 g/L, between about 0.2 g/L to about 20 g/L, between about 0.4 g/L to about 16 g/L, and preferably is, but is not limited to, about 0.1 g/L, about 0.5 g/L, about 1 g/L, about 2 g/L, about 4 g/L, about 6 g/L, about 8 g/L, about 10 g/L, about 12 g/L, about 14 g/L, about 16 g/L, about 18 g/L, about 20 g/L, about 22 g/L, about 24 g/L, about 26 g/L, about 28 g/L, about 30 g/L, about 32 g/L, about 34 g/L, about 36 g/L, about 38 g/L, about 40 g/L, or any concentration between about 0.1 g/L to about 40 g/L, such as about 0.867 g/L, about 5.823 g/L, about 34.869 g/L. In some embodiments, the concentration of salicylic acid in the concentrate composition is about 0.1 g/L, about 0.2 g/L, about 20 g/L, or about 40 g/L.

In some embodiments, the concentration of melatonin in the concentrate composition is between about 0.05 g/L to about 20 g/L, between about 0.1 g/L to about 10 g/L, between about 0.2 g/L to about 8 g/L, and preferably is, but is not limited to, about 0.05 g/L, about 0.1 g/L, about 0.5 g/L, about 1 g/L, about 2 g/L, about 3 g/L, about 4 g/L, about 5 g/L, about 6 g/L, about 7 g/L, about 8 g/L, about 9 g/L, about 10 g/L, about 11 g/L, about 12 g/L, about 13 g/L, about 14 g/L, about 15 g/L, about 16 g/L, about 17 g/L, about 18 g/L, about 19 g/L, about 20 g/L, or any concentration between about 0.05 g/L to about 20 g/L, such as about 0.743 g/L, about 6.513 g/L, or about 14.658 g/L. In some embodiments, the concentration of melatonin in the concentrate composition is about 0.05 g/L, about 0.1 g/L, about 10 g/L, or about 20 g/L.

In some embodiments, the concentrate composition for enhancing nitrogen assimilation in plants is diluted around 50 to 200 folds with water before use.

In some embodiments, the composition of the present invention is a ready to use composition, comprising between about 0.5 mg/L to about 200 mg/L auxin, between about 1 mg/L to about 400 mg/L salicylic acid, and between about 0.5 mg/L to about 200 mg/L melatonin. A ready to use solution is not diluted with water prior to application to the plant. A ready to use solution is a use solution when it is applied to the plant without further dilution.

In some embodiments, the concentration of auxin in the ready to use composition is between about 0.5 mg/L to about 200 mg/L, between about 0.75 mg/L to about 150 mg/L, between about 1 mg/L to about 100 mg/L, and preferably is, but is not limited to, about 0.5 mg/L, about 1 mg/L, about 5 mg/L, about 10 mg/L, about 25 mg/L, about 50 mg/L, about 75 mg/L, about 100 mg/L, about 150 mg/L, about 200 mg/L, or any concentration between about 0.5 mg/L to about 200 mg/L, such as about 1.853 mg/L, about 33.748 mg/L, or about 162.739 mg/L. In some embodiments, the concentration of auxin in the ready to use composition is about 1 mg/L, about 5 mg/L, about 10 mg/L, about 50 mg/L, about 75 mg/L, or about 100 mg/L.

In some embodiments, the concentration of salicylic acid in the ready to use composition is between about 1 mg/L to about 400 mg/L, between about 1.5 mg/L to about 300 mg/L, between about 2 mg/L to about 200 mg/L, and preferably is, but is not limited to, about 1 mg/L, about 5 mg/L, about 10 mg/L, about 50 mg/L, about 100 mg/L, about 150 mg/L, about 200 mg/L, about 250 mg/L, about 300 mg/L, about 350 mg/L, about 400 mg/L or any concentration between about 1 mg/L to about 400 mg/L, such as about 1.267 mg/L, about 47.823 mg/L, about 237.869 mg/L. In some embodiments, the concentration of salicylic acid in the ready to use composition is about 2 mg/L, 20 mg/L, 100 mg/L, 150 mg/L, or 200 mg/L.

In some embodiments, the concentration of melatonin in the ready to use composition is between about 0.5 mg/L to about 200 mg/L, between about 0.75 mg/L to about 150 mg/L, between about 1 mg/L to about 100 mg/L, and preferably is, but is not limited to, about 0.5 mg/L, about 1 mg/L, about 5 mg/L, about 10 mg/L, about 25 mg/L, about 50 mg/L, about 75 mg/L, about 100 mg/L, about 150 mg/L, about 200 mg/L, or any concentration between about 0.5 mg/L to about 200 mg/L, such as about 6.428 mg/L, about 68.654 mg/L, or about 127.824 mg/L. In some embodiments, the concentration of melatonin in the ready to use composition is about 1 mg/L, 10 mg/L, about 50 mg/L, about 75 mg/L, or about 100 mg/L.

In some embodiments, the composition for enhancing nitrogen assimilation in plants of the present invention may include one or more adjuvants, such as a surfactant or a drift control agent. In other embodiments, the composition for enhancing nitrogen assimilation in plants of the present invention may not include an adjuvant. For example, the composition for enhancing nitrogen assimilation in plants may include a surfactant and/or a drift control agent. Exemplary surfactants include, but are not limited to, cationic surfactants, anionic surfactants, zwitterionic surfactants, and nonionic surfactants, preferably including but not limited to, Tween® 20, Tween® 40, Tween® 60, Tween® 65, Tween® 80, Tween® 85, Laureth-4, Ceteth-2, Ceteth-20, Steareth-2, PEG40, PEG100, PEG150, PEG200, PEG600, Span® 20, Span® 40, Span® 60, Span® 65, Span® 80. An exemplary drift control agent includes LI 700®, which is commercially available from Loveland Products (Loveland, CO, USA).

In some embodiments, the concentration of the adjuvant in the ready to use composition for enhancing nitrogen assimilation in plants is between about 0.01 to 1% (v/v), and preferably is, but is not limited to, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1% (v/v). In some embodiments, the concentration of the adjuvant in the ready to use composition for enhancing nitrogen assimilation in plants is about 0.1% (v/v).

In some embodiments, the composition for enhancing nitrogen assimilation in plants of the present invention may be applied as part of a tank mix, which may include additional nutrients, such as micro or macro nutrients, such urea, and/or pesticides such as fungicides, herbicides, or insecticides.

Suitable concentration ranges for the concentrate composition of the present invention are provided in Table 1, and suitable concentration ranges for the ready to use composition of the present invention are provided in Table 2. In some embodiments, the concentrate composition and the ready to use composition can comprise, consist of, or consist essentially of the components listed in Table 1 and 2, respectively.

TABLE 1
Suitable concentrate compositions

| | First example | Second example | Third example |
|---|---|---|---|
| Component | range (g/L) | range (g/L) | range (g/L) |
| Auxin | 0.05-20 | 0.1-10 | 0.2-8 |
| Salicylic acid | 0.1-40 | 0.2-20 | 0.4-16 |
| Melatonin | 0.05-20 | 0.1-10 | 0.2-8 |

TABLE 2
Suitable ready to use compositions

| | First example | Second example | Third example |
|---|---|---|---|
| Component | range (mg/L) | range (mg/L) | range (mg/L) |
| Auxin | 0.5-200 | 1-100 | 2-80 |
| Salicylic acid | 1-400 | 2-200 | 4-160 |
| Melatonin | 0.5-200 | 1-100 | 2-80 |

In some embodiments, the present invention provides a method for enhancing nitrogen assimilation in plants, comprising a step of applying a use solution composition to a plant, and the use solution composition comprising between about 0.5 mg/L to about 200 mg/L auxin, between about 1 mg/L to about 400 mg/L salicylic acid, and between about 0.5 mg/L to about 200 mg/L melatonin.

In some embodiments, the composition for enhancing nitrogen assimilation in plants of the present invention is applied to a plant during the vegetative phase. In some embodiments, the composition for enhancing nitrogen assimilation in plants of the present invention is applied to a plant during the reproductive phase.

The composition of the present invention can be applied to different plants, such as, but not limited to, asparagus, berry (such as blackberry, blueberry, cranberry, kiwi, and raspberry), brassica vegetables (such as broccoli, cabbage, cauliflower, and mustard greens), bulb vegetable (such as garlic, leek, and onion), cereal grains (such as barley, corn, millet, oats, rice, sorghum, and wheat), citrus fruit (such as grapefruit, lemon, lime, sweet orange, and tangerine), coffee, cotton, cucurbit vegetables (such as cantaloupe, cucumber, honeydew, muskmelon, squash, and watermelon), forage, fodder, and straw of cereal grains, fruiting vegetables (such as eggplant, pepper, and tomato), grass forage, fodder, and hay, grass grown for seed (such as perennial ryegrass, tall fescue, or bent grass), grape, herbs and spices (such as basil, dill, mustard, and sage), hemp, hops, leafy vegetable (such as celery, head and leaf lettuce, kale, and spinach), legume vegetables (such as bean, peas, and soybeans), mint, peppermint, spearmint, nongrass animal feeds (such as alfalfa, clover, hay, and vetch), oil seed crops (such as canola, flax, and sunflower), peanut, pome fruits (such as apple and pear), root and tuber vegetables (such as carrot, ginseng, horseradish, parsley, potato, radish, sugar beet, sweet potato, and turnip), stone fruits (such as apricot, cherry, peach, and plumcot), strawberry, sugarcane, tobacco, tree nuts (such as almonds, cashews, and pecans). In another example, the composition for enhancing nitrogen assimilation in plants is applied to wheat, cotton, corn, rice, and soybeans.

In some embodiments, the composition for enhancing nitrogen assimilation in plants of the present invention is applied to plant foliage (for example, leaves, stems, flowers and/or fruits), for example as a foliar application or foliar spray. In some embodiments, the composition for enhancing nitrogen assimilation in plants of the present invention is applied to plant roots, such as by a soil application or soil drench, and/or to seeds, such as by a seed treatment.

Nitrogen is generally acquired by roots as inorganic ions in the form of nitrate (NO₃⁻) and ammonium (NH₄⁺). For many plants, some nitrate (NO₃⁻) taken up by the roots is assimilated into the roots, but the major part of nitrate is transported to the shoot, where it is first reduced to nitrite (NO₂⁻) by nitrate reductase (NR) in the cytoplasm and then further to ammonium (NH₄⁺) by nitrite reductase (NiR) in the plastids and glutamine synthetase (GS) in the plastids and cytoplasm. The ammonium derived from nitrate or directly from ammonium uptake by ammonium transporters (AMTs) is rapidly incorporated into 2-oxoglutarate (2-OG) to form glutamate and further assimilated into amino acids via the glutamine synthetase-glutamine-glutamate synthase (GS-GOGAT) pathway.

Therefore, in some embodiments, the composition of the present invention enhances nitrogen assimilation in plants by at least one of the methods selected from enhancing nitrogen absorption, improving photosynthesis efficiency to increase the supply of energy and 2-oxoglutarate (2-OG) to drive nitrogen assimilation through the glutamine synthetase-glutamine-glutamate synthase (GS-GOGAT) pathway, and enhancing the activities of nitrogen assimilation enzymes, such as nitrate reductase (NR), glutamine synthetase (GS), and glutamate synthase (GOGAT).

In some embodiments, the composition of the present invention enhances nitrogen absorption by at least one of the methods selected from up-regulating expression of genes involved in nitrogen uptake and assimilation and promoting root establishment, including increasing abscisic acid (ABA) content and/or indole-3-acetic acid (IAA) content, up-regulating expression of genes involved in root growth and elongation, increasing root length, increasing root dry weight, and increasing root density.

In some embodiments, the composition of the present invention improves photosynthesis efficiency in plants by at least one of the methods selected from up-regulating expression of genes related to increasing photosynthesis, increasing zeatin content and/or gibberellic acids (GAs) content, increasing chlorophyll content, increasing electron transport rate (ETR) of plants, increasing shoot dry weight, increasing leaf area, and improving leaf morphology.

It has been found that when auxin, salicylic acid, and melatonin are combined as the active ingredients in the composition of the present invention, the plant growth regulating actions of the respective components are increased synergistically, and the combination of the components exhibits a marked synergistic effect not seen when the components are used individually.

Unless otherwise defined, all technical and scientific terms used herein have the same meaning as commonly understood by one of ordinary skill in the art to which this invention pertains. In the case of conflict, the present document, including definitions will control.

As used herein, the term “auxin” refers to a class of plant growth regulators that promote stem elongation, inhibit growth of lateral buds, and therefore maintain apical dominance. Naturally occurring (endogenous) auxins are produced by apical meristem, such as stem tips and root tips. Auxin moves to the darker side of the plant, causing the cells there to grow longer than corresponding cells on the lighter side of the plant, and this produces a curving of the plant stem tip toward the light. Examples of auxin include, but are not limited to, indole-3-butyric acid (IBA), indole-3-acetic acid (IAA), 2-phenylacetic acid (PAA), indole-3-propionic acid (IPA), 1-naphthaleneacetic acid (NAA).

As used herein, the term “salicylic acid (SA),” refers to an organic compound having the formula HOC₆H₄CO₂H and the following chemical structure:

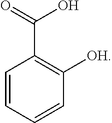

As used herein, the term “melatonin” refers to a hormone having the formula of C₁₃H₁₆N₂O₂ and the following chemical structure:

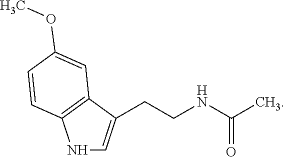 [SMILES: COc1ccc2[nH]cc(CCNC(C)=O)c2c1]

As used herein, the term “nitrogen assimilation” refers to the formation of organic nitrogen compounds, such as amino acids and proteins, from inorganic nitrogen compounds present in the environment. In nitrogen assimilation in plants, nitrate (NO₃⁻) and nitrite (NO₂⁻) are first reduced to ammonium (NH₄⁺) by nitrate reductase (NR) and nitrite reductase (NiR), respectively, and then ammonium (NH₄⁺) is incorporated into amino acid via the glutamine synthetase (GS)-glutamate synthase (GOGAT) pathway. Therefore, increasing activities of enzymes involved in nitrogen assimilation, such as nitrate reductase (NR), glutamine synthetase (GS), and glutamate synthase (GOGAT), in plant cells indicate that the plant synthesizes more amino acids and proteins.

As used herein, the term “electron transport rate (ETR)” refers to transport rate of electrons released by water splitting during photosynthesis. Since energy is generated during electron transportation, the faster the electron transport rate is, the more energy (ATP) is generated, which helps plants synthesize more sugar from CO₂ and supply more energy to drive nitrogen assimilation through the GS-GOGAT pathway.

As used herein, the term “higher level of nitrogen dose” refers to a higher level of nitrogen source within the reasonable application rate of nitrogen fertilizer for crops. As used herein, the term “lower level of nitrogen dose” refers to a lower level of nitrogen source within the reasonable application rate of nitrogen fertilizer for crops. The lower level of nitrogen dose is around 60˜70 wt % of the higher level of nitrogen dose. In some embodiments, the lower/higher level of nitrogen doses for wheat, cotton, corn, rice, and soybean are 43/72, 121/202, 74/123, 230/318, and 43/69 lb/acre of nitrogen, respectively. In some embodiments, the nitrogen fertilizer is urea, and 100 lb of urea is approximately equal to 46 lb of nitrogen. Therefore, the lower/higher level of urea for wheat, cotton, corn, rice, and soybean are 94/156, 264/440, 161/268, 500/692, and 94/150 lb/acre or urea, respectively.

As used herein, the terms “abiotic stress(es)” refers to the negative impact of non-living factors on the living organisms in a specific environment. The non-living variable must influence the environment beyond its normal range of variation to adversely affect the population performance or individual physiology of the organism in a significant way. Examples of abiotic stresses include, but are not limited to, low temperature (cold condition), high temperature, deficient water (drought), excessive water, deficient light intensity (cloudy condition), excess light intensity (ultraviolet radiation), high salinity, and heavy metals.

As used herein, the terms “comprises,” “comprising,” “includes,” “including,” “has,” “having,” “contains,” “containing,” “characterized by” or any other variation thereof, are intended to cover a non-exclusive inclusion, subject to any limitation explicitly indicated. For example, a composition, mixture, process, method, article, or apparatus that comprises a list of elements is not necessarily limited to only those elements but may include other elements not expressly listed or inherent to such composition, mixture, process, method, article, or apparatus.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”. As used herein “consisting essentially of” means that the composition can contain other minor ingredients that do not affect the physiological action of the active ingredients of the composition described herein.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The term “a,” “an,” or “the” disclosed in the present invention is intended to cover one or more numerical values in the specification and claims unless otherwise specified. For example, “an element” indicates one or more than one element.

It is to be understood that both the foregoing general description and the following detailed description are exemplary and explanatory only and are not restrictive of the invention.

### EXAMPLES

### Example 1 Effects of the Composition of the Present Invention on Plants Under Different Abiotic Stress Conditions

### A. Materials and Methods

### 1. Plant Growth and Treatment

Wheat seeds (SY Soren, Syngenta) were sown in pots containing culture medium (peat soil:perlite=10:1) and placed in a greenhouse at 22-25° C. One seed was sown in one pot. Wheat plants were divided into four groups: optimal group, cold group, drought group, and cloudy group. Each group was then divided into three subgroups, T1, T2, and T3, to receive different reagents listed in Table 3. Plants in T1 and T2 subgroup were applied with lower level of urea (nitrogen dose). Plants in T2 subgroup were also applied once at tillering stage with the composition of the present invention at a rate of 0.75 ml/plant using a foliar spray treatment. Plants in T3 subgroup were applied with higher level of urea (nitrogen dose). On the next day after the application, wheat plants in the optimal group were kept in the greenhouse (22-25° C.) with regular watering and light intensity. Wheat plants in the cold group were placed in a phytotron at 15-18° C., with regular watering and light intensity for 10 days. Wheat plants in the drought group were kept in the greenhouse (22-25° C.) without watering (drought condition) but with regular light intensity for 10 days. Wheat plants in the cloudy group were kept in the greenhouse (22-25° C.) with regular watering and 50% light intensity for 7 days. Plants under the abiotic stress conditions (i.e., cold, drought, and cloudy) were then recovered in the greenhouse (22-25° C.) with regular watering and light intensity for further analyses.

TABLE 3
Summary of the reagents and stress conditions applied to wheat plants in Example 1

| Group | | Urea / N dose* | IBA | SA | Melatonin | Tween ® 80 |
|---|---|---|---|---|---|---|
| (condition) | Subgroup | (lb/acre) | (mg/L) | (mg/L) | (mg/L) | % (v/v) |
| Optimal | T1 | 94 / 43 | 0 | 0 | 0 | 0.1 |
| (22-25° C.) | T2 | 94 / 43 | 10 | 200 | 50 | 0.1 |
| | T3 | 156 / 72 | 0 | 0 | 0 | 0.1 |
| Cold | T1 | 94 / 43 | 0 | 0 | 0 | 0.1 |
| (10 days at | T2 | 94 / 43 | 10 | 200 | 50 | 0.1 |
| 15-18° C.) | T3 | 156 / 72 | 0 | 0 | 0 | 0.1 |
| Drought | T1 | 94 / 43 | 0 | 0 | 0 | 0.1 |
| (10 days at | T2 | 94 / 43 | 10 | 200 | 50 | 0.1 |
| drought) | T3 | 156 / 72 | 0 | 0 | 0 | 0.1 |
| Cloudy | T1 | 94 / 43 | 0 | 0 | 0 | 0.1 |
| (7 days at 50% | T2 | 94 / 43 | 10 | 200 | 50 | 0.1 |
| light intensity) | T3 | 156 / 72 | 0 | 0 | 0 | 0.1 |

*One-hundred (100) lb of urea contains 46 lb of nitrogen. Therefore, applying 94 lb/acre of urea is approximately equal to applying 43 lb/acre of nitrogen, and applying 156 lb/acre of urea is approximately equal to applying 72 lb/acre of nitrogen.

Cotton seeds (DP 1646 B2XF, Bayer CropScience) were sown in pots containing culture medium (peat soil:vermiculite=7:3) and placed in a greenhouse at 25-28° C. One seed was sown in one pot. Cotton plants were divided into four groups: optimal group, cold group, drought group, and cloudy group. Each group was then divided into three subgroups, T1, T2, and T3, to receive different reagents listed in Table 4. Plants in T1 and T2 subgroup were applied with lower level of urea (nitrogen dose). Plants in T2 subgroup were also applied once at V5 stage with the composition of the present invention at a rate of 2.5 ml/plant using a foliar spray treatment. Plants in T3 subgroup were applied with higher level of urea (nitrogen dose). After the application, cotton plants in the optimal group were kept in the greenhouse (25-28° C.) with regular watering and light intensity. Cotton plants in the cold group were placed in a phytotron at 15-18° C., with regular watering and light intensity for 10 days. Cotton plants in the drought group were kept in the greenhouse (25-28° C.) without watering (drought condition) but with regular light intensity for 7 days. Cotton plants in the cloudy group were kept in the greenhouse (25-28° C.) with regular watering and 50% light intensity for 11 days. Plants under the abiotic stress conditions (i.e., cold, drought, and cloudy) were then recovered in the greenhouse (25-28° C.) with regular watering and light intensity for further analyses.

TABLE 4
Summary of the reagents and stress conditions applied to cotton plants in Example 1

| Group | | Urea / N dose* | IBA | SA | Melatonin | Tween ® 80 |
|---|---|---|---|---|---|---|
| (condition) | Subgroup | (lb/acre) | (mg/L) | (mg/L) | (mg/L) | % (v/v) |
| Optimal | T1 | 264 / 121 | 0 | 0 | 0 | 0.1 |
| (25-28° C.) | T2 | 264 / 121 | 100 | 2 | 75 | 0.1 |
| | T3 | 440 / 202 | 0 | 0 | 0 | 0.1 |
| Cold | T1 | 264 / 121 | 0 | 0 | 0 | 0.1 |
| (10 days at | T2 | 264 / 121 | 100 | 2 | 75 | 0.1 |
| 15-18° C.) | T3 | 440 / 202 | 0 | 0 | 0 | 0.1 |
| Drought | T1 | 264 / 121 | 0 | 0 | 0 | 0.1 |
| (7 days at | T2 | 264 / 121 | 100 | 2 | 75 | 0.1 |
| drought) | T3 | 440 / 202 | 0 | 0 | 0 | 0.1 |
| Cloudy | T1 | 264 / 121 | 0 | 0 | 0 | 0.1 |
| (11 days at 50% | T2 | 264 / 121 | 100 | 2 | 75 | 0.1 |
| light intensity) | T3 | 440 / 202 | 0 | 0 | 0 | 0.1 |

*One-hundred (100) lb of urea contains 46 lb of nitrogen. Therefore, applying 264 lb/acre of urea is approximately equal to applying 121 lb/acre of nitrogen, and applying 440 lb/acre of urea is approximately equal to applying 202 lb/acre of nitrogen.

Corn seeds (P1197AMXT, Corteva Agriscience) were sown in pots containing culture medium (peat soil:perlite=10:1) and placed in a greenhouse at 25-28° C. One seed was sown in one pot. Corn plants were divided into four groups: optimal group, cold group, drought group, and cloudy group. Each group was then divided into three subgroups, T1, T2, and T3, to receive different reagents listed in Table 5. Plants in T1 and T2 subgroup were applied with lower level of urea (nitrogen dose). Plants in T2 subgroup were also applied once at V4 stage with the composition of the present invention at a rate of 4 ml/plant using a foliar spray treatment. Plants in T3 subgroup were applied with higher level of urea (nitrogen dose). On the next day after the application, corn plants in the optimal group were kept in the greenhouse (25-28° C.) with regular watering and light intensity. Corn plants in the cold group were placed in a phytotron at 15-18° C., with regular watering and light intensity for 10 days. Corn plants in the drought group were kept in the greenhouse (25-28° C.) without watering (drought condition) but with regular light intensity for 10 days. Corn plants in the cloudy group were kept in the greenhouse (25-28° C.) with regular watering and 50% light intensity (18,066 lux) for 10 days. Plants under the abiotic stress conditions (i.e., cold, drought, and cloudy) were then recovered in the greenhouse (25-28° C.) with regular watering and light intensity for further analyses.

TABLE 5
Summary of the reagents and stress conditions applied to corn plants in Example

| Group | | Urea / N dose* | IBA | SA | Melatonin | Tween ® 80 |
|---|---|---|---|---|---|---|
| (condition) | Subgroup | (lb/acre) | (mg/L) | (mg/L) | (mg/L) | % (v/v) |
| Optimal | T1 | 161 / 74 | 0 | 0 | 0 | 0.1 |
| (25-28° C.) | T2 | 161 / 74 | 75 | 150 | 1 | 0.1 |
| | T3 | 268 / 123 | 0 | 0 | 0 | 0.1 |
| Cold | T1 | 161 / 74 | 0 | 0 | 0 | 0 |
| (10 days at | T2 | 161 / 74 | 75 | 150 | 1 | 0.1 |
| 15-18° C.) | T3 | 268 / 123 | 0 | 0 | 0 | 0.1 |
| Drought | T1 | 161 / 74 | 0 | 0 | 0 | 0.1 |
| (10 days at | T2 | 161 / 74 | 75 | 150 | 1 | 0.1 |
| drought) | T3 | 268 / 123 | 0 | 0 | 0 | 0.1 |
| Cloudy | T1 | 161 / 74 | 0 | 0 | 0 | 0.1 |
| (10 days at 50% | T2 | 161 / 74 | 75 | 150 | 1 | 0.1 |
| light intensity) | T3 | 268 / 123 | 0 | 0 | 0 | 0.1 |

*One-hundred (100) lb of urea contains 46 lb of nitrogen. Therefore, applying 161 lb/acre of urea is approximately equal to applying 74 lb/acre of nitrogen, and applying 268 lb/acre of urea is approximately equal to applying 123 lb/acre of nitrogen.

Rice seeds (Oryza sativa subsp. indica ‘Taichung sen 10’) were sown in pots containing culture medium (acidic peat soil:regular (neutral to alkaline) peat soil=3:2) and placed in a greenhouse at 28-32° C. One seed was sown in one pot. Rice plants were divided into four groups: optimal group, cold group, drought group, and cloudy group. Each group was then divided into three subgroups, T1, T2, and T3, to receive different reagents listed in Table 6. Plants in T1 and T2 subgroup were applied with lower level of urea (nitrogen dose). Plants in T2 subgroup were also applied once at tillering stage with the composition of the present invention at a rate of 5 ml/plant using a foliar spray treatment. Plants in T3 subgroup were applied with higher level of urea (nitrogen dose). On the next day after the application, rice plants in the optimal group were kept in the greenhouse (28-32° C.) with regular watering and light intensity. Rice plants in the cold group were placed in a phytotron at 15-18° C., with regular watering and light intensity for 7 days. Rice plants in the drought group were kept in the greenhouse (28-32° C.) without watering (drought condition) but with regular light intensity for 9 days. Rice plants in the cloudy group were kept in the greenhouse (28-32° C.) with regular watering and 50% light intensity for 10 days. Plants under the abiotic stress conditions (i.e., cold, drought, and cloudy) were then recovered in the greenhouse (28-32° C.) with regular watering and light intensity for further analyses.

TABLE 6
Summary of the reagents and stress conditions applied to rice plants in Example 1

| Group | | Urea / N dose* | IBA | SA | Melatonin | Tween ® 80 |
|---|---|---|---|---|---|---|
| (condition) | Subgroup | (lb/acre) | (mg/L) | (mg/L) | (mg/L) | % (v/v) |
| Optimal | T1 | 500 / 230 | 0 | 0 | 0 | 0.1 |
| (28-32° C.) | T2 | 500 / 230 | 5 | 200 | 50 | 0.1 |
| | T3 | 692 / 318 | 0 | 0 | 0 | 0.1 |
| Cold | T1 | 500 / 230 | 0 | 0 | 0 | 0.1 |
| (7 days at | T2 | 500 / 230 | 5 | 200 | 50 | 0.1 |
| 15-18° C.) | T3 | 692 / 318 | 0 | 0 | 0 | 0.1 |
| Drought | T1 | 500 / 230 | 0 | 0 | 0 | 0.1 |
| (9 days at | T2 | 500 / 230 | 5 | 200 | 50 | 0.1 |
| drought) | T3 | 692 / 318 | 0 | 0 | 0 | 0.1 |
| Cloudy | T1 | 500 / 230 | 0 | 0 | 0 | 0.1 |
| (10 days at 50% | T2 | 500 / 230 | 5 | 200 | 50 | 0.1 |
| light intensity) | T3 | 692 / 318 | 0 | 0 | 0 | 0.1 |

*One-hundred (100) lb of urea contains 46 lb of nitrogen. Therefore, applying 500 lb/acre of urea is approximately equal to applying 230 lb/acre of nitrogen, and applying 692 lb/acre of urea is approximately equal to applying 318 lb/acre of nitrogen.

Soybean seeds (P29A25X, Roundup Ready 2 Xtend®, Corteva Agriscience) were sown in pots containing culture medium (peat soil:vermiculite=3:1) and placed in a greenhouse at 25-28° C. One seed was sown in one pot. Soybean plants were divided into four groups: optimal group, cold group, drought group, and cloudy group. Each group was then divided into three subgroups, T1, T2, and T3, to receive different reagents listed in Table 7. Plants in T1 and T2 subgroup were applied with lower level of urea (nitrogen dose). Plants in T2 subgroup were also applied once at V3 stage with the composition of the present invention at a rate of 0.02 ml/plant using a foliar spray treatment. Plants in T3 subgroup were applied with higher level of urea (nitrogen dose). On the next day after the application, soybean plants in the optimal group were kept in the greenhouse (25-28° C.) with regular watering and light intensity. Soybean plants in the cold group were placed in a phytotron at 15-18° C., with regular watering and light intensity for 10 days. Soybean plants in the drought group were kept in the greenhouse (25-28° C.) without watering (drought condition) but with regular light intensity for 10 days. Soybean plants in the cloudy group were kept in the greenhouse (25-28° C.) with regular watering and 50% light intensity for 7 days. Plants under the abiotic stress conditions (i.e., cold, drought, and cloudy) were then recovered in the greenhouse (25-28° C.) with regular watering and light intensity for further analyses.

TABLE 7
Summary of the reagents and stress conditions
applied to soybean plants in Example 1

| Group | | Urea / N dose* | IBA | SA | Melatonin | Tween ® 80 |
|---|---|---|---|---|---|---|
| (condition) | Subgroup | (lb/acre) | (mg/L) | (mg/L) | (mg/L) | % (v/v) |
| Optimal | T1 | 94 / 43 | 0 | 0 | 0 | 0.1 |
| (25-28° C.) | T2 | 94 / 43 | 1 | 100 | 100 | 0.1 |
| | T3 | 150 / 69 | 0 | 0 | 0 | 0.1 |
| Cold | T1 | 94 / 43 | 0 | 0 | 0 | 0.1 |
| (10 days at | T2 | 94 / 43 | 1 | 100 | 100 | 0.1 |
| 15-18° C.) | T3 | 150 / 69 | 0 | 0 | 0 | 0.1 |
| Drought | T1 | 94 / 43 | 0 | 0 | 0 | 0.1 |
| (10 days at | T2 | 94 / 43 | 1 | 100 | 100 | 0.1 |
| drought) | T3 | 150 / 69 | 0 | 0 | 0 | 0.1 |
| Cloudy | T1 | 94 / 43 | 0 | 0 | 0 | 0.1 |
| (7 days at 50% | T2 | 94 / 43 | 1 | 100 | 100 | 0.1 |
| light intensity) | T3 | 150 / 69 | 0 | 0 | 0 | 0.1 |

*One-hundred (100) lb of urea contains 46 lb of nitrogen. Therefore, applying 94 lb/acre of urea is approximately equal to applying 43 lb/acre of nitrogen, and applying 150 lb/acre of urea is approximately equal to applying 69 lb/acre of nitrogen.

### 2. Analyses

### 2.1 Gene Expression

i. RNA Extraction

RNA extraction procedure was carried out according to the instructions of RNA Plus mini kit (Lab Prep). One-hundred (100) micrograms of leaves were frozen and ground thoroughly using a pre-cooled mortar and pestle with liquid nitrogen to obtain a fine powder and then transferred into a 2 mL Eppendorf tube. Next, 450 μL of the lysis buffer TRLL was added and vortexed vigorously, and then the lysate was transferred to a DNgone Filter Column using a 2 mL collection tube. The samples were centrifuged for 2 minutes at 14,000×g, and then the flow-through was transferred to a new 1.5 mL tube. Next, 0.5 volumes of ethanol (96%-100%) was added to each tube and immediately mixed by pipetting. Subsequently, the sample was transferred to an RNA Spin Column, placed in a 2 mL collection tube, and centrifuged for 15 seconds at 10,000×g. The flow-through was discarded, and then 700 μL of Buffer TRW1 was added to the RNA Spin Column and centrifuged for 15 seconds at 10,000×g, and then the emerged flow-through at this step was discarded. Next, 500 μL of Buffer TRW2 was added to the RNA Spin Column and centrifuged for 15 seconds at 10,000×g. The flow-through was discarded, and 500 μL of Buffer TRW2 was added to the RNA Spin Colum and centrifuged for 2 minutes at 10,000×g. The RNA Spin Colum was placed in a new 1.5 mL collection tube, and 30 μL of RNase-free water was added directly to the membrane of a spin column and centrifuged for 1 minute at 10,000×g to elute the RNA.

ii. Quality and Integrity of Extracted RNA

Protein and phenol/carbohydrate contaminations were considered based on the A260/280 and A260/230 records, respectively, using a Nanodrop ND-2000c spectrophotometer (ImplenNanoPhotometer, Munich, Bavaria, Germany).

iii. cDNA Synthesis

Reverse transcriptase PCR was performed to assess the quality of total RNA before further processing. A concentration of 0.5 μg/μL total RNA was used for first-strand cDNA synthesis using the iScript™ gDNA Clear cDNA Synthesis Kit (Bio-Rad) according to the manufacturer's instructions.

iv. Quantitative Real-time PCR Analysis

The expression experiment was performed using a 96 well plate on a CFX Connect machine (BIO-RAD, Hercules, USA) with the SsoFast EvaGreen Supermix (Bio-Rad). The final RT reaction volume was 20 μL, which consisted of 10 μL 2× SsoFast EvaGreen Supermix (Bio-Rad), 0.25 μM of forward primer and 0.25 μM reverse primer. The PCR cycling condition was as follows: step 1, 95° C. for 30 seconds; step 2, 95° C. for seconds; step 3, 60° C. for 5 seconds; step 4, repeat step 2 to step 3 for 44 times. Three biological replicates (each comprising three technical replicates) were performed. Water was used as a blank control instead of cDNA templates.

v. The Evaluation of Reference Gene Expression Stability

The Ct values were generated by the CFX Manager™ software (BIO-RAD, Hercules, USA) and the data then employed to analyze the gene expression levels.

### 2.2 SPAD Measurement

Minolta Special products analysis division (SPAD) units is a common relative index related to chlorophyll content. Used the portable chlorophyll (Chl) meter SPAD-502 Plus (Konica Minolta Optics, Japan) to measure the SPAD of young leaves.

### 2.3 Determination of Chlorophyll Content

Thirty (30) milligrams of leave tissue were ground by mixer mill (Retsch MM-400), and extracted by 1 mL 80% acetone in dark until the tissue turned into white. The extracted solution was then centrifuged at 15,000×g for 5 minutes. Two-hundred (200) microliters of clear supernatant were loaded on 96-well microtiter plate, and total chlorophyll was determined from the absorbance at 645 nm and 663 nm using Spark® multimode microplate reader (Tecan, Sweden). Total chlorophyll content was calculated as: 20.2×A₆₄₅+8.02×A₆₆₃ (mg·L⁻¹).

### 2.4 Electron Transport Rate (ETR) Measurement

Chlorophyll a fluorescence measurement was conducted for the electron transport rate (ETR) analysis. The chlorophyll a fluorescence measurement was carried out using a portable photosynthesis system with 6400-40 leaf chamber fluorometer (LI-6400 XT; LI-COR Inc., Lincoln, NE, USA), following recommended procedures in the LI-COR 6400 manual. The chlorophyll fluorescence was measured on the upper mature light-adapted leaves of the crop plants. The values of maximal fluorescence of light-adapted state (Fm′) and steady-state fluorescence (Fs), effective quantum yield of PSII photochemistry (ΦPSII) [ΦPSII=(Fm′−Fs)/Fm′] and ETR (ETR=ΦPSII×PAR×0.84×0.5) were determined and calculated by the equipment, where photosynthetically active radiation (PAR) was set as 1000 umol m⁻² s⁻¹.

### 2.5 Extraction and Quantification of Phytohormones

Two-hundred (200) milligrams of fresh leaves were ground and mixed with 1 mL phosphate buffer saline (PBS), pH 7.4. The mixture was centrifuged at 4° C., 11,000 rpm for 15 minutes. The supernatant was prepared for measurement of phytohormones. Zeatin, GA, ABA and IAA were determined by Plant zeatin (ZT) ELISA Kit (Cat. No: CK-bio-20589), Plant Gibberellic Acid (GA) ELISA Kit (Cat. No: CKbio-CA19073), Plant hormone abscisic acid (ABA) ELISA Kit (Cat. No: CK-bio-19156) and Plant Indole Acetic Acid (IAA) ELISA Kit (Cat. No: CK-bio-19157) from Shanghai Coon Koon Biotech Co., Ltd., respectively. Absorbance at 450 nm was measured with Spark® multimode microplate reader (Tecan, Sweden). Finally, the contents of phytohormones were calculated from the standard-curve.

### 2.6 Determination of Soluble Sugar Content

One-hundred (100) milligrams of fresh leaves were ground and mixed with 1 ml 80% (v/v) ethanol. The mixture was heated at 80° C. for 2 minutes. The sample was mixed with 30 mg activated charcoal and incubated for 5 minutes and then centrifuged at 10,000×g for 15 minutes. Supernatant was collected and dried at 50° C. to evaporate the ethanol, and distilled water was added to bring each sample to its original volume. Glucose (HK) Assay Kit from Sigma (product code GAHK-20) was used to determine the concentrations of glucose (Absorbance was measured at 340 nm with Spark® multimode microplate reader (Tecan, Sweden). Zero point twenty-five (0.25) units of phosphoglucose isomerase was added to the sample to determine the concentrations of fructose. Eighty-three (83) units of invertase was added to the sample to determine the concentrations of sucrose. Finally, the contents of all soluble sugar were calculated from the glucose standard-curve.

### 2.7 Enzyme Activities of Nitrogen Assimilation

i. Glutamine Synthetase (GS)

Two-hundred (200) milligrams of leave tissue were ground with liquid nitrogen by mixer mill (Retsch MM-400), and was homogenized in 1 mL extraction buffer containing 10 mM Tris-HCl (pH 7.6), 1 mM EDTA, 1 mM MgCl₂, and 10 mM 2-mercaptoethanol. The extracted solution was then centrifuged at 15,000×g for 15 minutes at 4° C. One-hundred (100) microliters of clear supernatant were mixed with 400 μl reaction buffer containing 100 mM Tris-HCl (pH 8.0), 50 mM L-glutamate, 10 mM ATP, 30 mM MgSO₄, and 20 mM NH₂OH—HCl, and was then reacted at 30° C. incubator for 30 minutes. The reaction was stopped by 1 mL stop buffer containing 1.5 M HCl, 1.5 mM FeCl₃, and 1.5 mM TCA (Trichloroacetic acid). The samples mixed with stop buffer were centrifuged at 15,000×g for 5 minutes at room temperature. Two-hundred (200) microliters of clear supernatant was loaded on 96-well microtiter plate, and GS activity was determined from the absorbance at 540 nm using Spark® multimode microplate reader (Tecan, Sweden).

ii. NADH-GOGAT

The extraction procedure of NADH-GOGAT was the same as that of GS. Twenty (20) microliters of clear supernatant were loaded on 96-well microtiter plate, and then 200 μl reaction buffer containing 20 mM L-glutamine, 2 mM 2-oxoglutarate, 10 mM KCl, 3 mM NADH, and 25 mM Tris-HCl (pH7.6) was added to each well. NADH-GOGAT activity was measured the changes of A340 excitation and A445 emission per 1 minute until 10 minutes.

iii. Nitrate Reductase (NR)

Two-hundred (200) milligrams of leave tissue were ground with liquid nitrogen by mixer mill (Retsch MM-400), and was homogenized in 1 mL extraction buffer containing 100 mM potassium phosphate buffer (pH 7.4), 7.5 mM cysteine, 1 mM EDTA, and 1.5% casein. The extracted solution was then centrifuged at 15,000×g for 15 min at 4° C. Three-hundred (300) microliters of clear supernatant were mixed with 700 μl reaction buffer containing 100 mM potassium phosphate buffer (pH 7.4), 10 mM EDTA, 150 μM NADH, and 100 mM KNO₃, and the sample was then reacted at 30° C. incubator for 30 minutes. The reaction was stopped by 50 μL 1 M zinc acetate. The samples mixed with stop buffer were centrifuged at 15,000×g for 5 minutes at room temperature. Seventy-five (75) microliters of clear supernatant were loaded on 96-well microtiter plate, and then 75 μL 5.8 mM sulphanilamide and 75 μL 0.8 mM N-(1-naphthyl) ethylenediamin (NNEDD) were added. The samples were mixed well and reacted for 30 minutes. NR activity was determined from the absorbance at 540 nm using Spark® multimode microplate reader (Tecan, Sweden).

### 2.8 Determination of Soluble Protein Content

One-hundred (100) milligrams of leave tissue were ground with liquid nitrogen by mixer mill (Retsch MM-400), and was homogenized in 1 mL PBS (pH 7.4). The extracted solution was then centrifuged at 15,000×g for 15 minutes at 4° C. One (1) microliter of clear supernatant was loaded on 96-well microtiter plate, and then 49 μl PBS (pH 7.4) and 200 μl Bradford reagent (Sigma Aldrich) were added. Soluble protein content was determined by the absorbance at 595 nm using Spark® multimode microplate reader (Tecan, Sweden).

### 2.9 Nitrogen and Carbon Content Analysis

Two (2) to 10 mg of dried and fine-grinded samples were weighted in tin capsule (depending on the sample property). After wrapping the capsule, the sample was introduced into the organic elemental analyzer (Flash 2000, Thermo Fisher Scientific) via the autosampler (MAS 200R, Thermo Fisher Scientific) with excess oxygen. The temperature of combust reactor was 950° C. For simultaneous N/C analysis, after combustion, the resulted gases were carried by a helium flow to a reaction column filled with copper and copper oxide, respectively. The combustion gases were separated by a GC column, and finally, detected by a thermal conductivity detector.

### 2.10 Other Nutrient Elements Analysis (Mineral Elements)

Plant samples were ground into powder. Zero point fifteen (0.15) grams of the powder were mixed with 5 mL 69% nitric acid (UNI-Onward). The mixtures were digested with microwave at 180° C. (+5° C.) for 10 minutes. After the digestion, the volume adjusted up to an appropriate volume with deionized water and the samples were filtered with 0.45 μm filter. All samples were analyzed for nutrient elements using inductively coupled plasma optical emission spectrometry (ICP-OES iCap 7400, Thermo Fisher Scientific). Diluted element standards to 10 ppm with 2% nitric acid. The ranges of the calibration curves (10 points) were selected to match the expected concentrations for all tested elements.

### 2.11 Determination of Protein Content in Grains

Two (2) to 10 mg of dried and fine-grinded grain samples were weighted in tin capsule (depending on the sample property). Nitrogen content measured by organic elemental analyzer (Flash 2000, Thermo Fisher Scientific) was multiplied by a specific (Jones) factor to arrive at protein content. Factor for wheat (whole kernel) was 5.83, soybean was 5.71, and corn was 6.25.

### 2.12 Determination of Starch Content in Grains (Phenol-Sulfuric Acid Method)

Grains were ground into powder and dried at 105° C. for 20 minutes. Two-hundred (200) milligrams of sample were mixed with 1 mL deionized water by vortexing. After centrifugation for 5 minutes at 3000 rpm, soluble carbohydrates dissolved in water were discarded, and then the pellet containing starch was mixed with 1 mL 3 M HCl by vortexing. The sample was heated at 100° C. for 45 minutes. One hundred (100) microliters of the sample were mixed with 100 μL 3 M NaOH and 300 μL deionized water after the mixture cool down to room temperature. The sample was then centrifuged for 5 minutes at 13,000 rpm. Four (4) microliters of the supernatant were mixed with 25 μL 5% phenol and 125 μL H₂SO₄, and the product was yellow-gold color. Starch concentration was determined from the absorbance at 490 nm and calculated from the glucose standard-curve.

### 2.13 Crude Lipid Evaluation in Soybean Seeds

Lipid extraction by Soxhlet (1879, Die gewichtsanalytische bestimmung des milchfettes. Polytechnisches J 232:461-465) method was performed. Soybean seeds were ground thoroughly with the grinding machine. Seed powder and filter paper cartridges (150 mm, ADVANTED) were dried overnight at 105° C. Two (2) grams of seed samples (weight 1, W1) were placed into pre-weighted cartridges (weight 2, W2), and packaged inside the Soxhlet apparatus. Lipids were extracted with 150 mL of boiling n-hexane for 6 hours. The “seed packets” were then dried and weighted (weight 3, W3). The percentages of crude lipid in seeds were calculated using the following formula: [(W1+W2-W3)/W1]×100%.

### 2.14 Analyses of Leaf Area

The leaf area of wheat, soybean, and rice was scanned by EPSON scanner and analyzed by a leaf analyzer (WinFOLIA™, Regent Instruments Inc., Québec, Canada). The leaf area of cotton was measured and calculated by the following formula: 0.81×length×width. In addition, leaves and stems of each sample plant were dried at 50° C. overnight, and then the dry weight was measured.

### 2.15 Analyses of Root Length and Dry Weight

On the sampling day, length of plant root was measured by a root analyzer (WinRHIZO™, Regent Instruments Inc., Quebec, Canada). In addition, roots of each plant were dried at 50° C. overnight, and then the dry weight was measured.

### 2.16 Yield Analyses

Wheat plants were harvested after the grains had reached maturity, and the spikes were dried at 55° C. for one week. The dried spikes and kernels were weighted and calculated for yield analyses. In addition, representative spikes were selected, and grains were taken out from each spikelet and arranged on the left side of the spikelet for morphology observation.

Cotton were harvested when around 70% capsule wall of the boll split. The bolls were weighted and counted for yield analyses. In addition, bolls at the bottom five fruiting branches (early bolls) and bolls at the first position (first position bolls) were collected and counted, and the numbers of early bolls and first position bolls were divided respectively by the number of total bolls to calculate the percentage of numbers. Corn ears were harvested after the grains had reached maturity. The ears and grains were weighted and calculated for yield analyses. In addition, representative ears of each group were selected to photograph for morphology observation.

Rice plants were harvested after the grains had reached maturity, and the panicles were dried at 65° C. for two days. The dried panicles and grains were weighted and calculated for yield analyses. In addition, representative panicles were selected and the branches were spread out to photograph for morphology observation.

Soybean plants were harvested at R8 stage (full maturity), and the grains were dried at 30° C. for two days. The dried grains were weighted and calculated for yield analyses. In addition, representative plants were selected, and the seeds were taken and divided into mature and immature parts for morphology observation.

### 2.17 Statistics

Unpaired Student's t-test was applied to assess numerical data statistical significance. Statistical significance was set at p-value less than 0.05.

### B. Results

### 1. Effects on Induction of Gene Expression

Gene expression, which covers multi-faceted information, is a way to understand the effects of the composition of the present invention. Gene expression was analyzed to evaluate the potential of the composition to promote plant growth and nitrogen utilization. The up-regulated genes in the aspects of root growth, photosynthesis, and nitrogen uptake and assimilation revealed the contributions of the composition.

### 1.1 Gene Expression of Wheat

Wheat samples for gene expression were collected on the first day after the application of the reagents listed in Table 3 or recovering from stress. The genes were selected from relevant references and classified as root-related genes (R), photosynthesis-related genes (P), nitrogen uptake and assimilation-related genes (N). The expression value was normalized to the GAPDH expression level. Relative gene expression of T2 and T3 were obtained by comparing with T1.

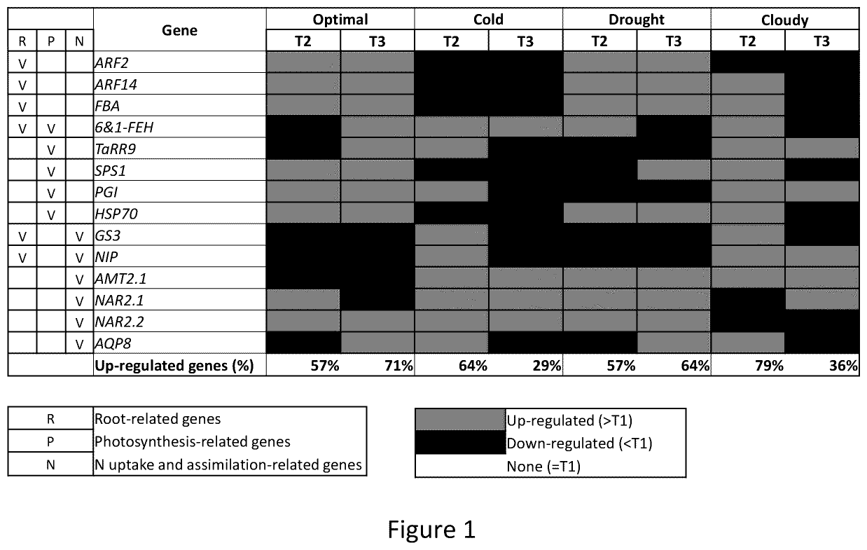

As shown in FIG. 1, under all of the conditions, the majority of the genes listed in Table 8 are up-regulated in T2 group (optimal, 57%; cold, 64%; drought, 57%; cloudy, 79%), which was applied with lower level of nitrogen dose and the composition of the present invention. In contrast, applying with higher level of nitrogen dose (T3 group) does not up-regulate most of the genes under cold (29%) and cloudy conditions (36%), indicating that the composition of the present invention promotes plant growth better than applying higher level of nitrogen dose under cold and cloudy conditions. The up-regulation caused by the composition of the present invention is most frequent in cloudy condition, reaching 79%. The generally up-regulated genes suggest that the composition of the present invention increases the activity in the aspects of root growth, photosynthesis, and nitrogen uptake and assimilation.

TABLE 8
List of the analyzed genes in wheat in Example 1

| Gene Name | Annotated function |
|---|---|
| ARF2 | Auxin response factors (ARFs) are transcriptional factors that bind |
| | specifically to the DNA sequence 5′-TGTCTC-3′ found in the auxin- |
| | responsive promoter elements (AuxREs). ARFs as transcriptional |
| | activators or repressors have important roles in plant growth, such as |
| | lateral root development. |
| ARF14 | Auxin response factors (ARFs) are transcriptional factors that bind |
| | specifically to the DNA sequence 5′-TGTCTC-3′ found in the auxin- |
| | responsive promoter elements (AuxREs). ARFs as transcriptional |
| | activators or repressors have important roles in plant growth, such as |
| | lateral root development. |
| FBA | Fructose-bisphosphate aldolase (FBA) is a key enzyme in glycolysis |
| | and gluconeogenesis. FBA is also involved in gibberellin-mediated root |
| | growth and the vacuolar proton ATPase-mediated control of root cell |
| | elongation. |
| 6&1-FEH | 6&1-FEH (fructan exohydrolase) participates in the degradation of |
| | fructans which are fructose oligomers or polymers. Unexpectedly, FEH |
| | also presents in non-fructan plants. Furthermore, FEH expression |
| | profile was strongly correlated with plant development and in response |
| | to drought, cold and abscisic acid, indicating that it might increase |
| | stress tolerance in agricultural crops. |
| TaRR9 | Two-component response regulator RR9 functions as a response |
| | regulator involved in His-to-Asp phosphorelay signal transduction |
| | system. Phosphorylation of the Asp residue in the receiver domain |
| | activates the ability of the protein to promote the transcription of target |
| | genes. |
| SPS1 | SPS1 (Sucrose-phosphate synthase 1) plays a major role in |
| | photosynthetic sucrose synthesis by catalyzing the rate-limiting step of |
| | sucrose biosynthesis from UDP-glucose and fructose- 6-phosphate. |
| | Plants silencing SPS1 show reduced shoot growth, leaf fresh weight |
| | and dry weight, and decreased leaf starch, leaf sugar levels and sucrose |
| | export rates. |
| PG1 | PG1 (Glucose-6-phosphate isomerase 1) promotes the synthesis of |
| | starch in leaves. PG1 is involved in the gluconeogenesis pathway, |
| | which is part of carbohydrate biosynthesis. |
| HSP70 | Hsp70 (Heat shock 70 kDa protein) facilitates folding of de novo |
| | synthesized proteins and translocation of precursor proteins into |
| | organelles. Under stress conditions, Hsp70 maintains protein |
| | homeostasis through degradation of damaged proteins or refolding of |
| | misfolded proteins. |
| GS3 | GS (Glutathione synthetase) participates in glutathione synthesis. |
| | Glutathione is produced from three amino acids, glutamate, cysteine |
| | and glycine, through two steps catalyzed by γ-glutamylcysteine ligase |
| | and GS respectively. |
| NIP | The nodulin 26-like intrinsic protein (NIP) family is a group of highly |
| | conserved multifunctional major intrinsic proteins that are unique to |
| | plants, and which transport a variety of uncharged solutes ranging from |
| | water to ammonia to glycerol. |
| AMT2.1 | Ammonium transporter (AMT)-mediated acquisition of ammonium |
| | nitrogen from soils is essential for the nitrogen demand of plants. |
| | Additionally, AMTs participate in many other physiological processes |
| | such as transporting ammonium from symbiotic fungi to plants, |
| | transporting ammonium from roots to shoots, transferring ammonium |
| | in leaves and reproductive organs, or facilitating resistance to plant |
| | diseases via ammonium transport. |
| NAR2.1 | NAR2.1 (Component of high-affinity nitrate transporter) is involved in |
| | nitrate transport. |
| NAR2.2 | NAR2.2 (High-affinity nitrate transporter) is involved in nitrate |
| | transport. |
| AQP8 | Aquaporin 8 Protein (AQP8), a water channel protein, is responsible |
| | for permeation of water and ammonia across cell membranes. |

### 1.2 Gene Expression of Cotton

Cotton samples for gene expression were collected on the first day after the application of the reagents listed in Table 4 or recovering from stress. The genes were selected from relevant references and classified as root-related genes (R), photosynthesis-related genes (P), nitrogen uptake and assimilation-related genes (N). The expression value was normalized to the histone 3.3 gene expression level. Relative gene expression of T2 and T3 were obtained by comparing with T1.

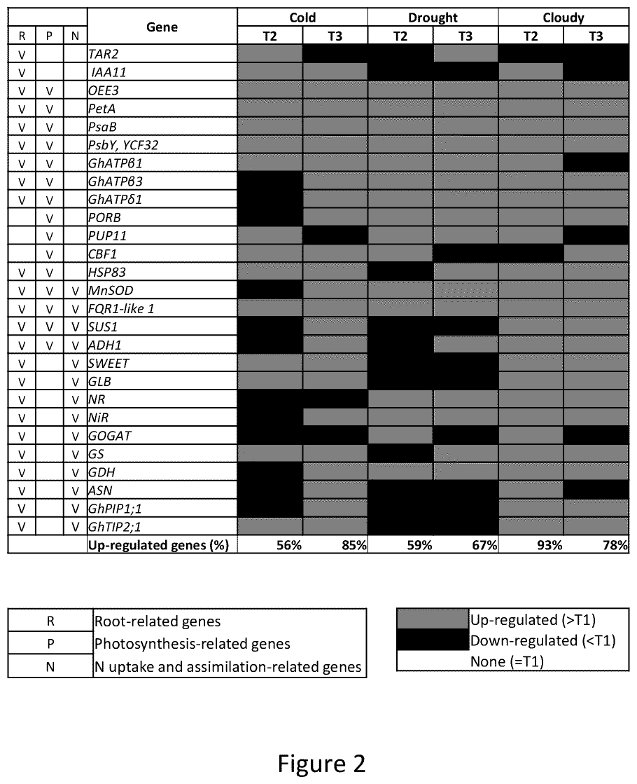

As shown in FIG. 2, under all of the conditions, the majority of the genes listed in Table 9 are up-regulated in T2 group (cold, 56%; drought, 59%; cloudy, 93%), which was applied with lower level of nitrogen dose and the composition of the present invention. The up-regulation caused by the composition of the present invention is most frequent and higher than that caused by higher level of nitrogen dose in cloudy condition, reaching 93%, indicating that the composition of the present invention promotes plant growth better than applying higher level of nitrogen dose under cloudy condition. The generally up-regulated genes suggest that the composition of the present invention increases the activity in the aspects of root growth, photosynthesis, and nitrogen uptake and assimilation.

TABLE 9
List of the analyzed genes in cotton in Example 1

| Gene Name | Annotated function |
|---|---|
| TAR2 | TRA2 (Tryptophan aminotransferase-related protein 2) is involved |
| | in auxin production and proper auxin level maintenance in roots. |
| IAA11 | IAA11 (Auxin responsive protein IAA11-like), a short-lived |
| | transcriptional factor, functions as a repressor of early auxin |
| | response genes at low auxin concentrations. |
| OEE3 | OEE3/PSBQ1 (Oxygen-evolving enhancer 3) is required for |
| | photosystem II assembly/stability and photoautotrophic growth |
| | under low light conditions. |
| PetA | The PetA gene encodes a subunit of the cytochrome b6-f complex, |
| | Cytochrome f, which mediates electron transfer between |
| | photosystem II (PSII) and photosystem I (PSI), cyclic electron flow |
| | around PSI, and state transitions. |
| PsaB | PsaB (Photosystem I P700 chlorophyll a apoprotein A2) is one of |
| | the subunits of the photosystem I complex, which catalyzes the |
| | light-driven electron transfer. |
| PsbY, YCF32 | PSBY, photosystem II core complex proteins, are manganese- |
| | binding polypeptides with L-arginine metabolizing enzyme activity. |
| GhATPβ1 | ATP synthase β-subunit 1(GhATPβ1) forms the catalytic site of |
| | ATP synthase which catalyzes the formation of the energy storage |
| | molecule ATP. |
| GhATPβ3 | ATP synthase β-subunit 3 (GhATPβ3) forms the catalytic site of |
| | ATP synthase which catalyzes the formation of the energy storage |
| | molecule ATP. |
| GhATPδ1 | ATP synthase δ-subunit 1 (GhATPδ1) forms the stator stalk of ATP |
| | synthase which catalyzes the formation of the energy storage |
| | molecule ATP. |
| PORB | PORB (Protochlorophyllide reductase B) catalyzes the light-driven |
| | transformation of protochlorophyllide to chlorophyllide in the |
| | chlorophyll biosynthesis pathway. |
| PUP11 | PUP11 (Purine permease11), a probable purine transporter, may be |
| | involved in the transport of purine and purine derivatives, such as |
| | cytokinins, across the plasma membrane. |
| CBF1 | CBF1 (C-repeat binding transcription factor 1), a transcriptional |
| | activator, plays pivotal roles in freezing tolerance and cold |
| | acclimation. |
| HSP83 | Heat shock protein83 (HSP83) is homologous to the chaperone |
| | HSP90 that facilitates stabilizing and refolding of misfolded |
| | proteins in response to environmental cues, such as thermal shock. |
| MnSOD | MnSOD (Manganese superoxide dismutase), an essential |
| | antioxidant enzyme, plays an important role for increasing stress |
| | tolerance in crop plants. |
| FQR1-like 1 | FQR1 (NAD(P)H dehydrogenase (quinone) FQR1-like 1) catalyzes |
| | the transfer of electrons from NADH and NADPH to quinones. It |
| | may act as detoxification enzyme and protect against auxin-induced |
| | oxidative stress. |
| SUS1 | SUS1 (Sucrose synthase 1), a glucosyltransferase, catalyzes a |
| | reversible cleavage of sucrose into UDP-glucose and fructose for |
| | various metabolic pathways such as energy production, primary- |
| | metabolite production, and the synthesis of complex carbohydrates. |
| ADH1 | Alcohol dehydrogenase (ADH) plays a central role in the metabolism |
| | of alcohols and aldehydes. ADH1 responds to environmental stress |
| | and requires for survival and acclimation in hypoxic conditions, |
| | especially in roots. |
| SWEET | The SWEET sugar transporter family plays multiple roles in plant |
| | physiological activities and developmental processes, such as sugar |
| | transport and absorption, reproductive tissue development, |
| | senescence, stress responses and plant-pathogen interaction. |
| GLB | GLB (Beta-galactosidase) catalyzes the hydrolysis of terminal non- |
| | reducing beta-D-galactose residues in beta-D-galactosides. |
| NR | Nitrate reductase (NR) is a key enzyme involved in the first step of |
| | nitrate assimilation in plants. |
| NiR | Nitrite reductase protein (NiR) catalyzes nitrite reduction to |
| | ammonium in the process of nitrate assimilation. |
| GOGAT | Glutamate synthase (GOGAT) and Glutamine synthetase (GS) |
| | catalyzes the conversion of ammonium and 2-oxoglutarate to |
| | glutamine and glutamate, which facilitates the ammonium |
| | assimilation in roots. |
| GS | Glutamate synthase (GOGAT) and Glutamine synthetase (GS) |
| | catalyzes the conversion of ammonium and 2-oxoglutarate to |
| | glutamine and glutamate, which facilitates the ammonium |
| | assimilation in roots. |
| GDH | Glutamate dehydrogenase (GDH) enzyme catalyzes the reversible |
| | conversion of ammonia and2-oxoglutarate into glutamate, which |
| | facilitates nitrogen assimilation. |
| ASN | Asparagine synthetase (ASN) catalyzes the synthesis of asparagine |
| | in the process of ammonium assimilation. |
| GhPIP1; 1 | PIPs (plasma membrane intrinsic proteins), a subfamily of |
| | aquaporins, are the main gateways for cell membrane water |
| | exchange. Aquaporins are multifunctional channels that facilitate |
| | the passage of water and/or other small solutes across cell |
| | membranes. |
| GhTIP2; 1 | TIPs (Tonoplast intrinsic proteins), a subfamily of aquaporins, |
| | facilitate the movement of water, small uncharged solutes (glycerol, |
| | urea, boric acid, silicic acid, hydrogen peroxide) and gases |
| | (ammonia, carbon dioxide) across biological membranes. |

### 1.3 Gene Expression of Corn

Corn samples for gene expression were collected on the first day after the application of the reagents listed in Table 5 or recovering from stress. The genes were selected from relevant references and classified as root-related genes (R), photosynthesis-related genes (P), nitrogen uptake and assimilation-related genes (N). The expression value was normalized to the UBF9 expression level. Relative gene expression of T2 and T3 were obtained by comparing with T1.

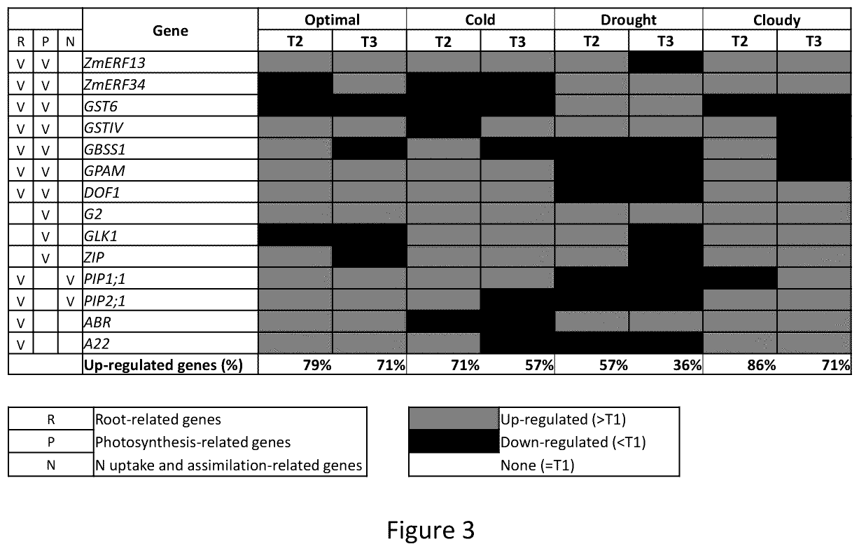

As shown in FIG. 3, under all of the conditions, the majority of the genes listed in Table 10 are up-regulated in T2 group (optimal, 79%; cold, 71%; drought, 57%; cloudy, 86%), which was applied with lower level of nitrogen dose and the composition of the present invention. In contrast, applying with higher level of nitrogen dose (T3 group) only up-regulates 37 percentage of these genes under drought conditions. The up-regulation caused by the composition of the present invention is generally higher than that caused by higher level of nitrogen dose, indicating that the composition of the present invention promotes plant growth better than applying higher level of nitrogen dose under all the conditions. The up-regulation caused by the composition of the present invention is most frequent in cloudy condition, reaching 86%. The generally up-regulated genes suggest that the composition of the present invention increases the activity in the aspects of root growth, photosynthesis, and nitrogen uptake and assimilation.

TABLE 10
List of the analyzed genes in corn in Example 1

| Gene Name | Annotated function |
|---|---|
| ZmERF13 | Ethylene-responsive transcription factor 13 (ERF13) is involved in the |
| | stress response. |
| ZmERF34 | Ethylene-responsive transcription factor ERF034 (ERF34) may be |
| | involved in the stress response. |
| GST6 | Glutathione S-transferases (GST), a family of detoxification enzymes, |
| | catalyze the conjugation of the reduced form of glutathione (GSH) to |
| | xenobiotic substrates. |
| GSTIV | Glutathione S-transferases (GST), a family of detoxification enzymes, |
| | catalyze the conjugation of the reduced form of glutathione (GSH) to |
| | xenobiotic substrates. |
| GBSS1 | Granule-bound starch synthase 1 (GBSS1) is required for the synthesis |
| | of amylose which is a part of glycan biosynthesis. Glycans are involved |
| | in cell wall biosynthesis, nascent protein folding, signal transduction in |
| | defense responses, and energy metabolism. |
| GPAM | Glycerol-3-phosphate acyltransferase (GPAM) is involved in an essential |
| | step in glycerolipids biosynthesis. Glycerolipids are necessary for |
| | membrane formation, caloric storage, and intracellular signaling |
| | processes. |
| DOF1 | Transcription factor DOF1 (DNA binding with one finger) is involved in |
| | the activation of photosynthetic genes in maize. |
| G2 | Transcription factor golden2 (G2) up-regulates target genes of |
| | chloroplast-localized and photosynthesis-related proteins. |
| GLK | Golden2-like (GLK) transcription factors are involved in chloroplast |
| | development. |
| ZIP | The ZIP (Zinc inducible protein) transporters are involved in cellular |
| | uptake of zinc, which plays critical role of numerous metalloenzymes |
| | and Zn-dependent transcription factors. |
| PIP1; 1 | PIPs (plasma membrane intrinsic proteins), a subfamily of aquaporins, |
| | are the main gateways for cell membrane water exchange. Aquaporins |
| | are multifunctional channels that facilitate the passage of water and/or |
| | other small solutes across cell membranes. |
| PIP2; 1 | PIPs (plasma membrane intrinsic proteins), a subfamily of aquaporins, |
| | are the main gateways for cell membrane water exchange. Aquaporins |
| | are multifunctional channels that facilitate the passage of water and/or |
| | other small solutes across cell membranes. |
| ABR | ABR (ABA-responsive protein) is responsible for several abiotic stress, |
| | especially by ABA. |
| A22 | The expression of A22 is induced by ABA and environmental stresses, |
| | which may function in stress tolerance. |

### 1.4 Gene Expression of Rice

Rice samples for gene expression were collected on the first day after the application of the reagents listed in Table 6 or recovering from stress. The genes were selected from relevant references and classified as root-related genes (R), photosynthesis-related genes (P), nitrogen uptake and assimilation-related genes (N). The expression value was normalized to the UBQ expression level. Relative gene expression of T2 and T3 were obtained by comparing with T1.

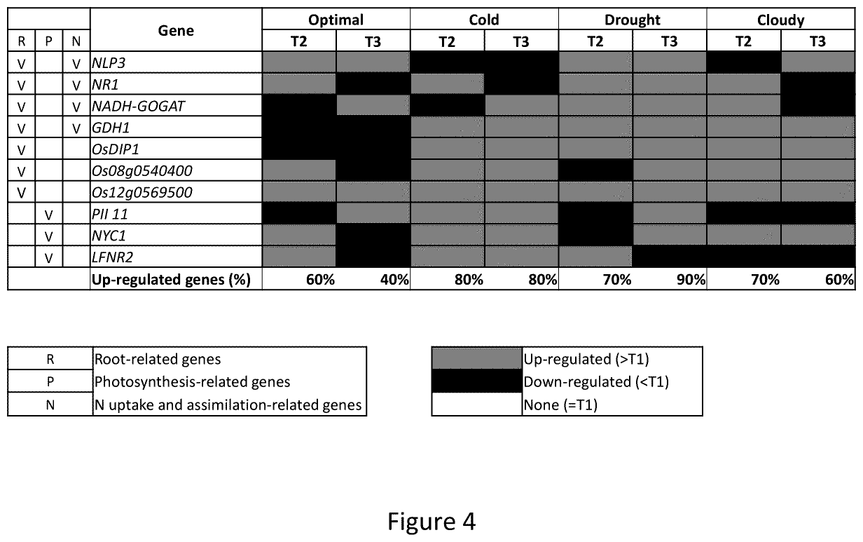

As shown in FIG. 4, under all of the conditions, the majority of the genes listed in Table 11 are up-regulated in T2 group (optimal, 60%; cold, 80%; drought, 70%; cloudy, 70%), which was applied with lower level of nitrogen dose and the composition of the present invention. The up-regulation caused by the composition of the present invention is higher than that caused by higher level of nitrogen dose under optimal (T2, 60%; T3, 40%) and cloudy conditions (T2, 70%; T3, 60%), indicating that the composition of the present invention promotes plant growth better than applying higher level of nitrogen dose under optimal and cloudy conditions. The up-regulation caused by the composition of the present invention is most frequent in cold condition, reaching 75%. The generally up-regulated genes suggest that the composition of the present invention increases the activity in the aspects of root growth, photosynthesis, and nitrogen uptake and assimilation.

TABLE 11
List of the analyzed genes in rice in Example 1

| Gene Name | Annotated function |
|---|---|
| NLP3 | The NLP (NIN-LIKE PROTEIN) transcription factors play the |
| | central role in nitrate signaling through up-regulation of nitrate- |
| | responsive gene expression. |
| NR1 | NR1 (Nitrate reductase) is a key enzyme involved in nitrate |
| | assimilation in plants. |
| NADH-GOGAT | NADH-dependent glutamate synthase (NADH-GOGAT), together |
| | with glutamine synthetase (GS), catalyzes the conversion of |
| | ammonium and 2-oxoglutarate to glutamine and glutamate, which |
| | facilitates the ammonium assimilation in roots. |
| GDH1 | GDH1 (Glutamate dehydrogenase 1) catalyzes the reversible |
| | conversion of ammonia and 2-oxoglutarate into glutamate, which |
| | facilitates nitrogen assimilation. |
| OsDIP1 | The expression of OsDIP1 (Dehydration Stress-inducible Protein 1) |
| | is induced under drought stress. |
| Os08g0540400 | Os08g0540400 encoded Calcium-dependent protein kinase may be |
| | involved in several signal transduction pathways for calcium, ABA |
| | and salt stress. |
| Os12g0569500 | Os12g0569500 encoded Osmotin-like protein is known to protect |
| | plants by maintaining cellular osmolarity under osmotic stress. |
| PII11 | PII11 (Photosystem II 11 kD protein) may be involved in |
| | photosystem II assembly and repair. |
| NYC1 | NYC1 (Non-yellow coloring 1) catalyzes the conversion of |
| | chlorophyll b to chlorophyll a in the chlorophyll cycle, which is also |
| | the first stage of the degradation of the LHC (light-harvesting |
| | chlorophyll a/b protein complex). |
| LFNR2 | LFNR2 (Ferredoxin--NADP reductase, leaf isozyme 2) plays key |
| | roles in linear photosynthetic electron transport and cyclic |
| | electron flow. |

### 1.5 Gene Expression of Soybean

Soybean samples for gene expression were collected on the first day after the application of the reagents listed in Table 7 or recovering from stress. The genes were selected from relevant references and classified as root-related genes (R), photosynthesis-related genes (P), nitrogen uptake and assimilation-related genes (N). The expression value was normalized to the CYP expression level. Relative gene expression of T2 and T3 were obtained by comparing with T1.

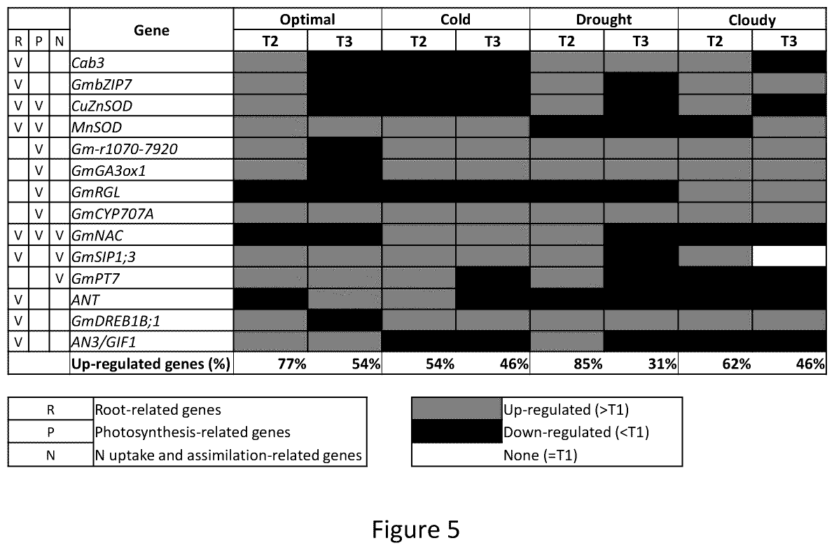

As shown in FIG. 5, under all of the conditions, the majority of the genes listed in Table 12 are up-regulated in T2 group (optimal, 77%; cold, 54%; drought, 85%; cloudy, 62%), which was applied with lower level of nitrogen dose and the composition of the present invention. In contrast, applying with higher level of nitrogen dose (T3 group) does not up-regulate most of the genes under cold (46%), drought (31%), and cloudy (46%) conditions. The up-regulation caused by the composition of the present invention is generally higher than that caused by higher level of nitrogen dose, indicating that the composition of the present invention promotes plant growth better than applying higher level of nitrogen dose under all the conditions. The up-regulation caused by the composition of the present invention is most frequent in drought condition, reaching 85%. The generally up-regulated genes suggest that the composition of the present invention increases the activity in the aspects of root growth, photosynthesis, and nitrogen uptake and assimilation.

TABLE 12
List of the analyzed genes in soybean in Example 1

| Gene Name | Annotated function |
|---|---|
| Cab3 | The light-harvesting CAB3 (chlorophyll a/b-binding protein 3) |
| | captures and delivers excitation energy to photosystems. |
| Gm-r1070-7920 | Gm-r1070-7920 encodes PSII type I chlorophyll a/b-binding protein. |
| GmbZIP7 | The basic leucine-zipper (bZIP) transcription factors play important |
| | roles in plant growth, development, and responses to abiotic and |
| | biotic stresses. |
| CuZnSOD | CuZuSOD (Superoxide dismutase [Cu—Zn]) is an antioxidant enzyme |
| | that protect cells from oxidative damage by catalyzing the conversion |
| | of toxic superoxide into less toxic oxygen and hydrogen peroxide. |
| MnSOD | MnSOD (Manganese superoxide dismutase) is an antioxidant enzyme |
| | that protect cells from oxidative damage by catalyzing the conversion |
| | of toxic superoxide into less toxic oxygen and hydrogen peroxide. |
| GmGA3ox1 | GA3OX1 (Gibberellin 3-beta-dioxygenase 1) converts the inactive |
| | gibberellin (GA) precursors GA9 and GA20 into the bioactives |
| | gibberellins GA4 and GA1, which facilitates vegetative growth and |
| | development. |
| GmRGL | Transcriptional regulator RGL (DELLA protein RGL), a repressor of |
| | the transcription of GA-inducible genes, participates in the floral |
| | development and seed germination. |
| GmCYP707A | GCYP707A (Abscisic acid 8′-hydroxylase CYP707A1) is involved in |
| | the oxidative degradation of ABA, especially in pollinated ovaries. |
| GmNAC | Plant-specific NAC-domain transcription factors play important roles |
| | in plant development, stress responses, and secondary cell wall |
| | synthesis. |
| GmSIP1; 3 | SIP (Small basic Intrinsic Proteins) belongs to one subfamily of |
| | aquaporins that facilitate the passage of water and/or other small |
| | solutes across cell membranes. |
| GmPT7 | A nodule-localized Pi transporter, GmPT7, transport Pi into nodules, |
| | which enhance symbiotic nitrogen fixation and crop yields. |
| ANT | ANT (AINTEGUMENTA) is a member of the AP2 subclass of the |
| | AP2/ERF family of plant-specific transcription factors. ANT is an |
| | important regulator of organ growth during flower development. |
| GmDREB1B; 1 | The dehydration-responsive element-binding (DREB) transcription |
| | factors play an important role in the response of plants to |
| | environmental stresses by controlling the expression of many stress- |
| | related genes. |
| AN3/GIF1 | Transcription coactivator GIF1 (GRF1-interacting factor 1) interacts |
| | with transcription factor GRF to form a functional transcriptional |
| | complex, which facilitates meristematic function in leaves and stem, |
| | and root meristem homeostasis. |

### 2. Effects on Promotion of Root Establishment

Root growth and establishment are essential for nitrogen acquisition and assimilation. However, root system is usually subjected to and susceptible to abiotic stresses. Several trait evaluations, including hormone levels, biomass, and morphological performance data of root systems, were conducted to assess the contribution of the composition of the present invention to the improvement of the root system under optimal and abiotic stress conditions.

2.1 Root-Related Hormone: Abscisic Acid (ABA)

ABA is known to mediate plant responses to various abiotic stresses and enhance plant's adaptations. Moreover, ABA can trigger root growth for the uptake of more water and nutrients, especially under stressful conditions. Therefore, ABA level is an indicator of abiotic stress tolerance in plants.

Plant samples for ABA assay were collected three or seven days after application of the reagents listed in Tables 3 to 7 under optimal condition or three or seven days after recovering from stress. ABA was determined by using Plant ABA ELISA Kit (Cat. No: CK-bio-19156) from Shanghai Coon Koon Biotech Co., Ltd.

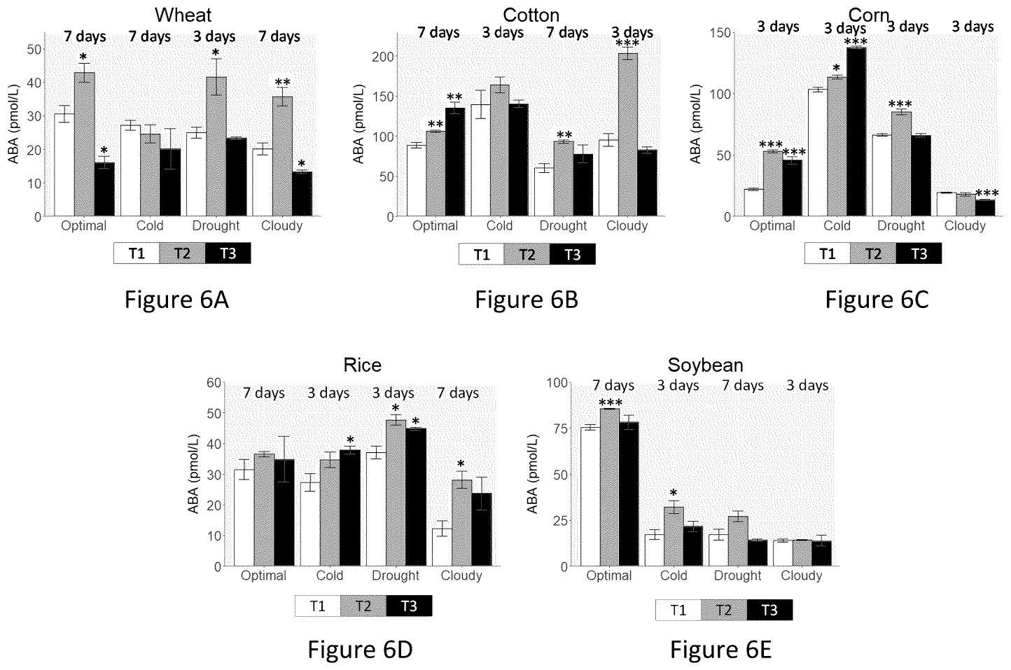

As shown in FIGS. 6A to 6E, plants treated with the composition of the present invention (T2 groups) have higher ABA level than plants treated with only lower level of urea (T1 groups) under most of the test conditions, except the cold-treated wheat (FIG. 6A), cloudy-treated corn (FIG. 6C), and cloudy-treated soybean (FIG. 6E). In addition, plants treated with the composition of the present invention (T2 groups) have equal or higher ABA level than plants treated with higher level of urea (T3 groups) under most of the test conditions, particularly that optimal-, drought-, and cloudy-treated wheat (FIG. 6A), cold- and cloudy-treated cotton (FIG. 6B), drought-treated corn (FIG. 6C), drought-treated rice (FIG. 6D), and optimal-, cold-, and drought-treated soybean (FIG. 6D) have higher ABA levels than T3 groups. The increase in ABA caused by the composition of present invention indicates that the composition enhances crop tolerance and root growth better than applying higher level of nitrogen dose under most of the optimal and stressful conditions.

### 2.2 Root-Related Hormone: Indole-3-Acetic Acid (IAA)

IAA induces root growth, root branching (lateral root initiation), and adventitious root formation. Therefore, IAA level is an indicator of root system establishment in plants. Plant samples for IAA assay were collected three or seven days after application of the reagents listed in Tables 3 to 7 under optimal condition or three or seven days after recovering from stress. IAA was determined by using Plant IAA ELISA Kit (Cat. No: CK-bio-19157) from Shanghai Coon Koon Biotech Co., Ltd.

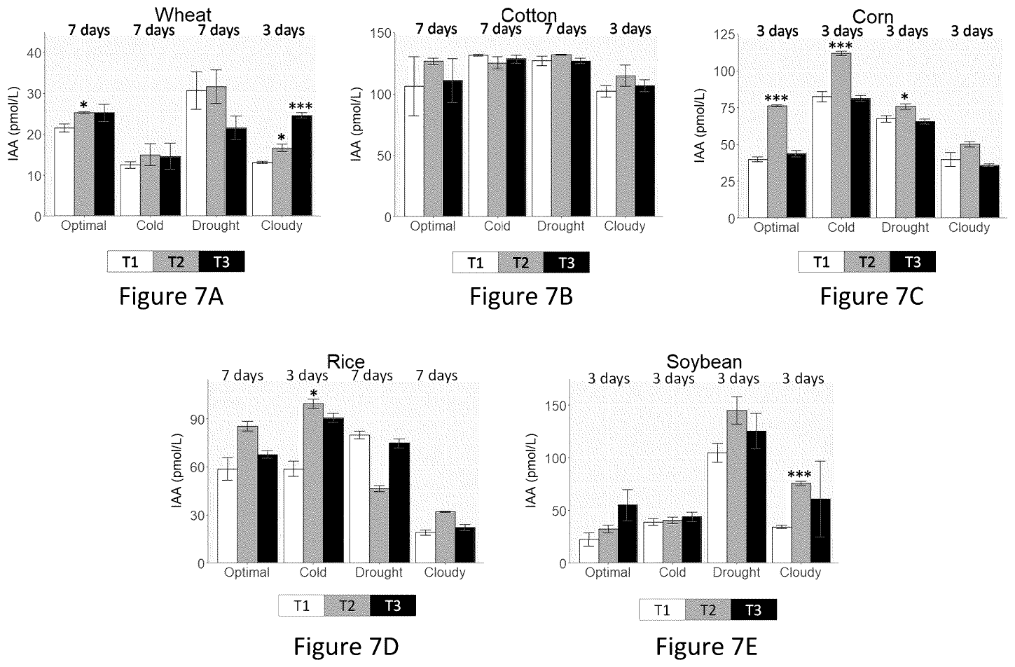

As shown in FIGS. 7A to 7E, plants treated with the composition of the present invention (T2 groups) have higher IAA level than plants treated with only lower level of urea (T1 groups) under most of the test conditions, except the cold-treated cotton (FIG. 7B) and drought-treated rice (FIG. 7D). In addition, plants treated with the composition of the present invention (T2 groups) have equal or higher IAA level than plants treated with higher level of urea (T3 groups) under most of the test conditions, especially that corn under all test conditions (FIG. 7C), rice under optimal, cold, and cloudy conditions (FIG. 7D), and soybean under drought and cloudy conditions (FIG. 7E) have higher IAA levels than T3 groups. The increase in IAA caused by the composition of present invention indicates that the composition promotes the root system establishment better than applying higher level of nitrogen dose under most of the optimal and stressful conditions.

### 2.3 Root Biomass

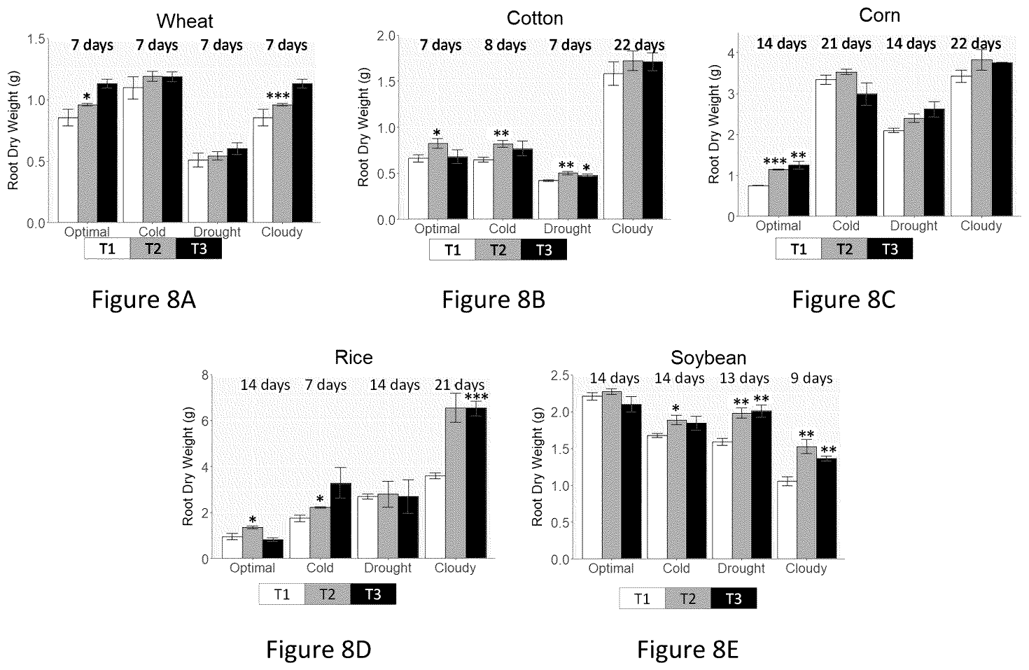

Roots of each plant were dried at 50° C. overnight, and then the dry weight was measured. For completion of the stress and recovery treatments, plants of the stress groups were sampled several days later, and resulted in more biomass than the optimal groups. As shown in FIGS. 8A to 8E, plants treated with the composition of the present invention (T2 groups) have more root biomass than plants treated with only lower level of urea (T1 groups) under all of the test conditions. In addition, in some cases, plants treated with the composition of the present invention (T2 groups) have equal or more root biomass than plants treated with higher level of urea (T3 groups). The increase in root biomass caused by the composition of present invention indicates that the composition promotes the root system establishment and water/nutrient uptake under optimal and stressful conditions, and in some cases, the effects of the composition of the present invention were stronger than that of the high nitrogen supply.

### 2.4 Root Length

On the sampling day, root length of wheat, corn, and soybean seedlings was measured by a root analyzer (WinRHIZO™, Regent Instruments Inc., Québec, Canada). For completion of the stress and recovery treatments, the stressful groups were sampled several days later, and resulted in more biomass than the optimal groups. In addition, roots of cotton and rice were not scanned and calculated because of their fragility.

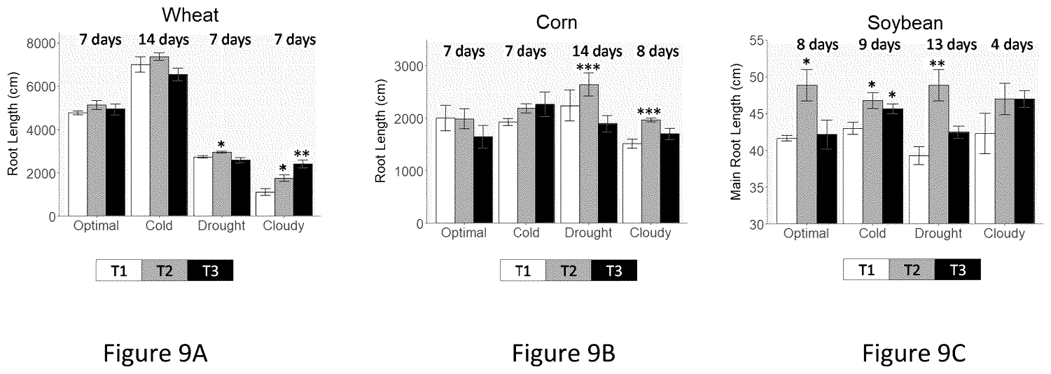

As shown in FIGS. 9A to 9C, plants treated with the composition of the present invention (T2 groups) have longer root length than plants treated with only lower level of urea (T1 groups) under most of the test conditions, except optimally treated corn (FIG. 9B). In addition, plants treated with the composition of the present invention (T2 groups) have equal or longer root length than plants treated with higher level of urea (T3 groups) under most of the test condition, except cloudy-treated wheat (FIG. 9A) and cold-treated corn (FIG. 9B). The increase in root length caused by the composition of present invention indicates that the composition promotes fertilizer and water uptake under optimal and stressful conditions, and in most cases, the effects of the composition of the present invention were stronger than that of the high nitrogen supply.

### 2.5 Root Density

The photos of rice root were taken on the 21^{st} day after application of the reagents listed in Table 6, or at the recovering stage after stressful period.

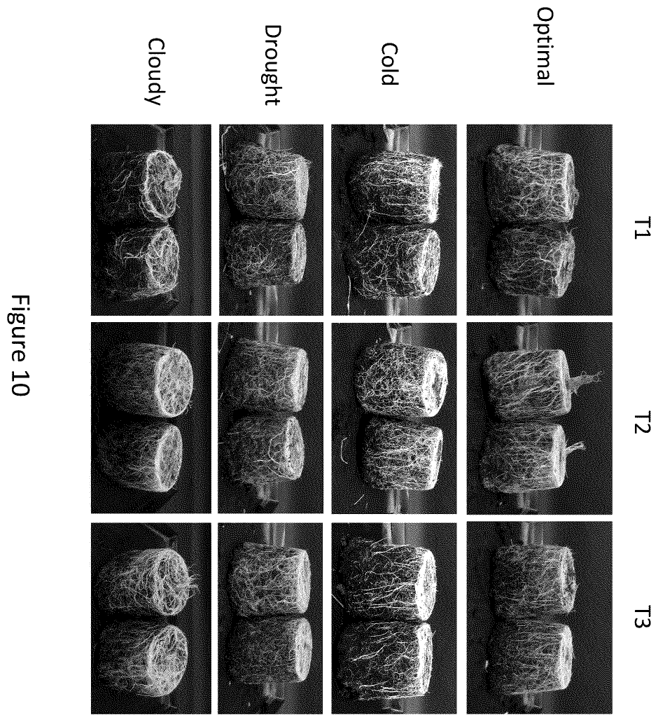

As shown in FIG. 10, plants treated with the composition of the present invention (T2 groups) have more extensive root formation than plants treated with only lower level of urea (T1 groups) and plants treated with higher level of urea (T3 groups) under all of the test conditions. The increase in root density caused by the composition of present invention indicates that the composition promotes fertilizer and water and nutrient uptake under optimal and stressful conditions, and the effects of the composition of the present invention were stronger than that of the high nitrogen supply.

### 3. Effects on Promotion of Photosynthesis

Photosynthesis determines the energy input and the carbon skeleton, 2-oxoglutarate (2-OG), supply that are essential for nitrogen assimilation. Good photosynthesis and nitrogen assimilation contribute to the formation of metabolic resources and structural constituents. However, photosynthesis is susceptible to abiotic stresses. In order to assess the contribution of the composition of the present invention to the improvement of photosynthesis, this section provides various hormone levels, photosynthesis efficiencies, biomass and morphological performance data.

### 3.1 Leaf and Photosynthesis-Related Hormone: Zeatin (ZT)

As one primary endogenous active ingredient in the cytokinin family, ZT regulates shoot growth and branching, vascular formation, photosynthesis and leaf senescence.

Therefore, ZT level is an indicator of shoot growth and leaf photosynthesis in plants. Plant samples for ZT assay were collected three or seven days after application of the reagents listed in Tables 3 to 7 under optimal condition or three or seven days after recovering from stress. ZT was determined by using Plant ZT ELISA Kit (Cat. No: CK-bio-20589) from Shanghai Coon Koon Biotech Co., Ltd.

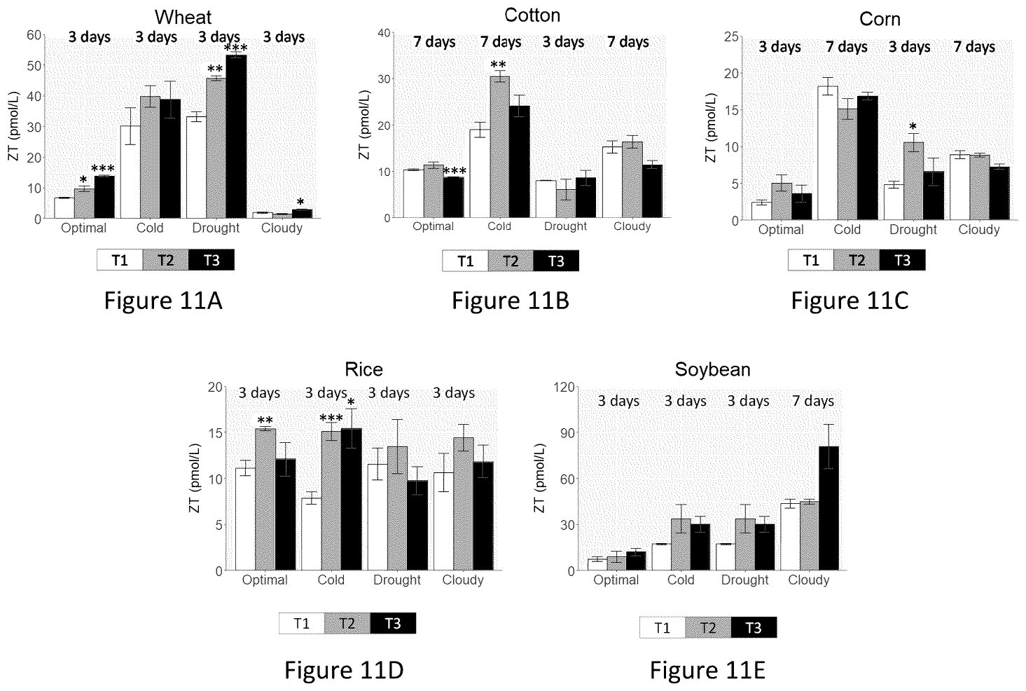

As shown in FIGS. 11A to 11E, plants treated with the composition of the present invention (T2 groups) have higher ZT level than plants treated with only lower level of urea (T1 groups) under most of the test conditions, except cloudy-treated wheat (FIG. 11A), drought-treated cotton (FIG. 11B), and cold-treated corn (FIG. 11C). In addition, in some cases, plants treated with the composition of the present invention (T2 groups) have equal or higher ZT level than plants treated with higher level of urea (T3 groups), such as cold-treated cotton (FIG. 11B), drought-treated corn (FIG. 11C), and optimally treated rice (FIG. 11D). The increase in ZT caused by the composition of present invention indicates that the composition promotes shoot growth and leaf photosynthesis, and prevent leaf senescence as well, under the optimal and stressful conditions, and in some cases, the effects of the composition of the present invention were stronger than that of the high nitrogen supply.

### 3.2 Leaf and Photosynthesis-Related Hormone: Gibberellic Acids (GA)

As one primary endogenous active ingredient in the gibberellin family, GA is involved in regulating shoot growth, stem elongation, bud break, leaf senescence, and the transition from vegetative to flowering stage. Therefore, GA level is also an indicator of shoot growth and leaf photosynthesis in plants.

Plant samples for GA assay were collected three or seven days after application of the reagents listed in Tables 3 to 7 under optimal condition or three or seven days after recovering from stress. GA was determined by using Plant GA ELISA Kit (Cat. No: CK-bio-20589) from Shanghai Coon Koon Biotech Co., Ltd.

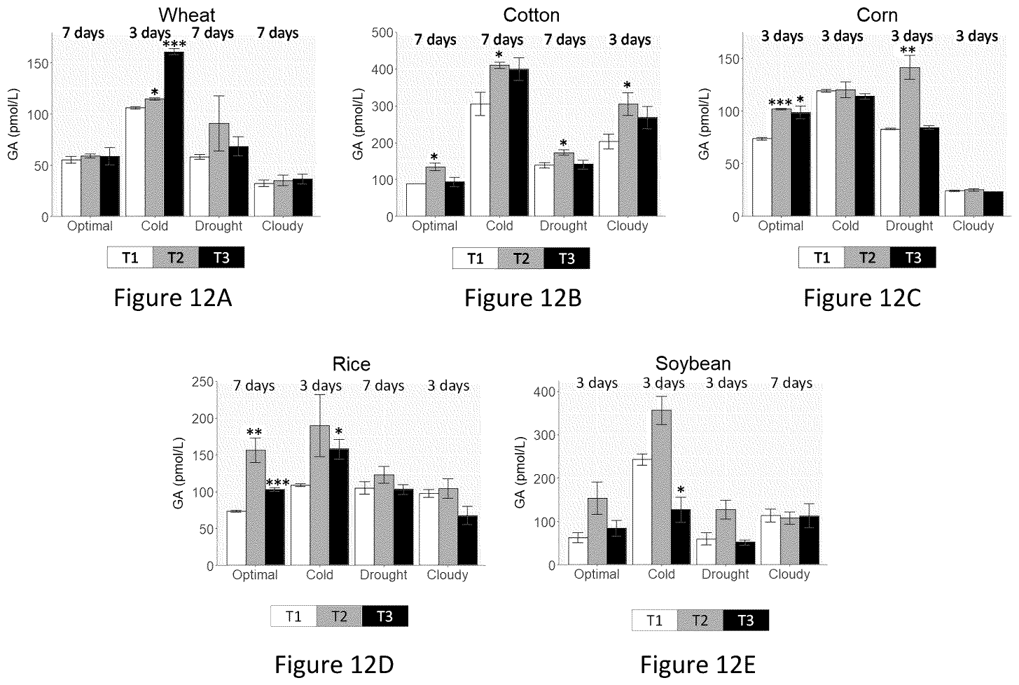

As shown in FIGS. 12A to 12E, plants treated with the composition of the present invention (T2 groups) have higher GA level than plants treated with only lower level of urea (T1 groups) under most of the test conditions, except cold- and cloudy-treated corn (FIG. 12C) and cloudy-treated soybean (FIG. 12E). In addition, in some cases, plants treated with the composition of the present invention (T2 groups) have equal or higher GA level than plants treated with higher level of urea (T3 groups), such as cloudy-treated cotton (FIG. 12B), drought-treated corn (FIG. 12C), optimally treated rice (FIG. 12D), and cold-treated soybean (FIG. 12E). The increase in GA caused by the composition of present invention indicates that the composition promotes shoot growth and leaf photosynthesis under the optimal and stressful conditions, and in some cases, the effects of the composition of the present invention were stronger than that of the high nitrogen supply.

### 3.3 Light Harvest Ability: Chlorophyll Content

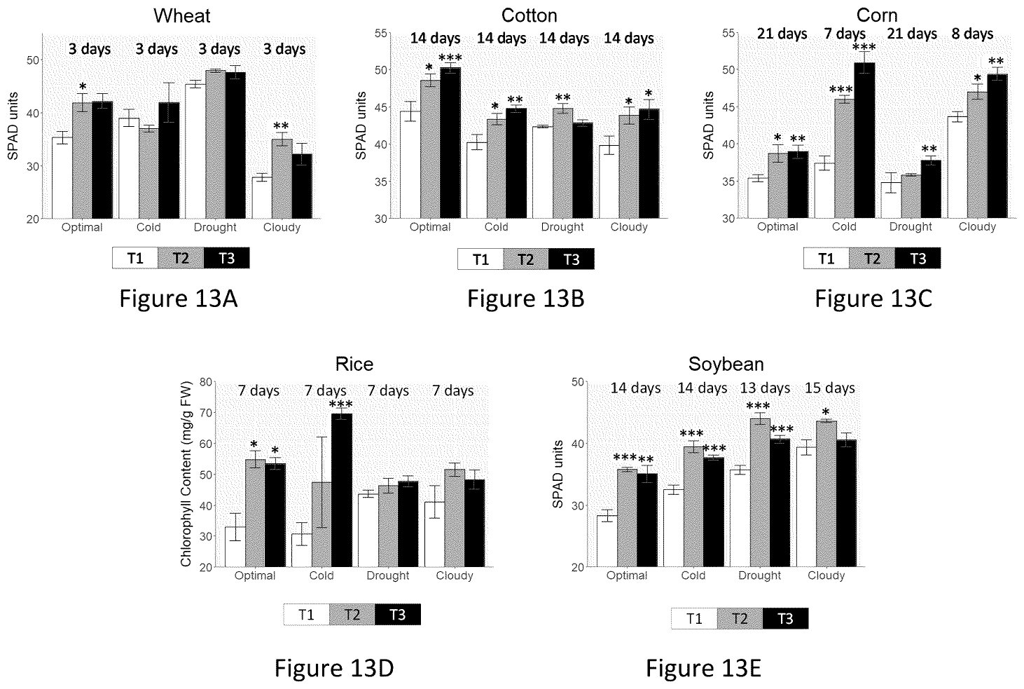

Special products analysis division (SPAD) is a common relative index related to chlorophyll content. SPAD was measured with the instrument SPAD 502 Plus after application of the reagents listed in Tables 3 to 7 or recovering from abiotic stresses. Total chlorophyll content of rice leaves was extracted and measured by ELISA reader. As shown in FIGS. 13A to 13E, plants treated with the composition of the present invention (T2 groups) have higher SPAD value than plants treated with only lower level of urea (T1 groups) under most of the test conditions, except cold-treated wheat (FIG. 13A). In addition, in some cases, plants treated with the composition of the present invention (T2 groups) have equal or higher chlorophyll content than plants treated with higher level of urea (T3 groups), such as drought-treated cotton (FIG. 13B) and cold-, drought-, and cloudy-treated soybean (FIG. 13E). The increase in chlorophyll content caused by the composition of present invention indicates that the composition contributes to better photosynthesis efficiencies under the optimal and stressful conditions, and in some cases, the effects of the composition of the present invention were stronger than that of the high nitrogen supply.

### 3.4 Light Harvest Ability: Electron Transport Rate

Among all fluorescence parameters, the photosynthetic electron transport rate (ETR) is a strong indicator of the efficiency of photosynthesis and carbon uptake. In order to investigate whether the composition of the present invention enhances the photosynthesis of five crops under different stress conditions, chlorophyll fluorescence measurement and calculation were carried out using a portable photosynthesis system with 6400-40 leaf chamber fluorometer (LI-COR Inc.). The chlorophyll fluorescence was measured on the upper mature light-adapted leaves of the crop plants.

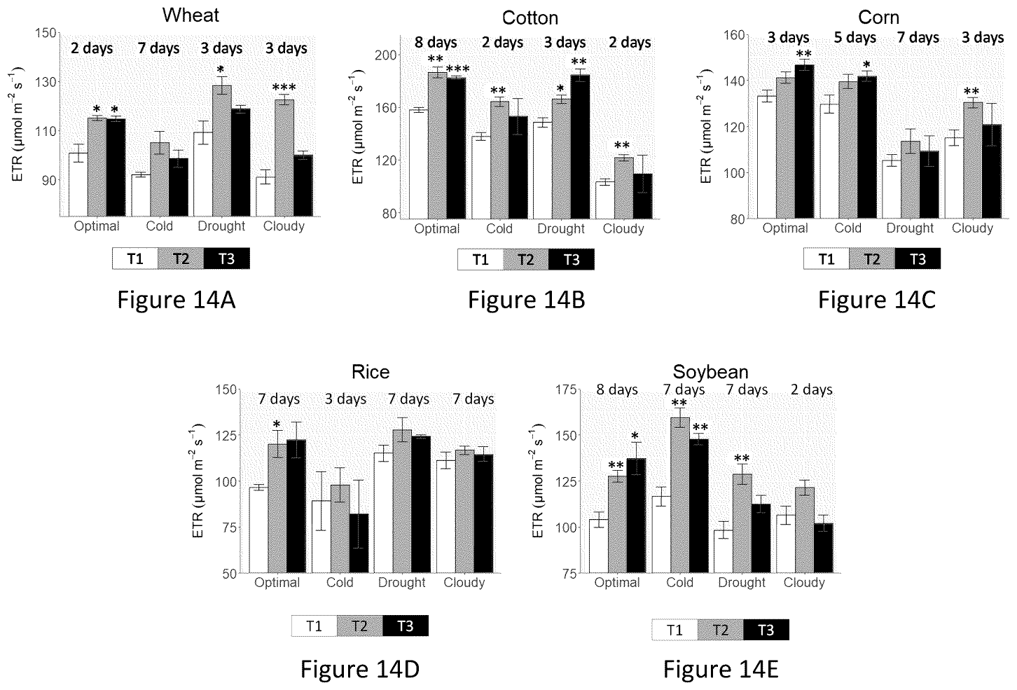

As shown in FIGS. 14A to 14E, plants treated with the composition of the present invention (T2 groups) have higher ETR than plants treated with only lower level of urea (T1 groups) under all of the test conditions. In addition, in most cases, plants treated with the composition of the present invention (T2 groups) have equal or higher ETR than plants treated with higher level of urea (T3 groups), except drought-treated cotton (FIG. 14B), optimally and cold-treated corn (FIG. 14C), optimally treated rice (FIG. 14D), and optimally treated soybean (FIG. 14E). The increase in ETR caused by the composition of present invention indicates that the composition promotes photosynthesis capacity and brings positive expectation on production under the optimal and stressful conditions, and in most cases, the effects of the composition of the present invention were stronger than that of the high nitrogen supply.

### 3.5 Essential Substance in Structure and Metabolism: Leaf Soluble Sugar

Soluble sugar plays a central role in plant structure and metabolism at the cellular and whole-organism levels. Soluble sugar not only functions as metabolic resources and structural constituents of cells, but acts as signals regulating various processes associated with stress responses, plant growth and development. Therefore, soluble sugar is an indicator of production potential of plants.

Soluble sugar was extracted from middle leaves. The concentration of glucose determined by using the Glucose (HK) Assay Kit from Sigma.

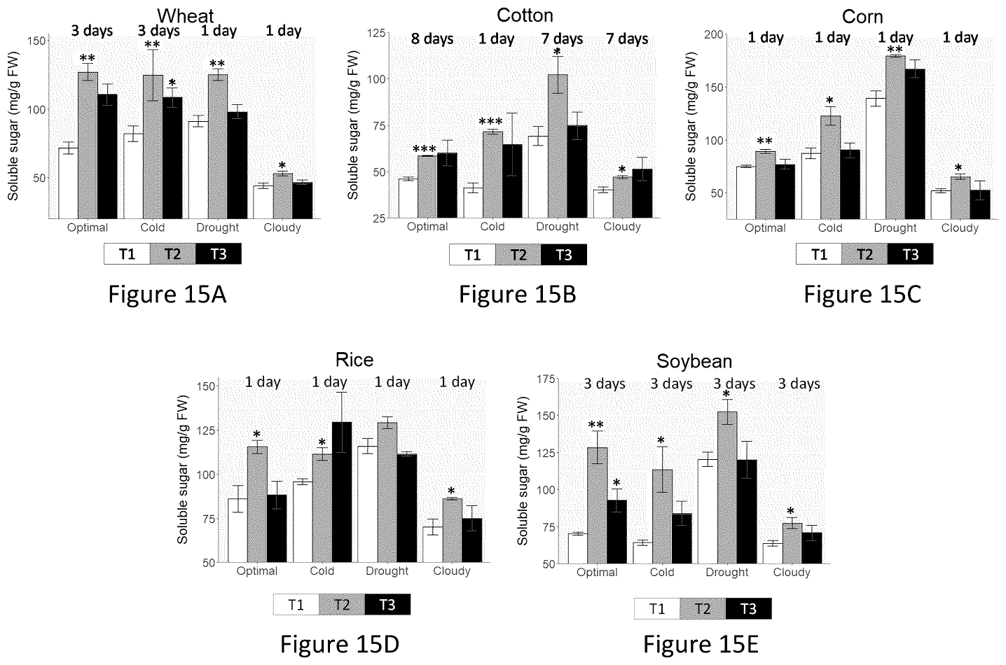

As shown in FIGS. 15A to 15E, plants treated with the composition of the present invention (T2 groups) have higher soluble sugar content than plants treated with only lower level of urea (T1 groups) under all of the test conditions. In addition, in most cases, plants treated with the composition of the present invention (T2 groups) have equal or higher soluble sugar content than plants treated with higher level of urea (T3 groups), except optimally and cloudy-treated cotton (FIG. 15B) and cold-treated rice (FIG. 15D). The increase in soluble sugar content caused by the composition of present invention indicates that the composition helps crops achieve better production potential under the optimal and stressful conditions, and in most cases, the effects of the composition of the present invention were stronger than that of the high nitrogen supply.

### 3.6 Shoot Biomass

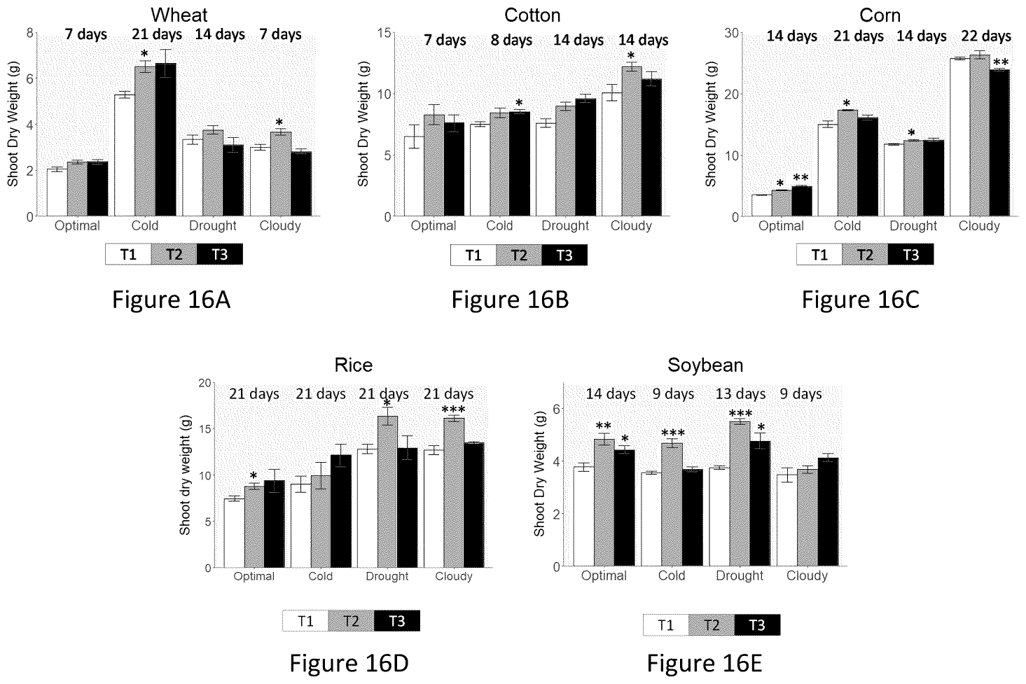

Leaves and stems of each plant were dried at 50° C. overnight, and then the dry weight was measured. For completion of the stress and recovery treatments, the stressful groups were sampled several days later, and resulted in more biomass than the optimal group. As shown in FIGS. 16A to 16E, plants treated with the composition of the present invention (T2 groups) have more shoot biomass than plants treated with only lower level of urea (T1 groups) under all of the test conditions. In addition, in most cases, plants treated with the composition of the present invention (T2 groups) have equal or more shoot biomass than plants treated with higher level of urea (T3 groups), except cold-treated wheat (FIG. 16A), drought-treated cotton (FIG. 16B), optimally treated corn (FIG. 16C), optimally and cold-treated rice (FIG. 16D), and cloudy-treated soybean (FIG. 16E). The increase in shoot biomass caused by the composition of present invention indicates that the composition contributes to a good foundation for crop yield since shoot biomass is highly correlated to the final yield. In addition, in most cases, the effects of the composition of the present invention were stronger than that of the high nitrogen supply.

### 3.6 Leaf Area

The leaf area of wheat, soybean and rice was scanned by EPSON scanner and analyzed by WinFolia. On the other hand, the leaf area of cotton was measured and calculated by formula: 0.81×length×width. For completion of the stress and recovery treatments, the stressful groups were sampled several days later, and resulting larger leaves than the optimal group.

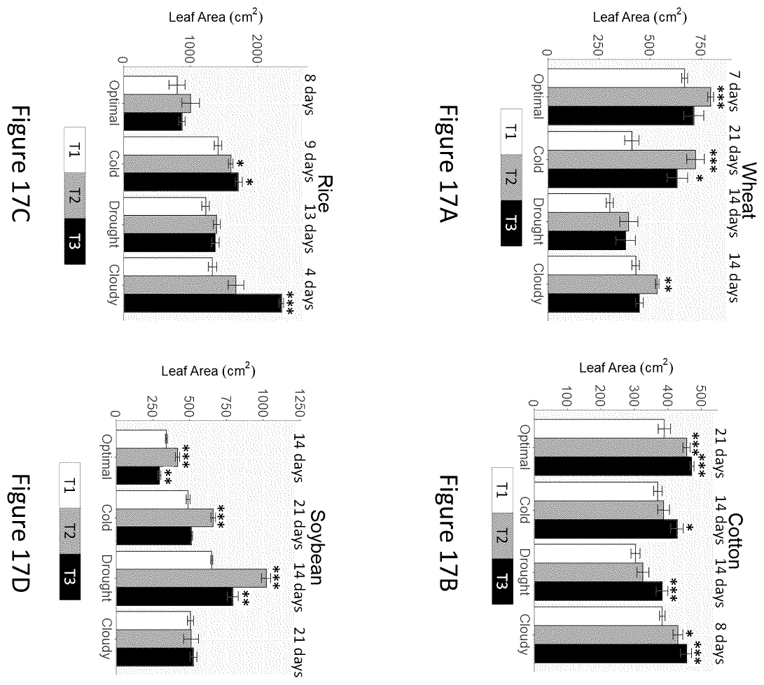

As shown in FIGS. 17A to 17D, plants treated with the composition of the present invention (T2 groups) have more leaf area than plants treated with only lower level of urea (T1 groups) under all of the test conditions. In addition, wheat and soybean treated with the composition of the present invention (T2 groups) have equal or more leaf area than wheat and soybean treated with higher level of urea (T3 groups) (FIGS. 17A and 17D). The increase in leaf area caused by the composition of present invention indicates that the composition contributes to higher light harvest ability since leaf area is positively correlated with light harvest ability, also with the final yield. In addition, in wheat and soybean, the effects of the composition of the present invention were stronger than that of the high nitrogen supply.

### 3.7 Growth Vigor and Tiller Numbers of Wheat

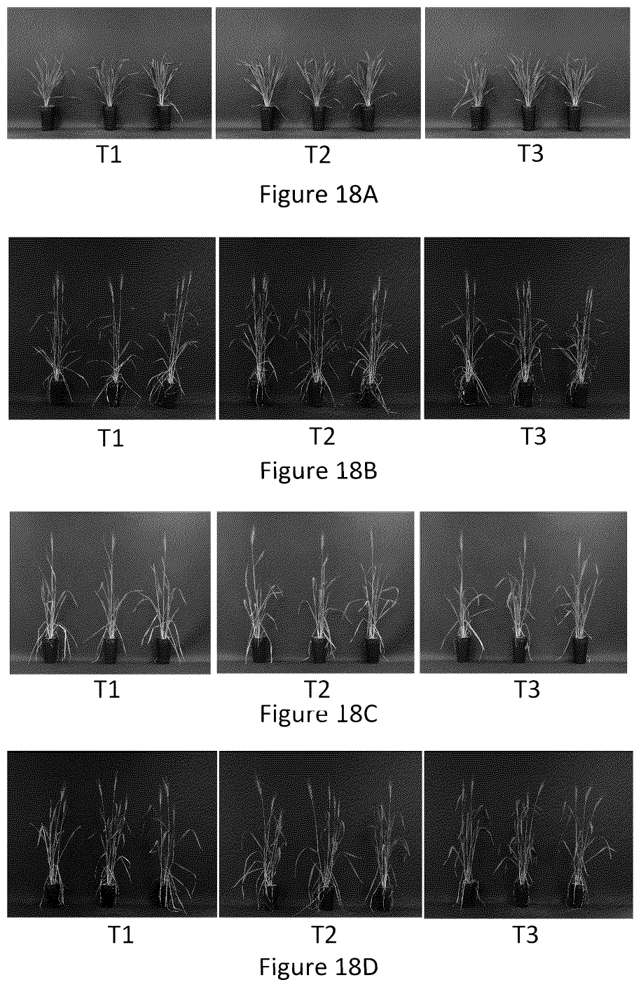

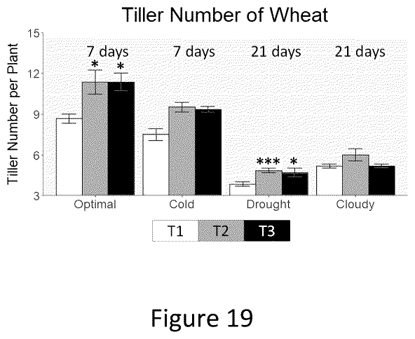

As shown in FIGS. 18A to 18D, wheat plants treated with the composition of the present invention (T2 groups) have more tillers and spikes than wheat plants treated with only lower level of urea (T1 groups) and wheat plants treated with higher level of urea (T3 groups) under all of the test conditions. As shown in FIG. 19, wheat plants treated with the composition of the present invention (T2 groups) have higher tiller numbers than wheat plants treated with only lower level of urea (T1 groups) under all of the test conditions. In addition, wheat plants treated with the composition of the present invention (T2 groups) have a higher tiller number than wheat plants treated with higher level of urea (T3 groups) under cloudy condition. The increase in tiller and spike numbers caused by the composition of present invention indicates that the composition enhances wheat growth and vigor and increases wheat yield, and under cloudy condition, the effects of the composition of the present invention were stronger than that of the high nitrogen supply.

### 3.8 Leaf Development and Stem Width of Cotton

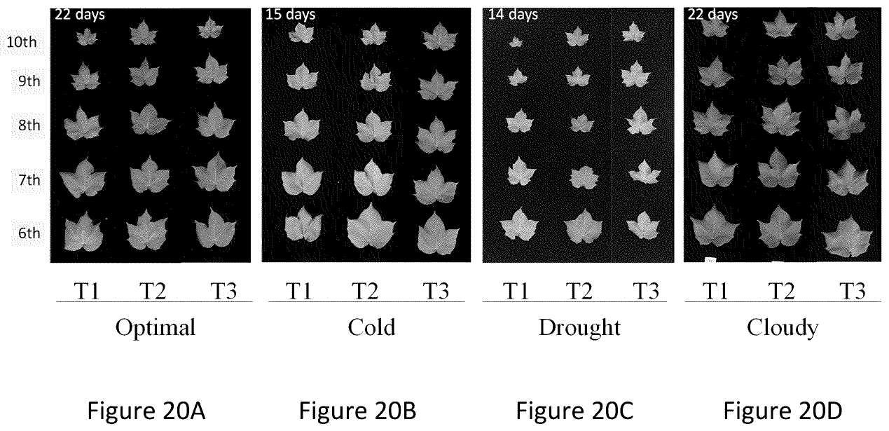

As shown in FIGS. 20A to 20D, cotton plants treated with the composition of the present invention (T2 groups) have bigger leaves than cotton plants treated with only lower level of urea (T1 groups). In addition, cotton plants treated with the composition of the present invention (T2 groups) have bigger leaves than cotton plants treated with higher level of urea (T3 groups) under cold and drought conditions. The increase in cotton leaf area caused by the composition of present invention indicates that the composition accelerates leaf development of cotton under the test condition and contributes to higher light harvest ability, and under cold and drought conditions, the effects of the composition of the present invention were stronger than that of the high nitrogen supply.

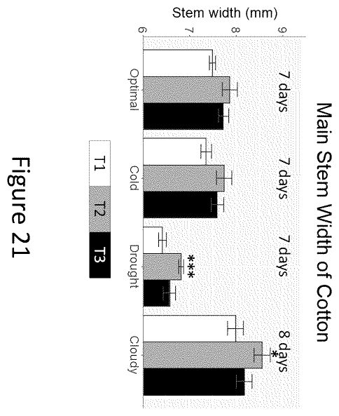

As shown in FIG. 21, cotton plants treated with the composition of the present invention (T2 groups) have wider main stems than cotton plants treated with only lower level of urea (T1 groups) and cotton plants treated with higher level of urea (T3 groups) under all of the test conditions, especially under drought and cloudy conditions. The stem width of cotton indicates the strength of the plant, which is conducive to the transportation ability of vascular bundles and the extension of branches and leaves. Therefore, the increase in main stem width of cotton caused by the composition of present invention indicates that the composition promotes the strength of the whole plant under all test conditions, and the effects of the composition of the present invention were stronger than that of the high nitrogen supply.

### 3.9 Leaf Development of Corn

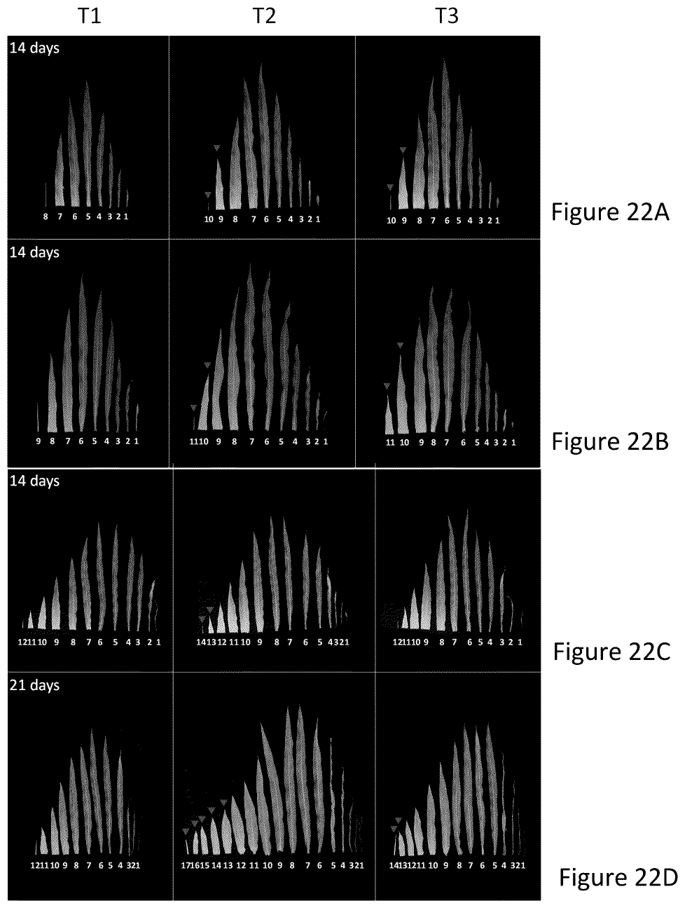

The leaves of the whole corn plant were cut and arranged. As shown in FIGS. 22A to 22D, corn plants treated with the composition of the present invention (T2 groups) have more leaves than corn plants treated with only lower level of urea (T1 groups) under all of the test conditions. In addition, corn plants treated with the composition of the present invention (T2 groups) have more leaves than corn plants treated with higher level of urea (T3 groups) under drought (FIG. 22C) and cloudy (FIG. 22D) conditions. The increase in leaf numbers caused by the composition of present invention indicates that the composition accelerates leaf development of corn under the teat conditions and contributes to higher light harvest ability. In addition, the effects of the composition of the present invention were stronger than that of the high nitrogen supply under drought and cloudy conditions.

### 3.10 Growth Vigor and Tiller Number of Rice

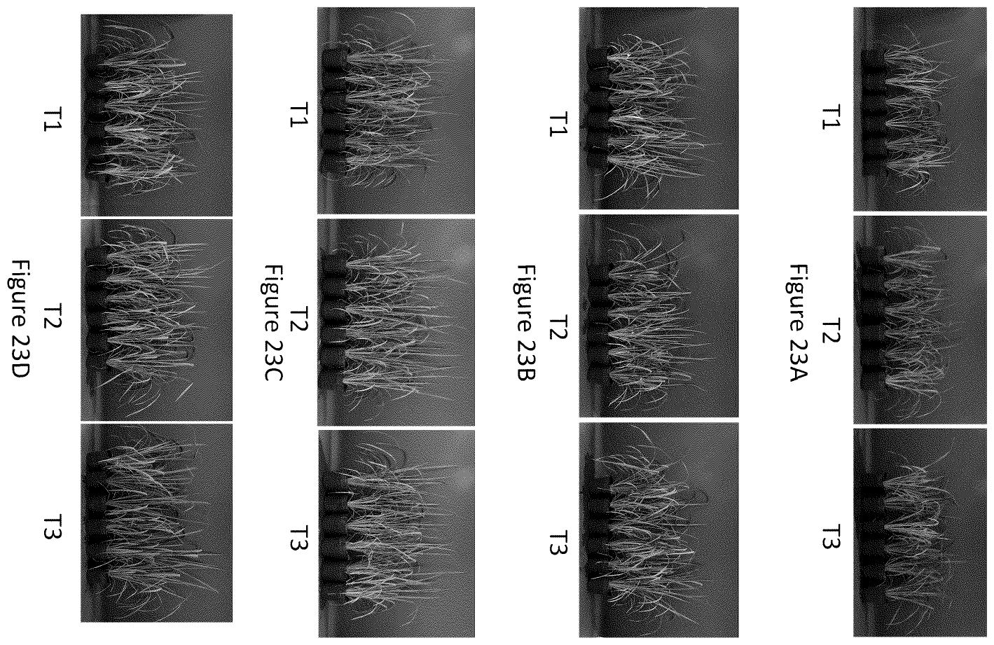

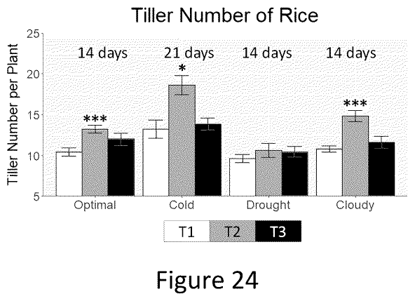

As shown in FIGS. 23A to 23D, rice plants treated with the composition of the present invention (T2 groups) have greener and wider leaves than rice plants treated with only lower level of urea (T1 groups) and rice plants treated with higher level of urea (T3 group) under all of the test conditions. As shown in FIG. 24, rice plants treated with the composition of the present invention (T2 groups) have higher tiller numbers than rice plants treated with only lower level of urea (T1 groups) and rice plants treated with higher level of urea (T3 groups) under all of the test conditions. The increase in tiller numbers caused by the composition of present invention indicates that the composition enhances rice growth and vigor and increases rice yield, and the effects of the composition of the present invention were stronger than that of the high nitrogen supply.

### 3.11 Growth Vigor of Soybean

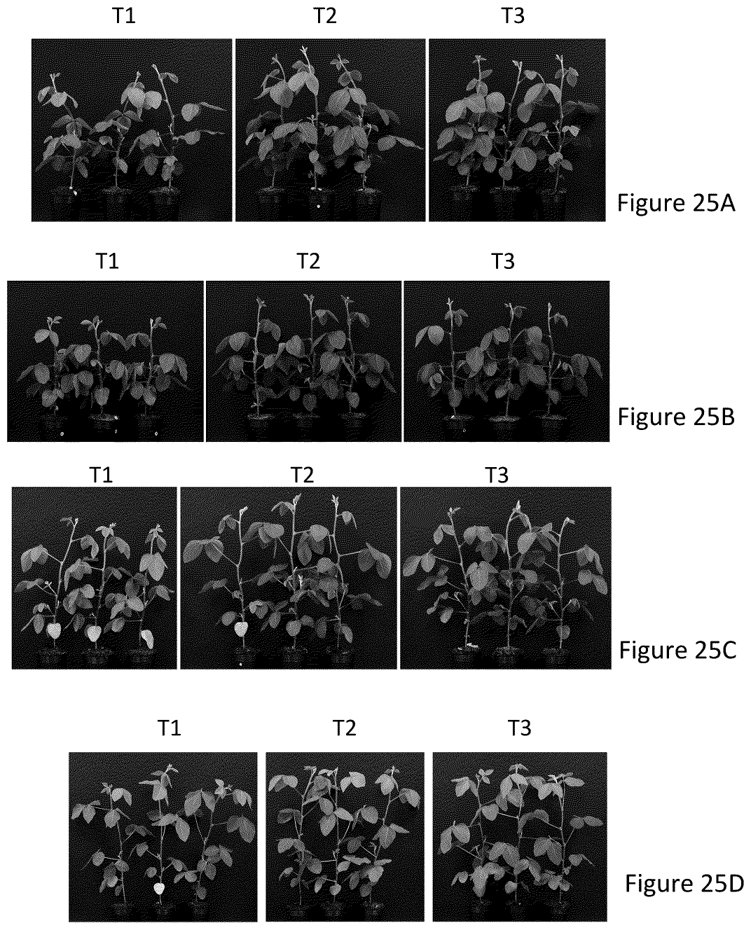

As shown in FIGS. 25A to 25D, soybean plants treated with the composition of the present invention (T2 groups) have bigger leaves and more branches than soybean plants treated with only lower level of urea (T1 groups) and soybean plants treated with higher level of urea (T3 groups) under all of the test conditions. The increase in expansion of leaves and branches caused by the composition of present invention indicates that the composition enhances soybean growth and vigor, and the effects of the composition of the present invention were stronger than that of the high nitrogen supply.

### 4. Effects on Promotion of Nitrogen Assimilation

Nitrogen is the major constituent of organic metabolites and is highly-related to crop yield. Therefore, improving the capability of nitrogen uptake and assimilation is the key to increasing yield under optimal and suboptimal conditions. This section provides activities of nitrogen assimilation enzymes (NR, GS, and GOGAT), soluble protein, and nutrient content data to demonstrate the efficacy of the composition of the present invention.

### 4.1 Activities of Nitrogen Assimilation Enzymes in Wheat

The samples from lower leaves were analyzed seven days after application of the reagents listed in Table 3 under optimal condition, or seven days after recovering from stress.

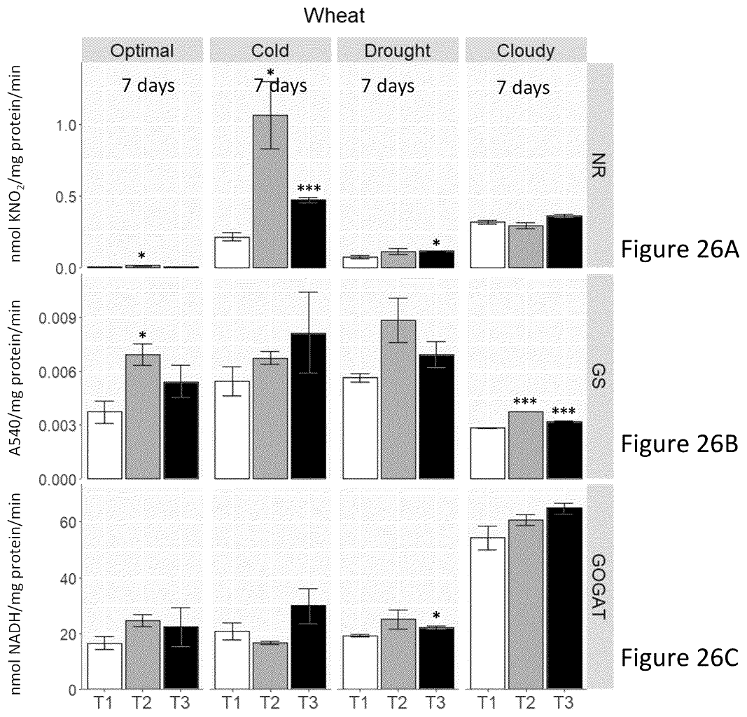

As shown in FIG. 26A, wheat plants treated with the composition of the present invention (T2 groups) have higher nitrate reductase (NR) activities than wheat plants treated with only lower level of urea (T1 groups) under most of the test conditions, except cloudy condition. In addition, wheat plants treated with the composition of the present invention (T2 groups) have higher NR activities than wheat plants treated with higher level of urea (T3 groups) under optimal and cold conditions.

As shown in FIG. 26B, wheat plants treated with the composition of the present invention (T2 groups) have higher glutamine synthetase (GS) activities than wheat plants treated with only lower level of urea (T1 groups) under all of the test conditions. In addition, wheat plants treated with the composition of the present invention (T2 groups) have higher GS activities than wheat plants treated with higher level of urea (T3 groups) under most of the test conditions, except cold condition.

As shown in FIG. 26C, wheat plants treated with the composition of the present invention (T2 groups) have higher glutamate synthase (GOGAT) activities than wheat plants treated with only lower level of urea (T1 groups) under most of the test conditions, except cold condition. In addition, wheat plants treated with the composition of the present invention (T2 groups) have higher GOGAT activities than wheat plants treated with higher level of urea (T3 groups) under optimal and drought conditions. The increase in activities of nitrogen assimilation enzymes caused by the composition of present invention indicates that the composition promotes the conversion of inorganic nitrogen to organic nitrogen, and in some cases, the effects of the composition of the present invention were stronger than that of the high nitrogen supply.

### 4.2 Activities of Nitrogen Assimilation Enzymes in Cotton

The samples from lower leaves were analyzed eight days after application of the reagents listed in Table 4 under optimal condition, or three or seven days after recovering from stress.

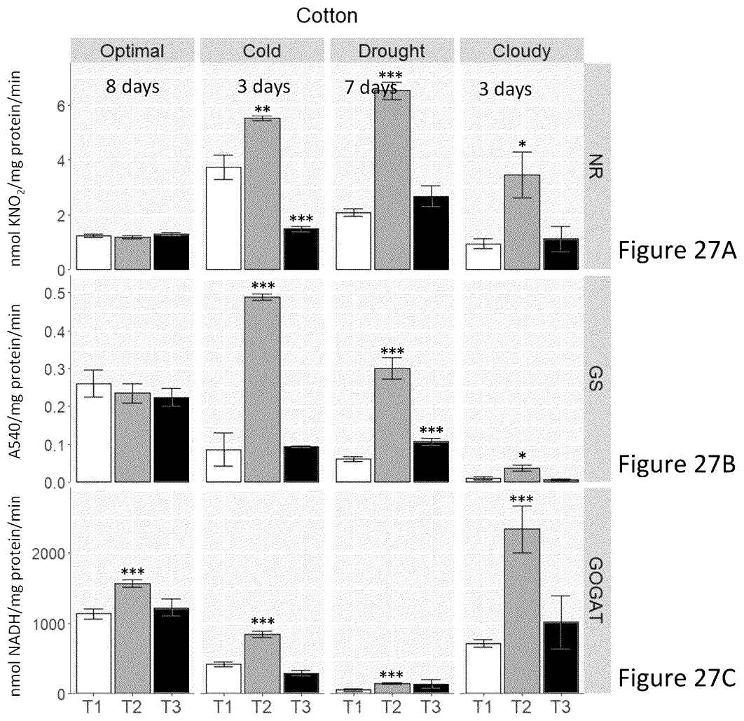

As shown in FIG. 27A, cotton plants treated with the composition of the present invention (T2 groups) have higher NR activities than cotton plants treated with only lower level of urea (T1 groups) and cotton plants treated with higher level of urea (T3 groups) under most of the test conditions, except optimal condition.

As shown in FIG. 27B, cotton plants treated with the composition of the present invention (T2 groups) have higher GS activities than cotton plants treated with only lower level of urea (T1 groups) and cotton plants treated with higher level of urea (T3 groups) under most of the test conditions, except optimal condition.

As shown in FIG. 27C, cotton plants treated with the composition of the present invention (T2 groups) have higher GOGAT activities than cotton plants treated with only lower level of urea (T1 groups) and cotton plants treated with higher level of urea (T3 groups) under all of the test conditions.

The increase in activities of nitrogen assimilation enzymes caused by the composition of present invention indicates that the composition promotes the conversion of inorganic nitrogen to organic nitrogen, and the effects of the composition of the present invention were stronger than that of the high nitrogen supply.

### 4.3 Activities of Nitrogen Assimilation Enzymes in Corn

The samples from lower leaves were analyzed three days after application of the reagents listed in Table 5 under optimal condition, or three or seven days after recovering from stress.

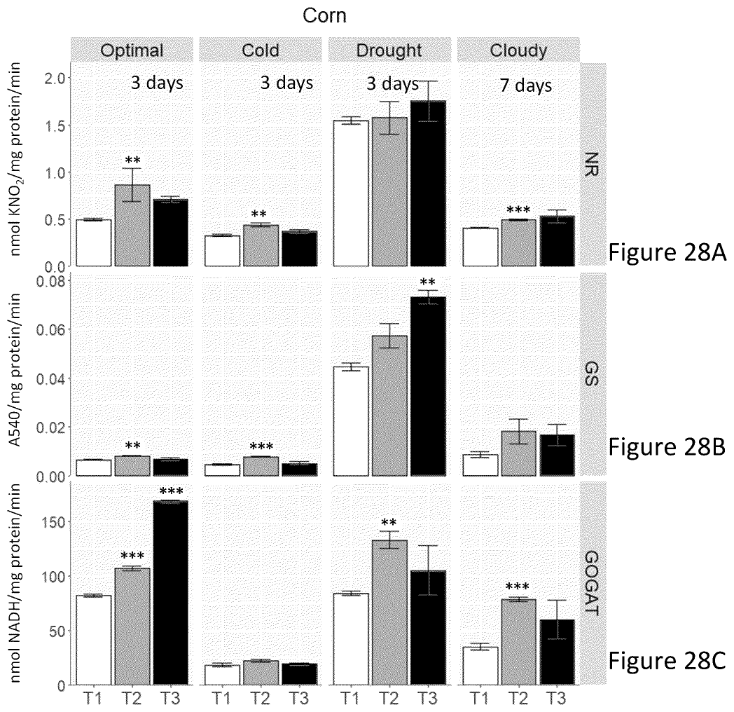

As shown in FIG. 28A, corn plants treated with the composition of the present invention (T2 groups) have higher NR activities than corn plants treated with only lower level of urea (T1 groups) under all of the test conditions. In addition, corn plants treated with the composition of the present invention (T2 groups) have higher NR activities than corn plants treated with higher level of urea (T3 groups) under optimal and cold conditions.

As shown in FIG. 28B, corn plants treated with the composition of the present invention (T2 groups) have higher GS activities than corn plants treated with only lower level of urea (T1 groups) under all of the test conditions. In addition, corn plants treated with the composition of the present invention (T2 groups) have higher GS activities than corn plants treated with higher level of urea (T3 groups) under most of the test conditions, except drought condition.

As shown in FIG. 28C, corn plants treated with the composition of the present invention (T2 groups) have higher GOGAT activities than corn plants treated with only lower level of urea (T1 groups) under all of the test conditions. In addition, corn plants treated with the composition of the present invention (T2 groups) have higher GOGAT activities than corn plants treated with higher level of urea (T3 groups) under most of the test conditions, except optimal condition.

The increase in activities of nitrogen assimilation enzymes caused by the composition of present invention indicates that the composition promotes the conversion of inorganic nitrogen to organic nitrogen, and in some cases, the effects of the composition of the present invention were stronger than that of the high nitrogen supply.

### 4.4 Activities of Nitrogen Assimilation Enzymes in Rice

The samples from lower leaves were analyzed seven days after application of the reagents listed in Table 6 under optimal condition, or three or seven days after recovering from stress.

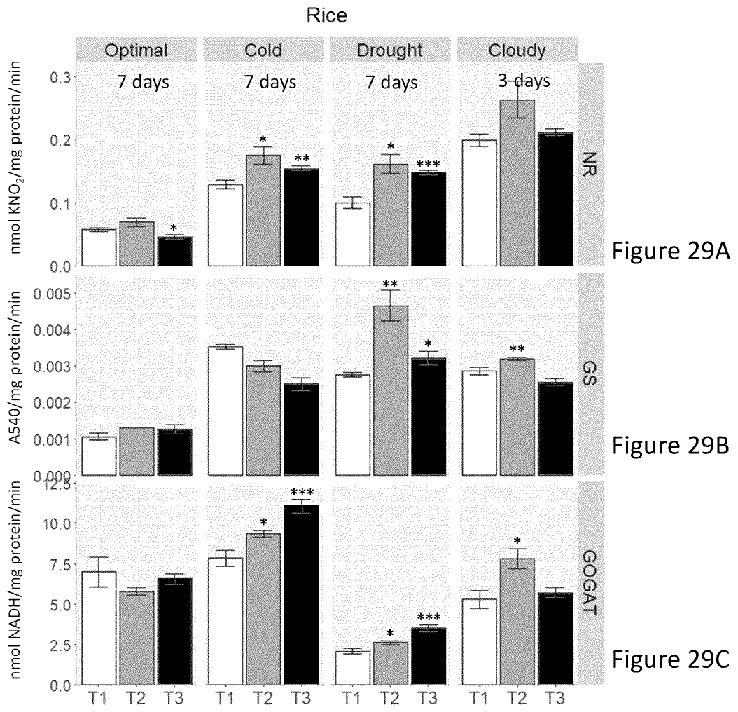

As shown in FIG. 29A, rice plants treated with the composition of the present invention (T2 groups) have higher NR activities than rice plants treated with only lower level of urea (T1 groups) and rice plants treated with higher level of urea (T3 groups) under all of the test conditions.

As shown in FIG. 29B, rice plants treated with the composition of the present invention (T2 groups) have higher GS activities than rice plants treated with only lower level of urea (T1 groups) under most of the test conditions, except cold condition. In addition, rice plants treated with the composition of the present invention (T2 groups) have higher GS activities than rice plants treated with higher level of urea (T3 groups) under most of the test conditions, except optimal condition.

As shown in FIG. 29C, rice plants treated with the composition of the present invention (T2 groups) have higher GOGAT activities than rice plants treated with only lower level of urea (T1 groups) under most of the test conditions, except optimal condition. In addition, rice plants treated with the composition of the present invention (T2 groups) have higher GOGAT activities than rice plants treated with higher level of urea (T3 groups) under cloudy condition.

The increase in activities of nitrogen assimilation enzymes caused by the composition of present invention indicates that the composition promotes the conversion of inorganic nitrogen to organic nitrogen, and in some cases, the effects of the composition of the present invention were stronger than that of the high nitrogen supply.

### 4.5 Activities of Nitrogen Assimilation Enzymes in Soybean

The samples from lower leaves were analyzed three days after application of the reagents listed in Table 7 under optimal condition, or three or seven days after recovering from stress.

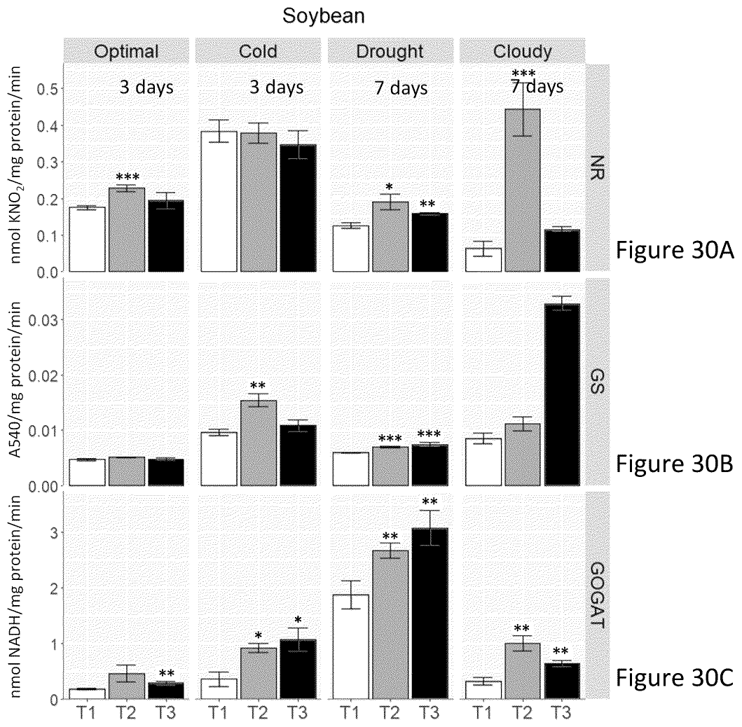

As shown in FIG. 30A, soybean plants treated with the composition of the present invention (T2 groups) have higher NR activities than soybean plants treated with only lower level of urea (T1 groups) and soybean plants treated with higher level of urea (T3 groups) under all of the test conditions.

As shown in FIG. 30B, soybean plants treated with the composition of the present invention (T2 groups) have higher GS activities than soybean plants treated with only lower level of urea (T1 groups) under all of the test conditions. In addition, soybean plants treated with the composition of the present invention (T2 groups) have higher GS activities than soybean plants treated with higher level of urea (T3 groups) under cold condition.

As shown in FIG. 30C, soybean plants treated with the composition of the present invention (T2 groups) have higher GOGAT activities than soybean plants treated with only lower level of urea (T1 groups) under all of the test conditions. In addition, soybean plants treated with the composition of the present invention (T2 groups) have higher GOGAT activities than soybean plants treated with higher level of urea (T3 groups) under optimal and cloudy conditions.

The increase in activities of nitrogen assimilation enzymes caused by the composition of present invention indicates that the composition promotes the conversion of inorganic nitrogen to organic nitrogen, and in some cases, the effects of the composition of the present invention were stronger than that of the high nitrogen supply.

### 4.6 Total Nitrogen Content

Nitrogen functions as part of plant structure and is involved in many plant life processes. Therefore, nitrogen content implies protein content in plants.

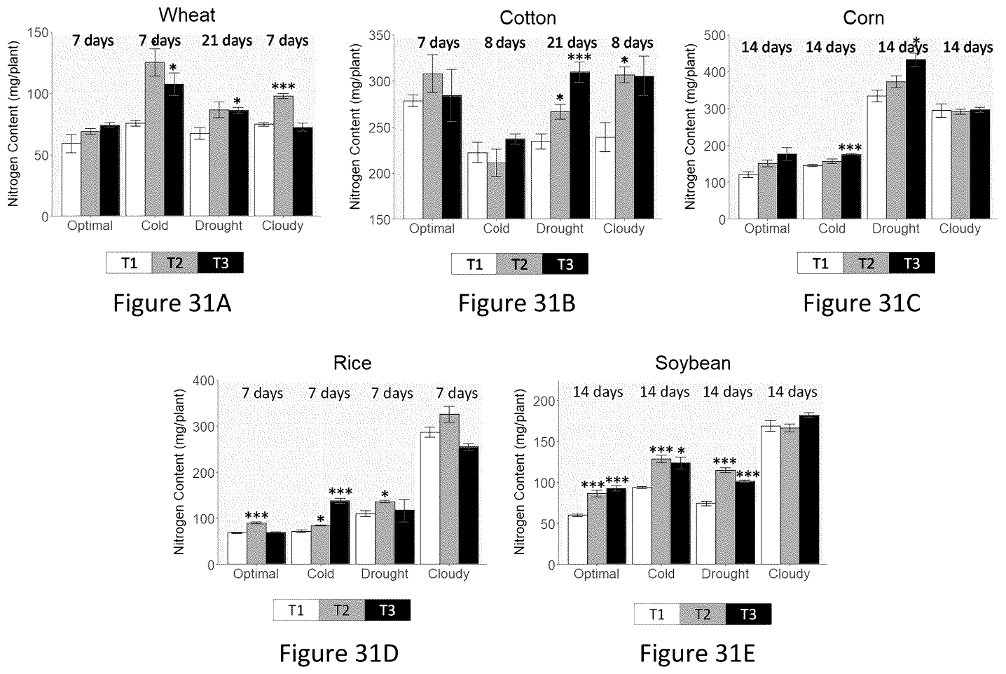

The above-ground parts of the test plants were ground into powder and analyzed for nitrogen content using the organic elemental analyzer (Thermo Fisher Scientific). As shown in FIGS. 31A to 31E, plants treated with the composition of the present invention (T2 groups) have higher nitrogen content than plants treated with only lower level of urea (T1 groups) under most of the test conditions, except cold-treated cotton (FIG. 31B), cloudy-treated corn (FIG. 31C), and cloudy-treated soybean (FIG. 31E). In addition, in some cases, plants treated with the composition of the present invention (T2 groups) have equal or higher nitrogen content than plants treated with higher level of urea (T3 groups), such as cold- and cloudy-treated wheat (FIG. 31A), optimally and cloudy-treated cotton (FIG. 31B), optimally, drought-, and cloudy-treated rice (FIG. 31D), and cold- and drought-treated soybean (FIG. 31E). The increase in nitrogen content caused by the composition of present invention indicates that the composition promotes protein biosynthesis under the optimal and stressful conditions, and in some cases, the effects of the composition of the present invention were stronger than that of the high nitrogen supply.

### 4.7 Soluble Protein Content

Soluble proteins not only function as metabolic resources and structural constituents of cells, but act as crucial enzymes related to photosynthesis and nitrogen assimilation. Therefore, soluble protein content is an indicator of yield of plants.

Soluble protein was extracted from lower leaves three or seven days after application of the reagents listed in Tables 3-7 under optimal condition or three, seven, or eight days after recovering from abiotic stresses.

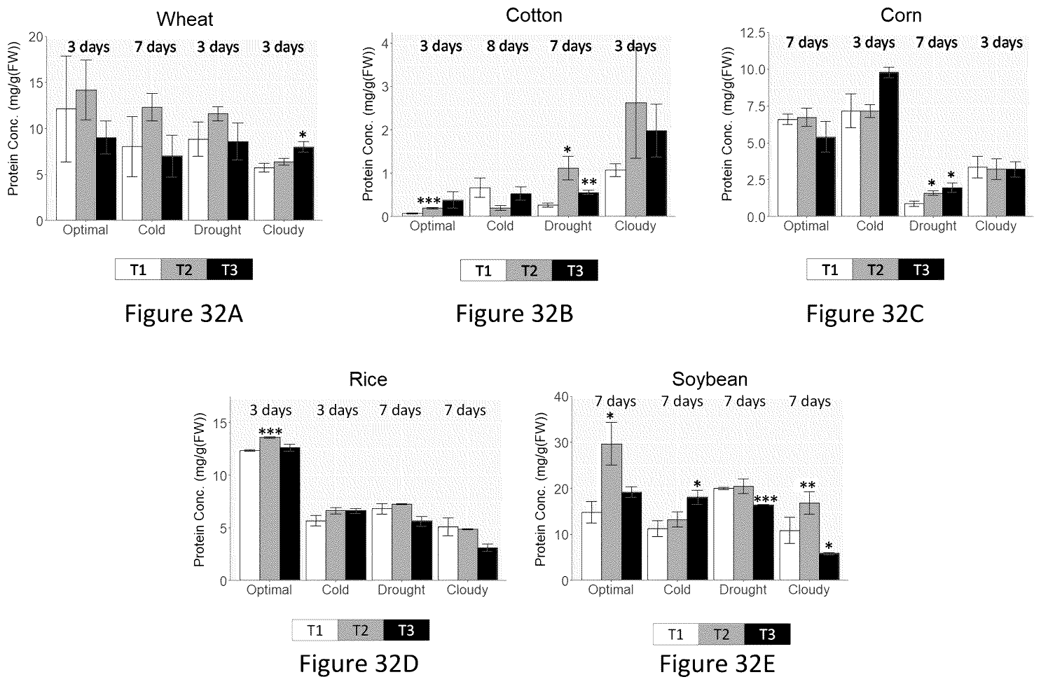

As shown in FIGS. 32A to 32E, plants treated with the composition of the present invention (T2 groups) have higher soluble protein content than plants treated with only lower level of urea (T1 groups) under most of the test conditions, except cold-treated cotton (FIG. 32B), cold- and cloudy-treated corn (FIG. 32C), and cloudy-treated rice (FIG. 32D). In addition, in some cases, plants treated with the composition of the present invention (T2 groups) have equal or higher soluble protein content than plants treated with higher level of urea (T3 groups), such as optimally, cold-, and drought-treated wheat (FIG. 32A), drought- and cloudy-treated cotton (FIG. 32B), optimally treated corn (FIG. 32C), optimally, drought-, and cloudy-treated rice (FIG. 32D), and optimally, drought-, and cloudy-treated soybean (FIG. 32E). The increase in soluble protein content caused by the composition of present invention indicates that the composition promotes many physiological functions and contribute to higher yield, and in some cases, the effects of the composition of the present invention were stronger than that of the high nitrogen supply.

### 4.8 Mineral Content in Wheat

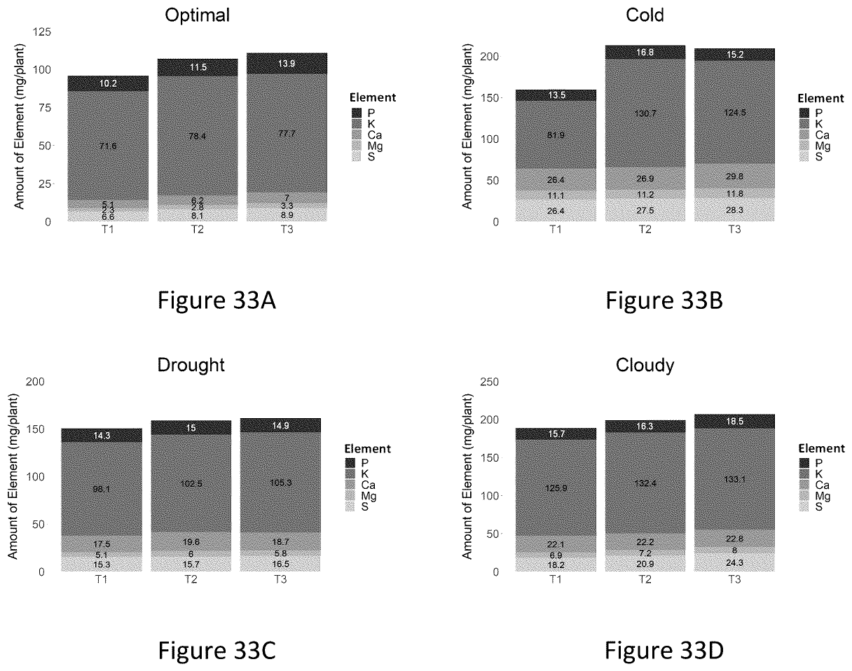

Promoting development of plant roots also drives the absorption of nutrients. Therefore, mineral content is an indicator of root development and metabolism in plants. The above-ground part of plants was grounded into powder and analyzed for mineral elements using inductively coupled plasma optical emission spectrometry (ICP-OES). As shown in FIGS. 33A to 33D, plants treated with the composition of the present invention (T2 groups) have higher mineral (including phosphorus (P), potassium (K), calcium (Ca), magnesium (Mg), and sulfur (S)) content than plants treated with only lower level of urea (T1 groups) under all of the test conditions, especially optimal (FIG. 33A) and cold (FIG. 33B) conditions. In addition, in some cases, plants treated with the composition of the present invention (T2 groups) have equal or higher mineral content than plants treated with higher level of urea (T3 groups), such as potassium (K) content under optimal condition (FIG. 33A), phosphorus (P) and potassium (K) contents under cold condition (FIG. 33B), and phosphorus (P), calcium (Ca), and magnesium (Mg) contents under drought condition (FIG. 33C). The increase in mineral (including P, K, Ca, Mg, and S) content caused by the composition of present invention indicates that the composition enhances structural elements, promotes energy metabolism, and triggers several biochemical adjustments, and in some cases, the effects of the composition of the present invention were stronger than that of the high nitrogen supply.

### 4.9 Mineral Content in Cotton

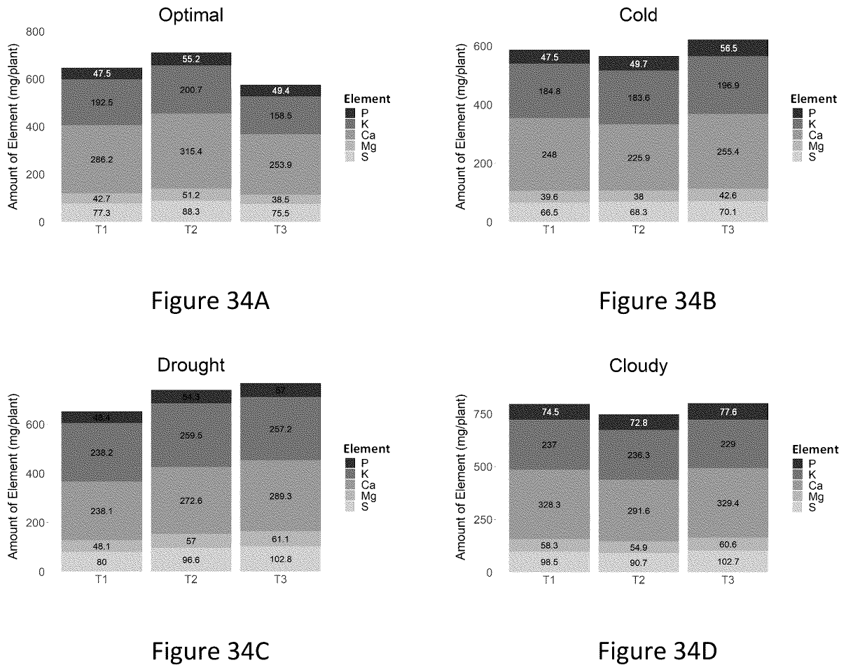

As shown in FIGS. 34A to 34D, plants treated with the composition of the present invention (T2 groups) have higher mineral (including P, K, Ca, Mg, and S) content than plants treated with only lower level of urea (T1 groups) under optimal (FIG. 34A) and drought (FIG. 34C) conditions. The increase in mineral (including P, K, Ca, Mg, and S) content caused by the composition of present invention indicates that the composition enhances structural elements, promotes energy metabolism, and triggers several biochemical adjustments under optimal and drought conditions.

### 4.10 Mineral Content in Corn

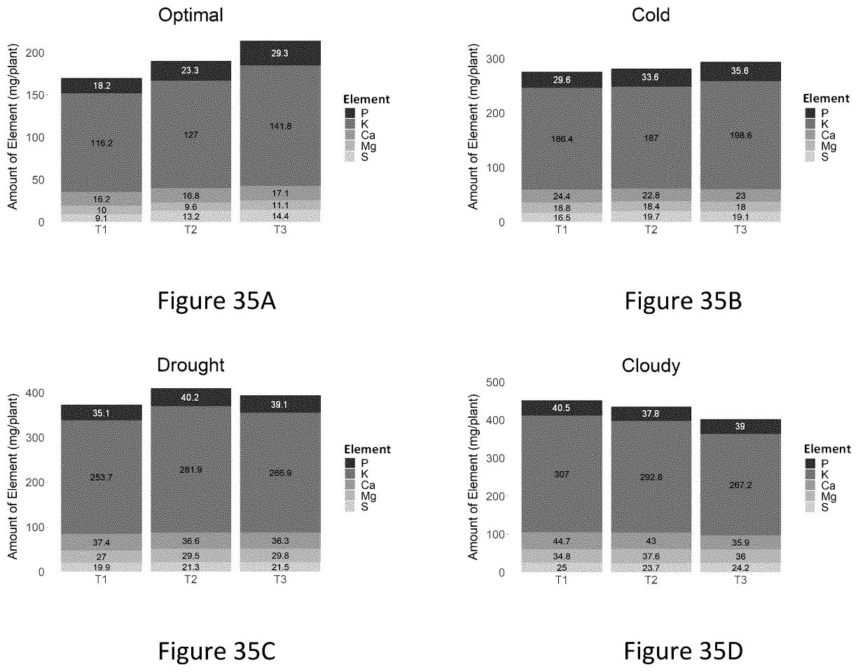

As shown in FIGS. 35A to 35D, plants treated with the composition of the present invention (T2 groups) have higher mineral (including P, K, Ca, Mg, and S) content than plants treated with only lower level of urea (T1 groups) under most of the test conditions, except cloudy condition (FIG. 35D). The increase in mineral (including P, K, Ca, Mg, and S) content caused by the composition of present invention indicates that the composition enhances structural elements, promotes energy metabolism, and triggers several biochemical adjustments.

### 4.11 Mineral Content in Rice

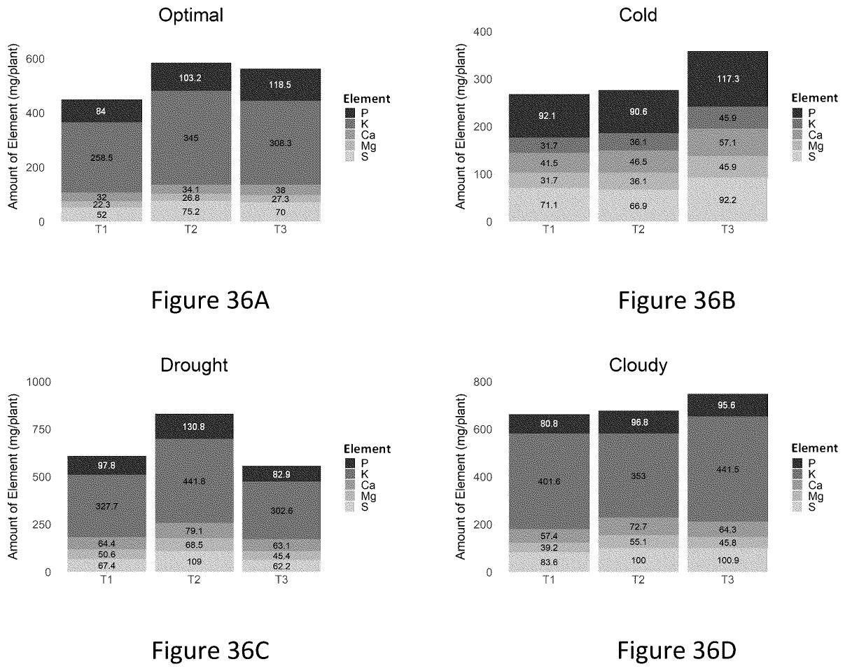

As shown in FIGS. 36A to 36D, plants treated with the composition of the present invention (T2 groups) have higher mineral (including P, K, Ca, Mg, and S) content than plants treated with only lower level of urea (T1 groups) under all of the test conditions, especially optimal (FIG. 36A) and drought (FIG. 36C) conditions. In addition, plants treated with the composition of the present invention (T2 groups) have higher mineral content than plants treated with higher level of urea (T3 groups) under drought condition (FIG. 36C). The increase in mineral (including P, K, Ca, Mg, and S) content caused by the composition of present invention indicates that the composition enhances structural elements, promotes energy metabolism, and triggers several biochemical adjustments, and in some cases, the effects of the composition of the present invention were stronger than that of the high nitrogen supply.

### 4.12 Mineral Content in Soybean

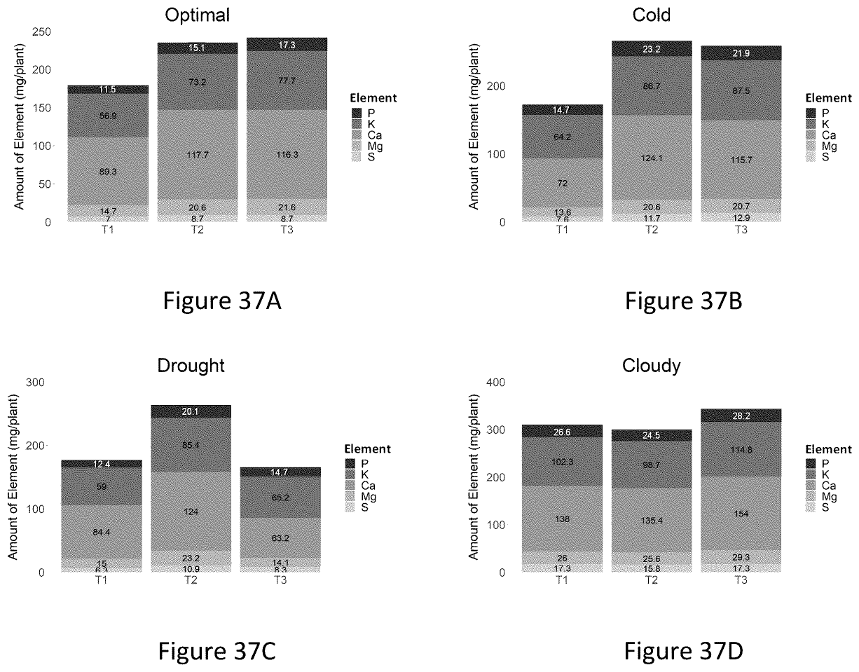

As shown in FIGS. 37A to 37D, plants treated with the composition of the present invention (T2 groups) have higher mineral (including P, K, Ca, Mg, and S) content than plants treated with only lower level of urea (T1 groups) under most of the test conditions, except cloudy condition (FIG. 37D). In addition, plants treated with the composition of the present invention (T2 groups) have higher mineral content than plants treated with higher level of urea (T3 groups) under drought condition (FIG. 37C). The increase in mineral (including P, K, Ca, Mg, and S) content caused by the composition of present invention indicates that the composition enhances structural elements, promotes energy metabolism, and triggers several biochemical adjustments, and in some cases, the effects of the composition of the present invention were stronger than that of the high nitrogen supply.

### 5. Effects on Enhancement of Yield

The potential of yield formation is always brought by crops' efficiency of nitrogen assimilation during the growth period under changeable climate conditions. This section provided the yield and quality data of the tested crops treated with the composition of the present invention under the test conditions.

### 5.1 Yield Analysis of Wheat

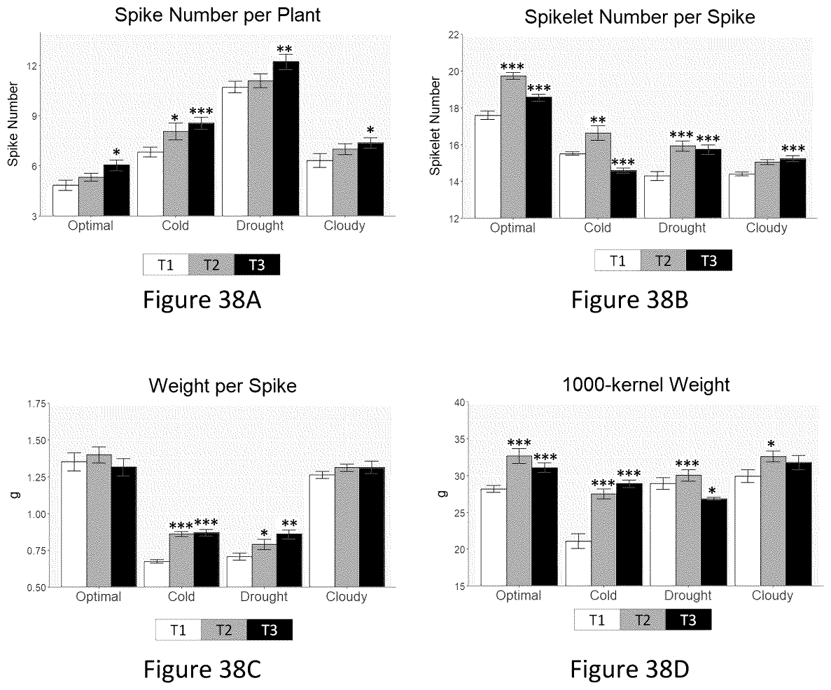

As shown in FIGS. 38A to 38D, wheat plants treated with the composition of the present invention (T2 groups) have more spike numbers per plant (FIG. 38A), spikelet numbers per spike (FIG. 38B), weight per spike (FIG. 38C), and 1000-kernel weight (FIG. 38D) than wheat plants treated with only lower level of urea (T1 groups) under all of the test conditions. In addition, wheat plants treated with the composition of the present invention (T2 groups) have more spikelet numbers per spike (FIG. 38B) and 1000-kernel weight (FIG. 38D) than wheat plants treated with higher level of urea (T3 groups) under optimal and drought conditions. The increase in spike number, spikelet number, spike weight, and 1000-kernel weight caused by the composition of present invention indicates that the composition contributes to the yield establishment, better grain filling, and better grain quality, and in some cases, the effects of the composition of the present invention were stronger than that of the high nitrogen supply.

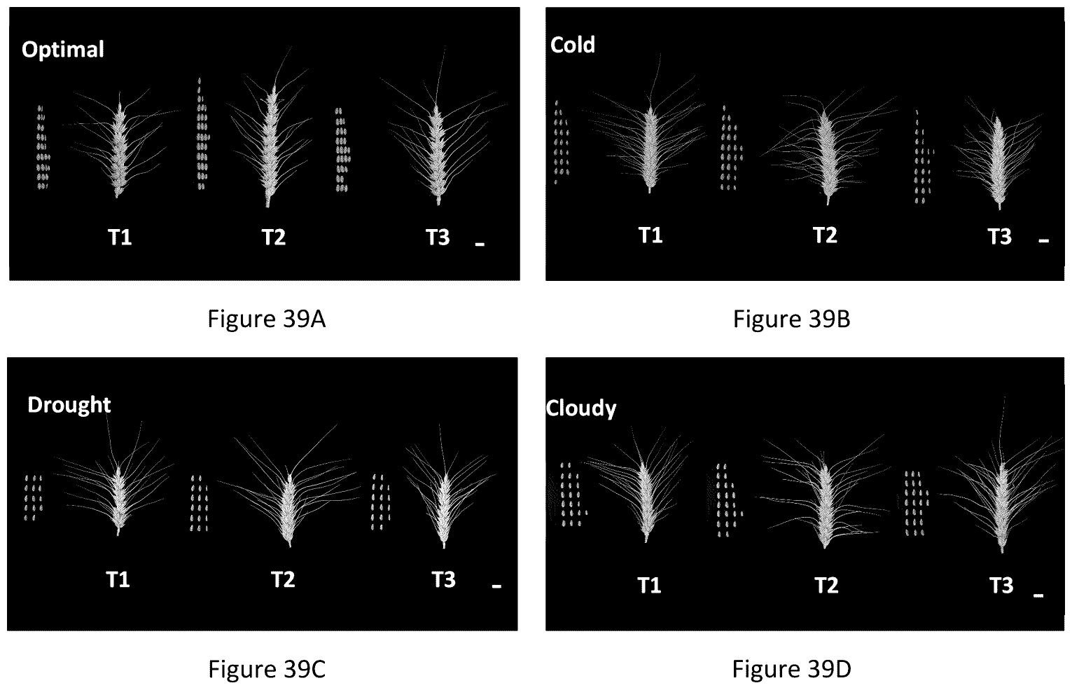

In addition, as shown in FIGS. 39A to 39D, wheat plants treated with the composition of the present invention (T2 groups) have more and larger kernels than wheat plants treated with only lower level of urea (T1 groups) and wheat plants treated with higher level of urea (T3 groups) under all of the test conditions. The increase in spikelet number and size caused by the composition of present invention indicates that the composition generally improves the fertility of apical spikelets, and increase the grain size of central and basal spikelets as well, and the effects of the composition of the present invention were stronger than that of the high nitrogen supply.

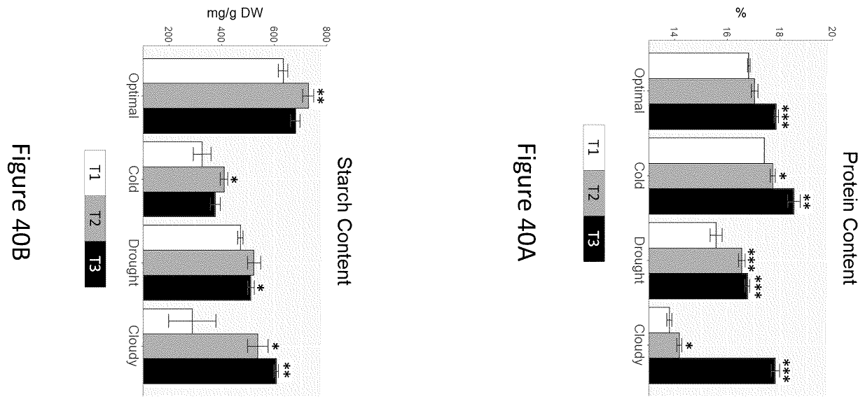

Furthermore, as shown in FIGS. 40A and 40B, wheat plants treated with the composition of the present invention (T2 groups) have higher protein content (FIG. 40A) and starch content (FIG. 40B) in grains than wheat plants treated with only lower level of urea (T1 groups) under all of the test conditions. In addition, as shown in FIG. 40B, wheat plants treated with the composition of the present invention (T2 groups) have higher starch content in grains than wheat plants treated with higher level of urea (T1 groups) under most of the test conditions, except cloudy condition. The increase in protein and starch content in grains caused by the composition of present invention indicates that the composition increases protein content and grain starch, and therefore, improve the quality of spikelet.

### 5.2 Yield Analysis of Cotton

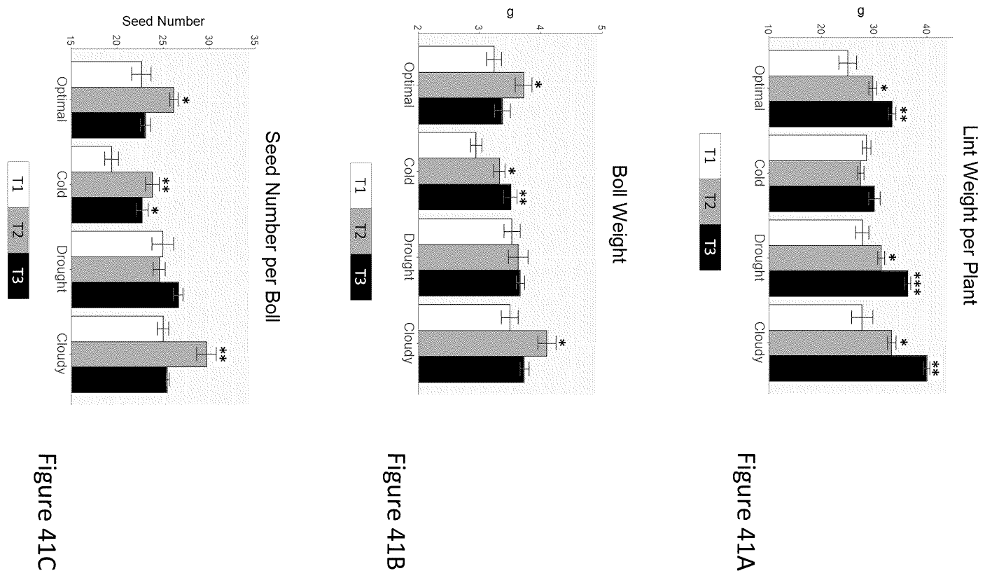

As shown in FIGS. 41A to 41C, cotton plants treated with the composition of the present invention (T2 groups) have more lint weight per plant (FIG. 41A), boll weight (FIG. 41B), and seed number per boll (FIG. 41C) than cotton plants treated with only lower level of urea (T1 groups) under most of the test conditions, except lint weight under cold condition (FIG. 41A) and seed number under drought condition (FIG. 41C). In addition, cotton plants treated with the composition of the present invention (T2 groups) have more boll weight (FIG. 41B) under optimal and cloudy conditions and more seed number per boll (FIG. 41C) under optimal, cold, and cloudy conditions than cotton plants treated with higher level of urea (T3 groups). The increase in lint weight per plant, boll weight, and seed number per boll caused by the composition of present invention indicates that the composition contributes to the yield establishment, and in some cases, the effects of the composition of the present invention were stronger than that of the high nitrogen supply.

In addition, since cotton bolls grow from bottom to top, and the first position grows earlier and larger than the other fruit positions. The earlier, lower bolls have higher quality and contribute greatly to yield, and the lint value of the bolls at the first position (first position bolls) will be higher than that of the other positions. Therefore, the percentage of early bolls and the percentage of first position bolls are both indicators of boll quality.

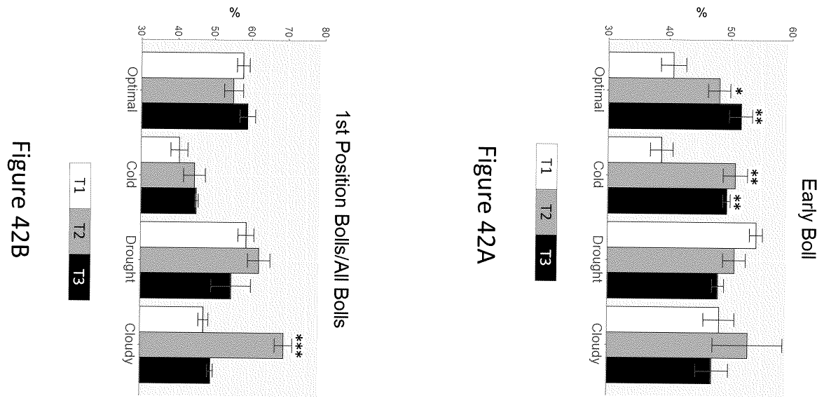

As shown in FIG. 42A, cotton plants treated with the composition of the present invention (T2 groups) have higher percentage of early bolls than cotton plants treated with only lower level of urea (T1 groups) under most of the test conditions, except drought condition. In addition, cotton plants treated with the composition of the present invention (T2 groups) have higher percentage of early bolls than cotton plants treated with higher level of urea (T3 groups) under cold and cloudy conditions. As shown in FIG. 42B, cotton plants treated with the composition of the present invention (T2 groups) have higher percentage of first position bolls than cotton plants treated with only lower level of urea (T1 groups) under most of the test conditions, except optimal condition. In addition, cotton plants treated with the composition of the present invention (T2 groups) have higher percentage of first position bolls than cotton plants treated with higher level of urea (T3 groups) under drought and cloudy conditions. The increase in percentage of early bolls and first position bolls caused by the composition of present invention indicates that the composition contributes to better lint quality, and in some cases, the effects of the composition of the present invention were stronger than that of the high nitrogen supply.

### 5.3 Yield Analysis of Corn

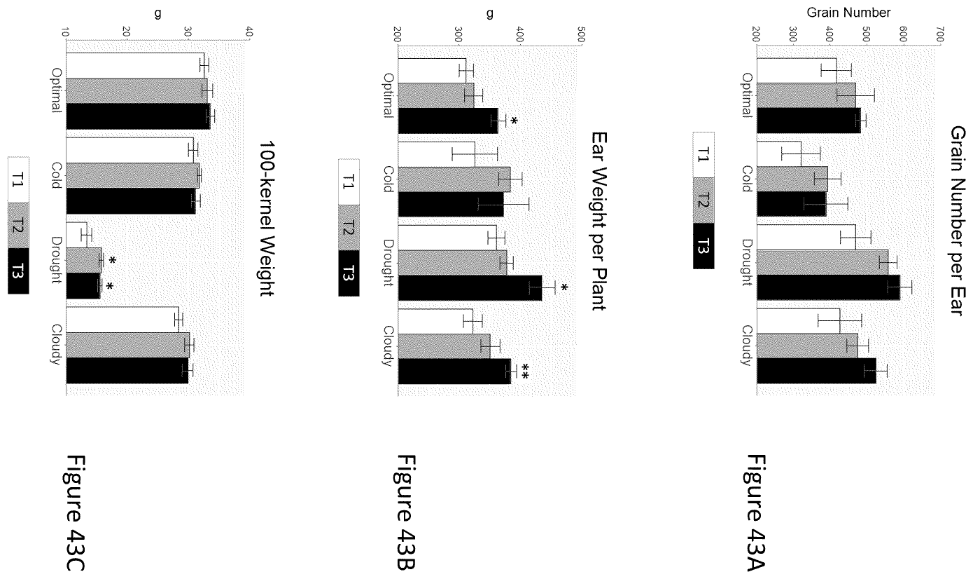

As shown in FIGS. 43A to 43C, corn plants treated with the composition of the present invention (T2 groups) have more grain number per ear (FIG. 43A), ear weight per plant (FIG. 43B), and 100-kernel weight (FIG. 43C) than corn plants treated with only lower level of urea (T1 groups) under all of the test conditions. The increase in grain number per ear, ear weight per plant, and 100-kernel weight caused by the composition of present invention indicates that the composition contributes to the yield establishment and better grain fullness and quality.

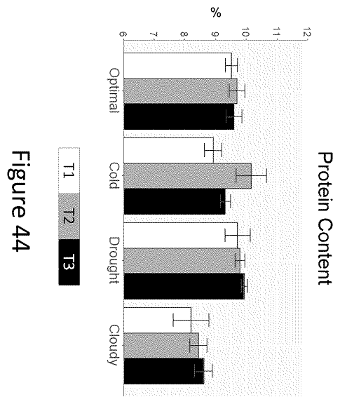

In addition, as shown in FIG. 44, corn plants treated with the composition of the present invention (T2 groups) have higher protein content in corn kernel than corn plants treated with only lower level of urea (T1 groups) under all of the test conditions. In addition, corn plants treated with the composition of the present invention (T2 groups) have higher protein content in corn kernel than corn plants treated with higher level of urea (T3 groups) under optimal and cold conditions. The increase in protein content in corn caused by the composition of present invention indicates that the composition improves grain quality.

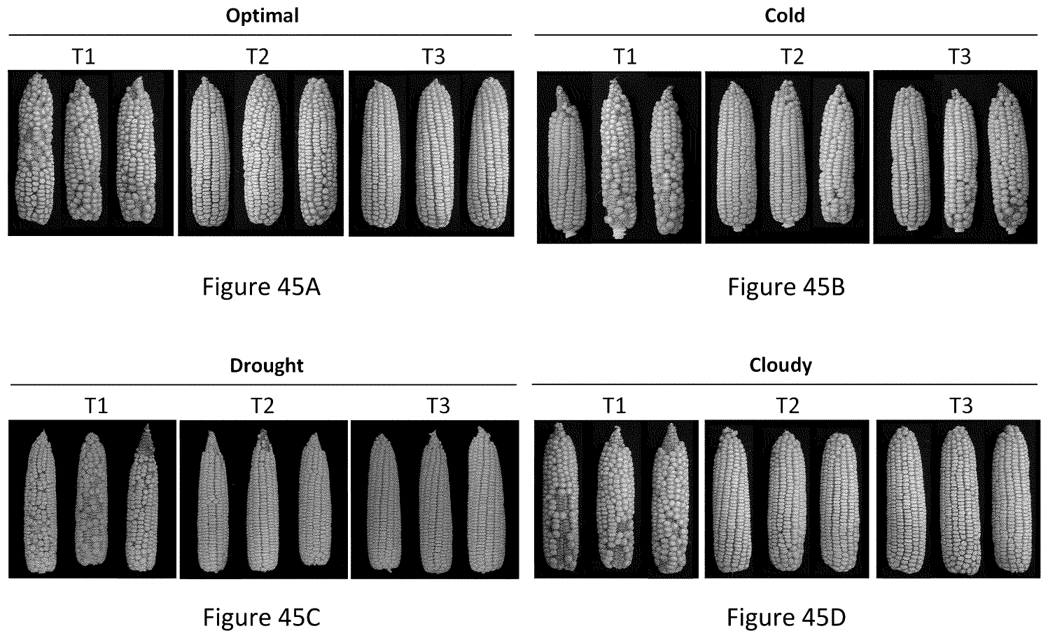

Furthermore, as shown in FIG. 45A to 45D, corn plants treated with the composition of the present invention (T2 groups) have more kernels per ear than corn plants treated with only lower level of urea (T1 groups) under all of the test conditions. In addition, corn plants treated with the composition of the present invention (T2 groups) have equal or more kernels per ear than corn plants treated with higher level of urea (T3 groups) under most of the test conditions, except optimal condition. The increase in kernels per ear caused by the composition of present invention indicates that the composition improves corn quality.

### 5.4 Yield Analysis of Rice

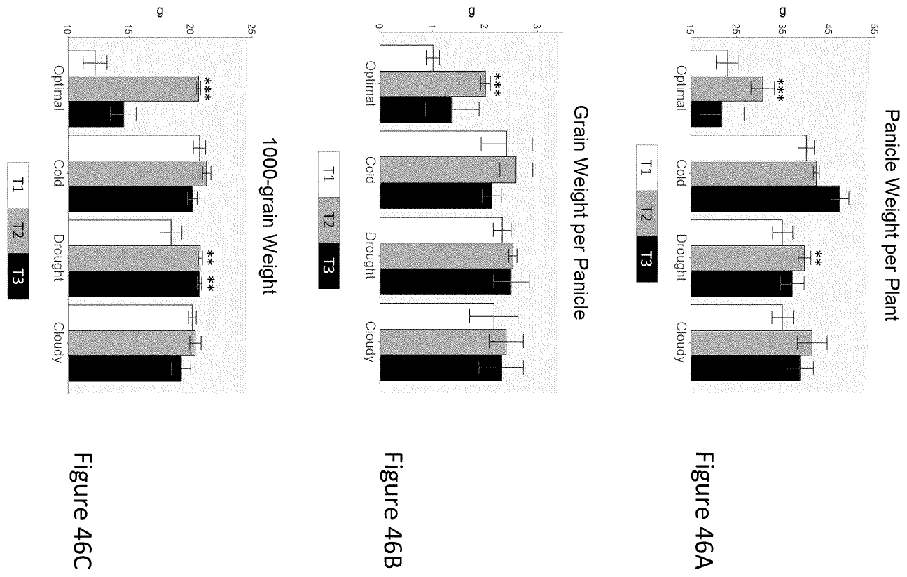

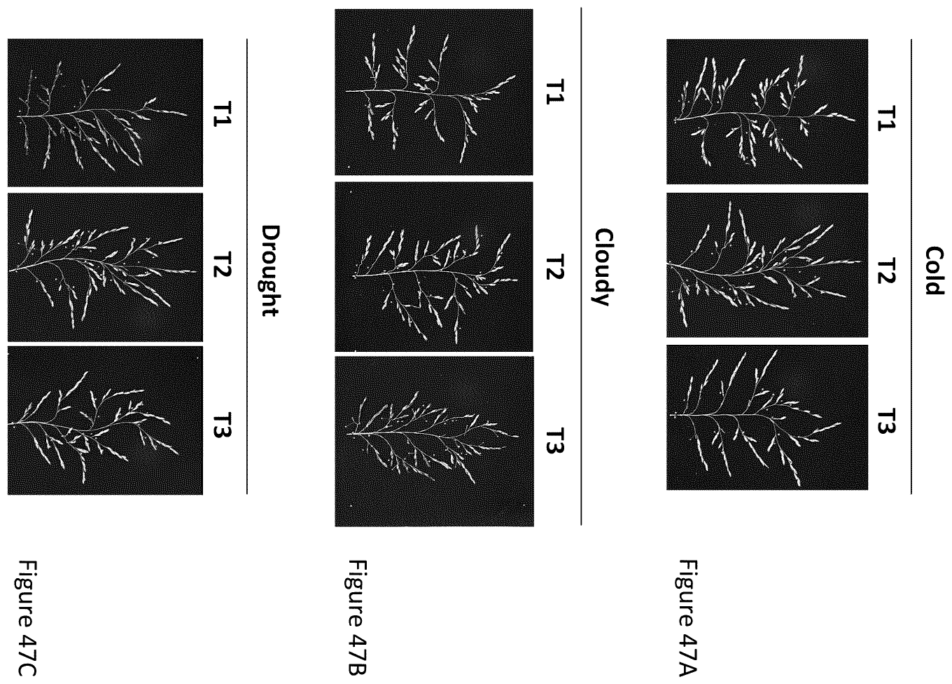

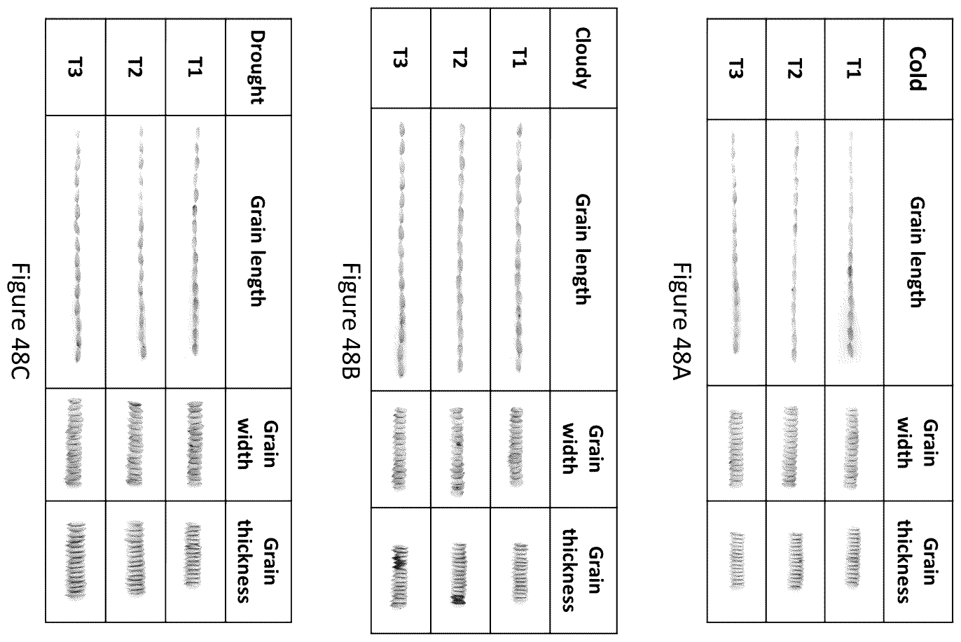

As shown in FIGS. 46A to 46C, rice plants treated with the composition of the present invention (T2 groups) have more panicle weight per plant (FIG. 46A), grain weight per panicle (FIG. 46B), and 1000-grain weight (FIG. 46C) than rice plants treated with only lower level of urea (T1 groups) and rice plants treated with higher level of urea (T3 groups) under most of the test conditions. Note that in the optimal growing area, the yield formation was greatly destroyed due to the occurrence of bacterial leaf blight. However, under the threat of bacteria, rice plants treated with the composition of the present invention (T2 groups) still have more panicle weight per plant (FIG. 46A), grain weight per panicle (FIG. 46B), and 1000-grain weight (FIG. 46C) than rice plants treated with only lower level of urea (T1 groups) and rice plants treated with higher level of urea (T3 groups). The increase in panicle weight per plant, grain weight per panicle, and 1000-grain weight caused by the composition of present invention indicates that the composition contributes to the yield establishment and better grain fullness and quality. In addition, as shown in FIGS. 47A to 47C, rice plants treated with the composition of the present invention (T2 groups) have larger rice panicles with more branches than rice plants treated with only lower level of urea (T1 groups) and rice plants treated with higher level of urea (T3 groups) under cold-treated condition (FIG. 47A), cloudy-treated condition (FIG. 47B), and drought-treated condition (FIG. 47C). As shown in FIGS. 48A to 48C, rice plants treated with the composition of the present invention (T2 groups) have longer, wider, and thicker grains than rice plants treated with only lower level of urea (T1 groups) and rice plants treated with higher level of urea (T3 groups) under cold-treated condition (FIG. 48A), cloudy-treated condition (FIG. 48B), and drought-treated condition (FIG. 48C). The increase in length, width, and thickness of grains caused by the composition of present invention indicates that the composition contributes to better grain filling and quality.

### 5.5 Yield Analysis of Soybean

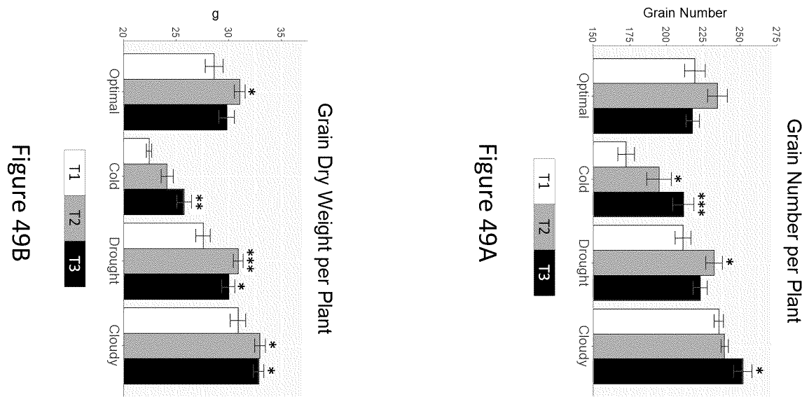

As shown in FIGS. 49A and 49B, soybean plants treated with the composition of the present invention (T2 groups) have more grain number per plant (FIG. 49A) and grain dry weight per plant (FIG. 49B) than soybean plants treated with only lower level of urea (T1 groups) under all of the test conditions. In addition, soybean plants treated with the composition of the present invention (T2 groups) have more grain number per plant (FIG. 49A) and grain dry weight per plant (FIG. 49B) than soybean plants treated with higher level of urea (T3 groups) under optimal and drought conditions. The increase in grain number per plant and grain dry weight per plant caused by the composition of present invention indicates that the composition enhances yield components, and in some cases, the effects of the composition of the present invention were stronger than that of the high nitrogen supply.

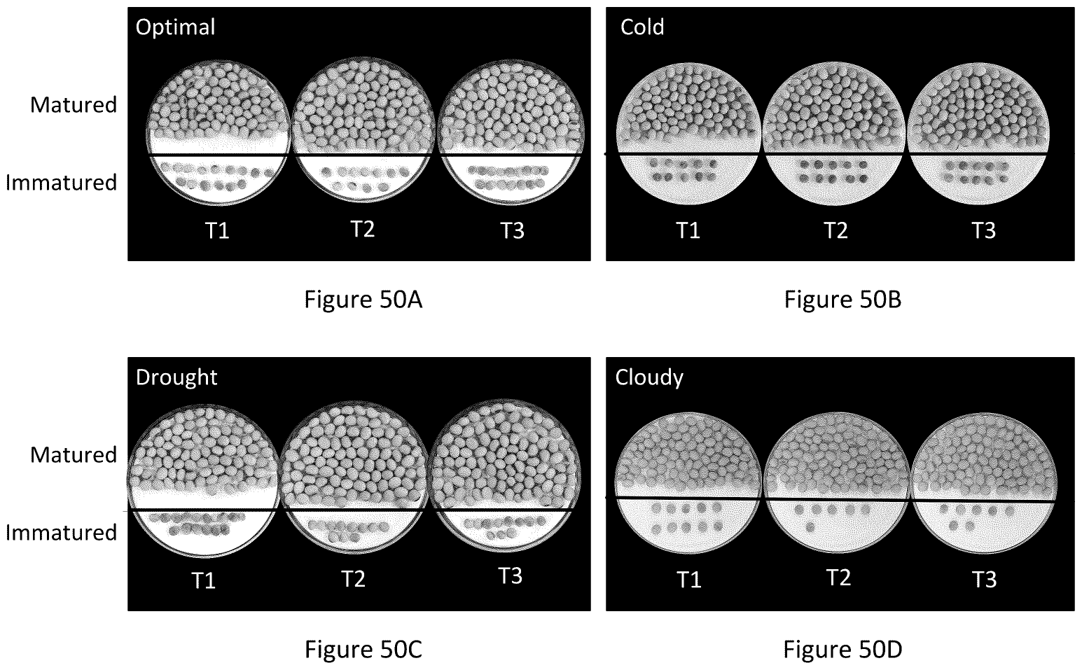

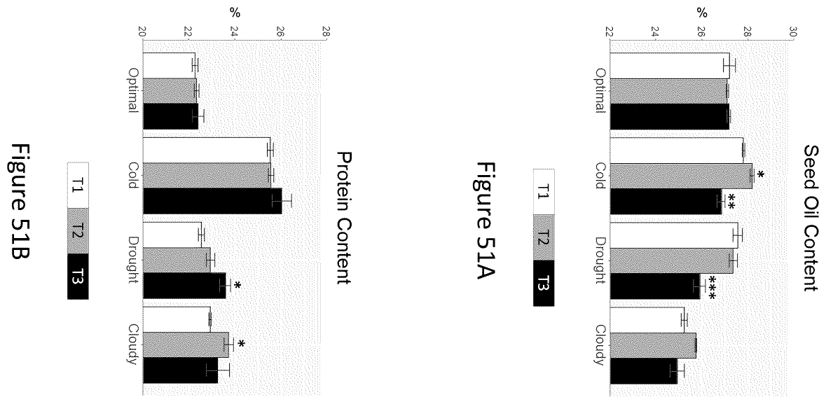

In addition, as shown in FIGS. 50A to 50D, soybean plants treated with the composition of the present invention (T2 groups) have more mature (saleable) seeds per soybean plant than soybean plants treated with only lower level of urea (T1 groups) and soybean plants treated with higher level of urea (T3 groups) under all of the test conditions. On the other hand, soybean plants treated with the composition of the present invention (T2 groups) have less immature seeds per soybean plant than soybean plants treated with only lower level of urea (T1 groups) and soybean plants treated with higher level of urea (T3 groups) under optimal, drought, and cloudy conditions. The increase in mature (saleable) seeds and the decrease in immature seeds caused by the composition of present invention indicates that the composition contributes to better seed quality. Furthermore, as shown in FIG. 51A, soybean plants treated with the composition of the present invention (T2 groups) have higher seed oil content than soybean plants treated with only lower level of urea (T1 groups) and soybean plants treated with higher level of urea (T3 groups) under cold and cloudy conditions. As shown in FIG. 51B, soybean plants treated with the composition of the present invention (T2 groups) have higher seed protein content than soybean plants treated with only lower level of urea (T1 groups) and soybean plants treated with higher level of urea (T3 groups) under cloudy conditions. The increase in seed oil content and seed protein content caused by the composition of present invention indicates that the composition contributes to better seed quality.

### 6. Conclusion

The examples above support that the composition of the present invention enhances nitrogen assimilation under optimal and suboptimal (cold, drought or cloudy) conditions. The effects of the composition of the present invention are confirmed in the three areas listed below:
1. The composition of the present invention promotes root establishment and therefore enhances nutrient absorption.
2. The composition of the present invention improves the efficiency of photosynthesis, thereby increasing the supply of energy and carbon skeleton (2-OG) to drive nitrogen assimilation through the GS-GOGAT pathway.
3. The composition of the present invention enhances the activities of nitrogen assimilation enzymes and results in higher yield.

### Example 2 Effects of the Compositions of the Present Invention with Different Concentrations of Active Ingredients on Plants

### A. Materials and Methods

### 1. Plant Growth and Treatment

Corn seeds (P1197AMXT, Corteva Agriscience) were sown in pots containing culture medium (peat soil:perlite=3:1) and placed in a greenhouse at 25-28° C. One seed was sown in one pot. Corn plants were divided into 5 groups to receive different reagents listed in Table 13 once at V1 stage at a rate of 12.5 ml/12 pots using a foliar spray treatment. After the application of reagents, corn plants were kept in the greenhouse (25-28° C.) with limited watering (1.25 L/12 pots, drought condition) for 7 days. Soybean seeds (Kaohsiung 10, Kaohsiung District Agricultural Research and Extension Station, Kaohsiung, Taiwan) were sown in pots containing culture medium (peat soil:perlite=3:1) and placed in a greenhouse at 25-28° C. One seed was sown in one pot. Soybean plants were divided into 5 groups to receive different reagents listed in Table 13 once at V1 stage at a rate of 15 ml/12 pots by soil drench. After the application of reagents, soybean plants were kept in the greenhouse (25-28° C.) with limited watering (5.8 L/12 pots, drought condition) for 14 days.

TABLE 13
Summary of the reagents applied to corn
and soybean plants in Example 2

| | IBA | SA | Melatonin | Tween ® 80, % |
|---|---|---|---|---|
| Group | (mg/L) | (mg/L) | (mg/L) | (v/v) |
| T1 | 0 | 0 | 0 | 0.1 |
| T2 | 1 | 2 | 1 | 0.1 |
| T3 | 10 | 20 | 10 | 0.1 |
| T4 | 50 | 100 | 50 | 0.1 |
| T5 | 100 | 200 | 100 | 0.1 |

### 2. Analyses

### 2.1 Shoot Fresh Weight

Seven (7) days after the application of reagents, 24 corn plants from each group were randomly selected to measure shoot fresh weight (n=24). Fourteen (14) days after the application of reagents, 16 soybean plants from each group were randomly selected to measure shoot fresh weight (n=16). Fresh weight of the leaves and stems of each plant was measured.

### 2.2 Leaf Area

Seven (7) days after the application of reagents, 24 corn plants from each group were randomly selected for analysis (N=24). Fourteen (14) days after the application of reagents, 16 soybean plants from each group were randomly selected for analysis (N=16). The leaf area of corn and soybean was scanned by EPSON scanner and analyzed by a leaf analyzer (WinFOLIA™, Regent Instruments Inc.).

### 2.3 Total Nitrogen Content

Seven (7) days after the application of reagents, 18 corn plants from each group were randomly selected for analysis (N=18). Fourteen (14) days after the application of reagents, 8 soybean plants from each group were randomly selected for analysis (N=8). The second corn leaf from the bottom of the corn plants and the first to third trifoliate leaves from the bottom of the soybean plants were collected, dried at 55° C. for 2 days, and ground into powder. Then, nitrogen content of the powder samples was measured by organic elemental analyzer (Flash 2000, Thermo Fisher Scientific).

### 2.4 Statistics

Unpaired Student's t-test was applied to assess numerical data statistical significance. Statistical significance was set at p-value less than 0.05.

### B. Results

### 1. Shoot Fresh Weight

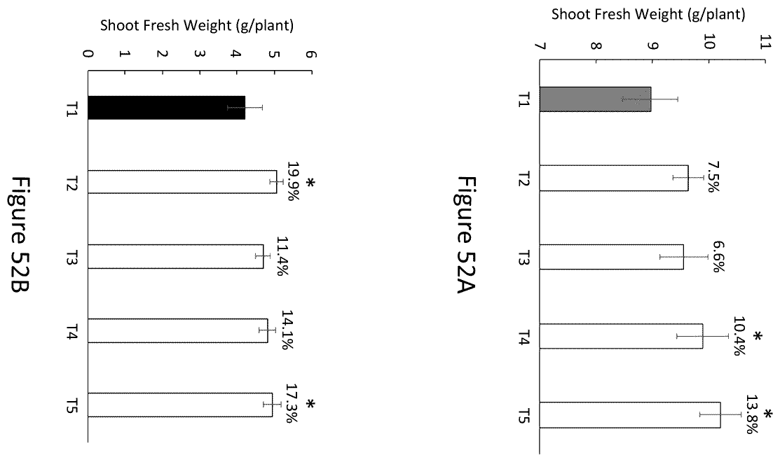

As shown in FIG. 52A, corn plants of all the four groups (T2 to T5 groups) treated with the compositions of the present invention have more shoot fresh weight than corn plants not treated with the compositions (T1 group) under the drought condition. In particular, corn plants of T4 and T5 groups have significantly more shoot fresh weight than corn plants of T1 group under the drought condition (p<0.05).

As shown in FIG. 52B, soybean plants of all the four groups (T2 to T5 groups) treated with the compositions of the present invention have more shoot fresh weight than soybean plants not treated with the compositions (T1 group) under the drought condition. In particular, soybean plants of T2 and T5 groups have significantly more shoot fresh weight than soybean plants of T1 group under the drought condition (p<0.05).

### 2. Leaf Area

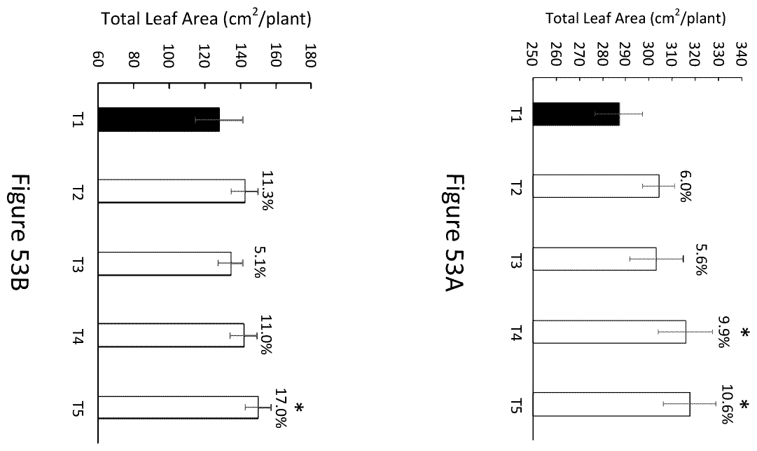

As shown in FIG. 53A, corn plants of all the four groups (T2 to T5 groups) treated with the compositions of the present invention have more leaf area than corn plants not treated with the compositions (T1 group) under the drought condition. In particular, corn plants of T4 and T5 groups have significantly more leaf area than corn plants of T1 group under the drought condition (p<0.05).

As shown in FIG. 53B, soybean plants of all the four groups (T2 to T5 groups) treated with the compositions of the present invention have more leaf area than soybean plants not treated with the compositions (T1 group) under the drought condition. In particular, soybean plants of T5 group have significantly more leaf area than soybean plants of T1 group under the drought condition (p<0.05).

### 3. Total Nitrogen Content

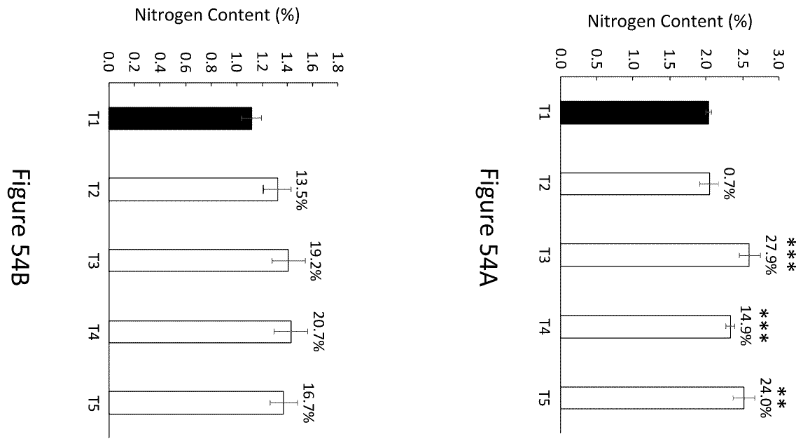

As shown in FIG. 54A, corn plants of all the four groups (T2 to T5 groups) treated with the compositions of the present invention have more total nitrogen content than corn plants not treated with the compositions (T1 group) under the drought condition. In particular, corn plants of T3, T4 and T5 groups have significantly more total nitrogen content than corn plants of T1 group under the drought condition (p<0.01 or p<0.001). As shown in FIG. 54B, soybean plants of all the four groups (T2 to T5 groups) treated with the compositions of the present invention have more total nitrogen content than soybean plants not treated with the compositions (T1 group) under the drought condition.

### C. Conclusion

The increase in shoot fresh weight and leaf area caused by the compositions of present invention indicates that the compositions of the present invention with different concentrations of active ingredients promote plant growth under abiotic stress conditions, contributing to a good foundation for crop yield since shoot fresh weight is highly correlated to the final yield and contributing to higher light harvest ability since leaf area is positively correlated with light harvest ability, also with the final yield. In addition, the increase in total nitrogen content caused by the compositions of present invention indicates that the compositions of the present invention with different concentrations of active ingredients enhance nitrogen absorption and nitrogen assimilation (i.e., nitrogen use efficiency) of plants under abiotic stress conditions.

### Example 3 Synergistic Effect of the Composition of the Present Invention on Plants

### A. Materials and Methods

### 1. Plant Growth and Treatment

Corn seeds (P1197AMXT, Corteva Agriscience) were sown in pots containing culture medium (peat soil:perlite=3:1) and placed in a greenhouse at 25-28° C. One seed was sown in one pot. Corn plants were divided into 8 groups to receive different reagents listed in Table 14 once at V1 stage at a rate of 12.5 ml/12 pots using a foliar spray treatment. After the application of reagents, corn plants were kept in the greenhouse (25-28° C.) with limited watering (1.99 L/12 pots, drought condition) for 13 days.

Soybean seeds (Kaohsiung 10) were sown in pots containing culture medium (peat soil:perlite=3:1) and placed in a greenhouse at 25-28° C. One seed was sown in one pot. Soybean plants were divided into 8 groups to receive different reagents listed in Table 14 once at V1-V2 stage at a rate of 15 ml/12 pots by soil drench. After the application of reagents, soybean plants were kept in the greenhouse (25-28° C.) with limited watering (5.8 L/12 pots, drought condition) for 14 days.

TABLE 14
Summary of the reagents applied to corn
and soybean plants in Example 3

| | IBA | SA | Melatonin | Tween ® 80, % |
|---|---|---|---|---|
| Group | (mg/L) | (mg/L) | (mg/L) | (v/v) |
| T1 | 0 | 0 | 0 | 0.1 |
| T2 | 50 | 0 | 0 | 0.1 |
| T3 | 0 | 100 | 0 | 0.1 |
| T4 | 0 | 0 | 50 | 0.1 |
| T5 | 50 | 100 | 0 | 0.1 |
| T6 | 50 | 0 | 50 | 0.1 |
| T7 | 0 | 100 | 50 | 0.1 |
| T8 | 50 | 100 | 50 | 0.1 |

### 2. Analyses

### 2.1 Shoot Biomass

Thirteen (13) days after the application of reagents, 12 corn plants from each group were randomly selected (n=12). Shoots, including leaves and sheaths, of each selected corn plant were collected and dried at 55° C. for 2 days, and then the shoot dry weight was measured.

Fourteen (14) days after the application of reagents, 16 soybean plants from each group were randomly selected (n=16). Shoots, including leaves and stems, of each selected plant were collected and dried at 55° C. for 2 days, and then the shoot dry weight was measured.

### 2.2 Leaf Area

Thirteen (13) days after the application of reagents, 10 corn plants from each group were randomly selected for analysis (n=10). Fourteen (14) days after the application of reagents, 16 soybean plants from each group were randomly selected for analysis (n=16). The leaf area of corn and soybean was scanned by EPSON scanner and analyzed by a leaf analyzer (WinFOLIA™, Regent Instruments Inc.).

### 2.3 Total Nitrogen Content

Total nitrogen content of soybean plants was measured as described in section 2.3 in Example 2.

### 2.4 Statistics

Unpaired Student's t-test was applied to assess numerical data statistical significance. Statistical significance was set at p-value less than 0.05.

### B. Results

### 1. Shoot Biomass

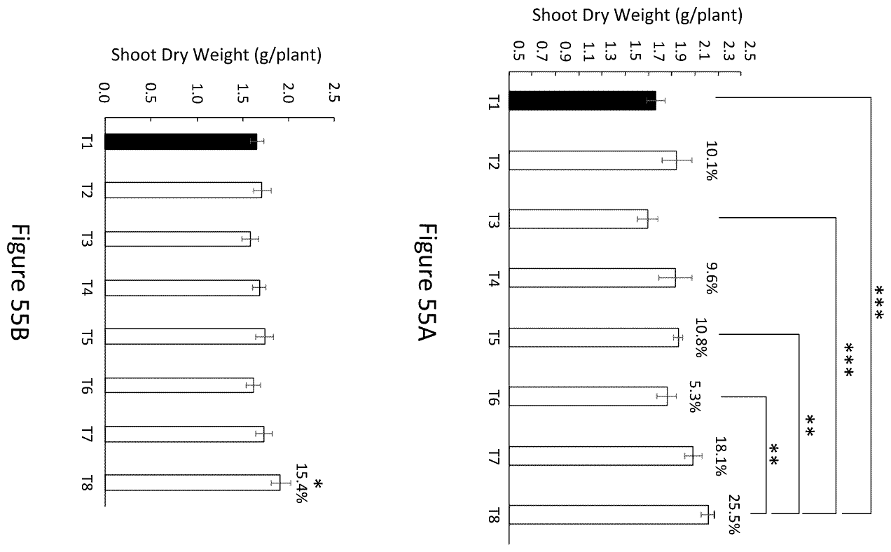

As shown in FIG. 55A, under the drought condition, as compared to corn plants not treated with any active ingredient of the composition (T1 group), corn plants treated with the composition of the present invention (T8 group) have the most significant increase (18.5%) in shoot dry weight among all the groups treated with at least one active ingredient of the composition of the present invention (T2 to T8 groups). In other words, corn plants treated with the composition of the present invention (T8 group) have more shoot dry weight than all the corn plants not treated with the composition of the present invention (T1 to T7 groups), especially significantly more than T1, (T2), T3, T5, T6 groups (p<0.05; p<0.01; p<0.001).

Similarly, as shown in FIG. 55B, under the drought condition, as compared to soybean plants not treated with any active ingredient of the composition (T1 group), soybean plants treated with the composition of the present invention (T8 group) have the most significant increase (15.4%) in shoot biomass among all the groups treated with at least one active ingredient of the composition of the present invention (T2 to T8 groups) (p<0.05).

### 2. Leaf Area

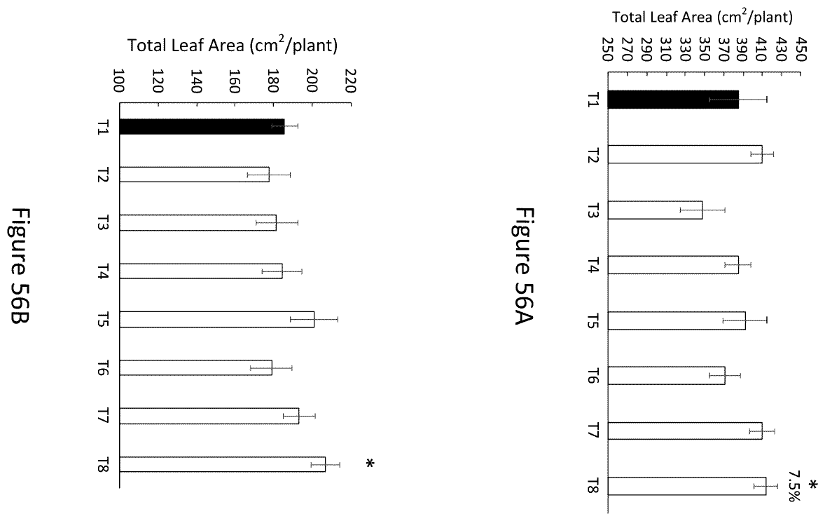

As shown in FIG. 56A, under the drought condition, as compared to corn plants not treated with any active ingredient of the composition (T1 group), corn plants treated with the composition of the present invention (T8 group) have the most significant increase (7.5%) in leaf area among all the groups treated with at least one active ingredient of the composition of the present invention (T2 to T8 groups) (p<0.05).

Similarly, as shown in FIG. 56B, under the drought condition, as compared to soybean plants not treated with any active ingredient of the composition (T1 group), soybean plants treated with the composition of the present invention (T8 group) have the most significant increase (11.4%) in leaf area among all the groups treated with at least one active ingredient of the composition of the present invention (T2 to T8 groups) (p<0.05).

### 3. Total Nitrogen Content

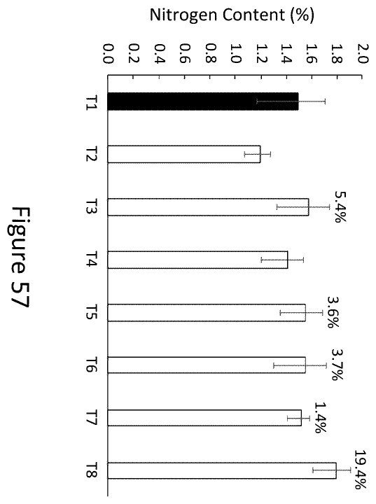

As shown in FIG. 57, under the drought condition, soybean plants treated with the composition of the present invention (T8 group) have more total nitrogen content than all the corn plants not treated with the composition of the present invention (T1 to T7 groups).

### C. Conclusion

The significant increase in shoot biomass and leaf area caused by the compositions of the present invention shows the synergistic effects of the composition of the present invention on plant growth regulation action, contributing to a good foundation for crop yield since shoot biomass is highly correlated to the final yield and to higher light harvest ability since leaf area is positively correlated with light harvest ability, also with the final yield. In addition, the increase in total nitrogen content caused by the compositions of present invention also shows the synergistic effects of the composition of the present invention on enhancing nitrogen absorption and nitrogen assimilation (i.e., nitrogen use efficiency) of plants under abiotic stress conditions.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A concentrate composition for enhancing nitrogen assimilation in plants, comprising
between about 0.05 g/L to about 20 g/L auxin;
between about 0.1 g/L to about 40 g/L salicylic acid; and
between about 0.05 g/L to about 20 g/L melatonin.

2. The concentrate composition of claim 1, wherein the auxin is selected from indole-3-butyric acid (IBA), indole-3-acetic acid (IAA), 2-phenylacetic acid (PAA), indole-3-propionic acid (IPA), and 1-naphthaleneacetic acid (NAA).

3. The concentrate composition of claim 1, wherein the concentrate composition for enhancing nitrogen assimilation in plants is diluted about 50 folds to 200 folds before use.

4. The concentrate composition of claim 1, wherein the concentrate composition enhances nitrogen assimilation in plants by at least one of the methods selected from enhancing nitrogen absorption, improving photosynthesis efficiency to increase the supply of energy and 2-oxoglutarate (2-OG) to drive nitrogen assimilation through the glutamine synthetase-glutamate synthase (GS-GOGAT) pathway, and enhancing the activities of nitrogen assimilation enzymes.

5. The concentrate composition of claim 4, wherein the nitrogen assimilation enzyme is at least one enzyme selected from the group consisting of nitrate reductase, glutamine synthetase, and glutamate synthase.

6. A ready to use composition for enhancing nitrogen assimilation in plants, comprising
between about 0.5 mg/L to about 200 mg/L auxin;
between about 1 mg/L to about 400 mg/L salicylic acid; and
between about 0.5 mg/L to about 200 mg/L melatonin.

7. The ready to use composition of claim 6, wherein the auxin is selected from indole-3-butyric acid (IBA), indole-3-acetic acid (IAA), 2-phenylacetic acid (PAA), indole-3-propionic acid (IPA), and 1-naphthaleneacetic acid (NAA).

8. The ready to use composition of claim 6, further comprising 0.01-1% (v/v) adjuvant.

9. The ready to use composition of claim 8, wherein the adjuvant is a surfactant.

10. The ready to use composition of claim 8, wherein the adjuvant is a drift control agent.

11. The ready to use composition of claim 6, wherein the ready to use composition enhances nitrogen assimilation in plants by at least one of the methods selected from enhancing nitrogen absorption, improving photosynthesis efficiency to increase the supply of energy and 2-oxoglutarate (2-OG) to drive nitrogen assimilation through the glutamine synthetase-glutamate synthase (GS-GOGAT) pathway, and enhancing the activities of nitrogen assimilation enzymes.

12. The ready to use composition of claim 11, wherein the nitrogen assimilation enzyme is at least one enzyme selected from the group consisting of nitrate reductase, glutamine synthetase, and glutamate synthase.

13. A method for enhancing nitrogen assimilation in plants, comprising a step of applying a use solution composition to a plant, and the use solution composition comprising
between about 0.5 mg/L to about 200 mg/L auxin;
between about 1 mg/L to about 400 mg/L salicylic acid; and
between about 0.5 mg/L to about 200 mg/L melatonin.

14. The method of claim 13, wherein the auxin is selected from indole-3-butyric acid (IBA), indole-3-acetic acid (IAA), 2-phenylacetic acid (PAA), indole-3-propionic acid (IPA), and 1-naphthaleneacetic acid (NAA).

15. The method of claim 13, further comprising a step of mixing the use solution composition with an adjuvant before the step of applying the use solution composition to the plant.

16. The method of claim 13, wherein the adjuvant is a surfactant or a drift control agent.

17. The method of claim 13, wherein the use solution composition is applied to foliage of the plant.

18. The method of claim 13, wherein the use solution composition is applied to roots of the plant.

19. The method of claim 13, wherein the use solution composition enhances nitrogen assimilation in plants by at least one of the methods selected from enhancing nitrogen absorption, improving photosynthesis efficiency to increase the supply of energy and 2-oxoglutarate (2-OG) to drive nitrogen assimilation through the glutamine synthetase-glutamine-glutamate synthase (GS-GOGAT) pathway, and enhancing the activities of nitrogen assimilation enzymes.

20. The method of claim 19, wherein the nitrogen assimilation enzyme is at least one enzyme selected from the group consisting of nitrate reductase, glutamine synthetase, and glutamate synthase.
